(19) United States
(12) Patent Application Publication
(10) Pub. No.: US 2024/0258497 A1
(43) Pub. Date: Aug. 1, 2024

(54) BATTERY, ELECTRONIC DEVICE, POWER STORAGE SYSTEM, AND MOVING VEHICLE

(71) Applicant: SEMICONDUCTOR ENERGY LABORATORY CO., LTD., Atsugi-shi, Kanagawa-ken (JP)

(72) Inventors: Shunpei YAMAZAKI, Setagaya, Tokyo (JP); Tetsuya KAKEHATA, Isehara, Kanagawa (JP); Teppei OGUNI, Atsugi, Kanagawa (JP); Tatsuyoshi TAKAHASHI, Atsugi, Kanagawa (JP); Kazuya SHIMADA, Atsugi, Kanagawa (JP); Yohei MOMMA, Isehara, Kanagawa (JP); Atsushi KAWATSUKI, Yokohama, Kanagawa (JP)

(21) Appl. No.: 18/562,365

(22) PCT Filed: May 16, 2022
(86) PCT No.: PCT/IB2022/054515

§ 371 Date: Nov. 20, 2023

(30) Foreign Application Priority Data
May 28, 2021 (JP) 2021-090473
Jul. 30, 2021 (JP) 2021-125256
Mar. 16, 2022 (JP) 2022-040970

(51) Int. Cl. H01M 4/13; H01G 11/24; H01G 11/56; H01G 11/66; H01M 4/02; H01M 4/36; H01M 4/62

(52) U.S. Cl. CPC H01M 4/13; H01G 11/24; H01G 11/56; H01G 11/66; H01M 4/366; H01M 4/624; H01M 2004/021; H01M 2004/028; H01M 2220/10; H01M 2220/20; H01M 2220/30

(57) ABSTRACT

Electrodes and a secondary battery having high capacity density and being excellent in terms of rapid charging and rapid discharging are provided. The battery includes a positive electrode and a negative electrode. The positive electrode includes a current collector, a first layer overlapping with the current collector, and a second layer overlapping with the first layer. The first layer contains a first active material with a first particle diameter and the second layer contains a second active material with a second particle diameter. The first particle diameter is smaller than the second particle diameter. It is preferable that the second active material include a surface portion and an inner portion, the surface portion be a region within a depth of 10 nm or less from a surface of the second active material to the inner portion, and that the surface portion and the inner portion be topotaxy.

### TECHNICAL FIELD

One embodiment of the present invention relates to a secondary battery and a fabrication method thereof. The present invention relates to an electrode fabricating method and an electrode fabricating apparatus. Other embodiment of the present invention relates to an electronic device, a power storage system, a moving vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification means all devices including power storage devices, and electro-optical devices including power storage devices, information terminal devices including power storage devices, and the like are all electronic devices.

Note that in this specification, a power storage device refers to all elements and devices each having a function of storing power. For example, a power storage device (also referred to as a battery, a secondary battery, or the like) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry, for portable information terminals such as mobile phones, smartphones, and laptop computers, portable music players, digital cameras, medical equipment, moving vehicles such as next-generation clean energy vehicles, e.g., hybrid electric vehicles (HVs), electric vehicles (EVs), plug-in hybrid electric vehicles (PHVs), and the like, and the lithium-ion secondary batteries are essential as rechargeable energy supply sources for today's information society.

A lithium-ion secondary battery is composed of a positive electrode containing a positive electrode active material such as lithium cobalt oxide (LiCoO₂), lithium nickel-cobalt-manganese oxide (LiNi_{1x-y}CoₓMn_{y}O₂), or lithium iron phosphate (LiFePO₄), a negative electrode containing a negative electrode active material such as a carbon material, e.g., graphite capable of occluding and releasing lithium, and an electrolyte containing an organic solvent such as ethylene carbonate (EC) or diethyl carbonate (DEC), for example.

For the lithium-ion secondary batteries, high capacity density, higher performance, safety in a variety of operating environments, and the like are required.

Patent Document 1 discloses an electrode fabrication method which can increase capacity density of a secondary battery.

### REFERENCES

### Patent Document

[Patent Document 1] International Publication WO 2020/128699 Pamphlet

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LixCoO₂ (0.0≤x≤1.0)”, Physical Review B, 80 (16): 165114. [Non-Patent Document 3] Zhaohui Chen et al., “Staging Phase Transitions in LixCoO₂”, Journal of The Electrochemical Society, 2002, 149 (12), A1604-A1609.
[Non-Patent Document 4] Belsky, A. et al., “New developments in the Inorganic Crystal Structure Database (ICSD): accessibility in support of materials research and design”, Acta Cryst., (2002) B58, pp. 364-369.
[Non-Patent Document 5] A. van de Walle, “Multicomponent multisublattice alloys, nonconfigurational entropy and other additions to the Alloy Theoretic Automated Toolkit”, Calphad Journal 33, 266, (2009).
[Non-Patent Document 6] Rasband, W. S., Image J, U. S. National Institutes of Health, Bethesda, Maryland, USA, http://rsb.info.nih.gov/ij/, 1997-2012.
[Non-Patent Document 7] Schneider, C. A, Rasband, W. S., Eliceiri K. W., “NIH Image to ImageJ: 25 years of image analysis”, Nature Methods, 9, pp. 671-675, 2012.
[Non-Patent Document 8] Abramoff, M. D., Magelhaes, P. J., Ram, S. J. “Image Processing with ImageJ”, Biophotonics International, volume 11, issue 7, pp. 36-42, 2004.

### SUMMARY OF THE INVENTION

### Problems to be Solved by the Invention

An object is to achieve a fabrication method that can increase capacity density of a secondary battery. Another object is to achieve a fabrication method that enables rapid charging and rapid discharging of a secondary battery. Another object is to provide a fabrication method of a highly safe and highly reliable secondary battery.

Electrodes (a positive electrode and a negative electrode) for a lithium-ion secondary battery are each fabricated by applying slurry containing a particulate active material onto a metal foil called a current collector and drying the slurry. An electrode fabricated in such a manner includes an active material layer over a current collector. The active material layer contains an active material and a space, and the space needs to be as small as possible in order to increase capacity density of a secondary battery. Between secondary batteries having the same volume, the secondary battery including an electrode with a smaller space can have higher battery capacity and higher capacity density per volume. Note that an electrode including an active material layer with a small space is sometimes referred to as a high-density electrode, an electrode having increased density, or an electrode having high film density.

It is desirable that an electrode for a lithium-ion secondary battery include a favorable electron conductive path at an interface between a current collector and an active material layer and in the active material layer. It is also desirable that a favorable lithium-ion conductive path be included in a region of the active material layer which is close to a separator or a solid electrolyte layer. An electrode including a favorable electron conductive path and a favorable lithium ion conductive path is an electrode suitable for rapid charging and rapid discharging: however, it cannot be said that a structure and a fabrication method of the electrode including a favorable electron conductive path and a favorable lithium ion conductive path have been obtained sufficiently. Furthermore, it is also an object to provide a structure and a fabrication method of a high-capacity-density electrode including a favorable electron conductive path and a favorable lithium ion conductive path.

Note that the description of these objects does not preclude the existence of other objects. Note that one embodiment of the present invention does not have to achieve all the objects. Other objects can be derived from the description of the specification, the drawings, and the claims.

### Means for Solving the Problems

One embodiment of the present invention is a battery including a positive electrode and a negative electrode. The positive electrode includes a current collector, a first layer overlapping with the current collector, and a second layer overlapping with the first layer. The first layer contains a first active material with a first particle diameter. The second layer contains a second active material with a second particle diameter. The first particle diameter is smaller than the second particle diameter.

Another embodiment of the present invention is the battery including the positive electrode and the negative electrode. The positive electrode includes the current collector, the first layer overlapping with the current collector, and the second layer overlapping with the first layer. The first layer contains the first active material with the first particle diameter. The second layer contains the second active material with the second particle diameter. The first particle diameter is smaller than the second particle diameter. The sphericity of the second active material is greater than or equal to 0.8 and less than or equal to 1.0.

Another embodiment of the present invention is the battery including the positive electrode and the negative electrode. The positive electrode includes the current collector, the first layer overlapping with the current collector, and the second layer overlapping with the first layer. The first layer contains the first active material with the first particle diameter. The second layer contains the second active material with the second particle diameter. The first particle diameter is smaller than the second particle diameter. The second active material includes a surface portion and an inner portion. The surface portion is a region within a depth of 10 nm or less from a surface of the second active material to the inner portion. The surface portion and the inner portion are topotaxy.

Another embodiment of the present invention is the battery including the positive electrode and the negative electrode. The positive electrode includes the current collector, the first layer overlapping with the current collector, and the second layer overlapping with the first layer. The first layer contains the first active material with the first particle diameter. The second layer contains the second active material with the second particle diameter. The first particle diameter is smaller than the second particle diameter. The second active material includes the surface portion and the inner portion. The surface portion is the region within a depth of 10 nm or less from the surface of the second active material to the inner portion. The surface portion and the inner portion are topotaxy. The sphericity of the second active material is greater than or equal to 0.8 and less than or equal to 1.0.

In any one of the above-described batteries including the first layer and the second layer, the following is preferable: the first layer is over the current collector and the second layer is over the first layer.

In the case where the first layer is over the current collector and the second layer is over the first layer, the following is preferable: the first layer and the second layer each contain a conductive material, and mass of the conductive material contained in the second layer is larger than mass of the conductive material contained in the first layer.

In the case where the first layer is over the current collector and the second layer is over the first layer, the following is preferable: the first layer and the second layer each contain a solid electrolyte, and mass of the solid electrolyte contained in the first layer is larger than mass of the solid electrolyte contained in the second layer.

In any one of the above-described batteries, the following is preferable: the second layer is over the current collector and the first layer is over the second layer.

In the case where the second layer is over the current collector and the first layer is over the second layer, the following is preferable: the first layer and the second layer each contain a conductive material, and mass of the conductive material contained in the first layer is larger than mass of the conductive material contained in the second layer.

In the case where the second layer is over the current collector and the first layer is over the second layer, the following is preferable: the first layer and the second layer each contain a solid electrolyte, and mass of the solid electrolyte contained in the second layer is larger than mass of the solid electrolyte contained in the first layer.

Another embodiment of the present invention is a battery including a positive electrode and a negative electrode. The positive electrode includes a current collector, a first layer over the current collector, a second layer over the first layer, and a third layer over the second layer. The first layer contains a first active material with a first particle diameter. The second layer contains a second active material with a second particle diameter. The third layer contains a third active material with a third particle diameter. The first particle diameter is smaller than the second particle diameter. The third particle diameter is smaller than the second particle diameter.

Another embodiment of the present invention is the battery including the positive electrode and the negative electrode. The positive electrode contains the current collector, the first layer over the current collector, the second layer over the first layer, and the third layer over the second layer. The first layer contains the first active material with the first particle diameter. The second layer contains the second active material with the second particle diameter. The third layer contains the third active material with the third particle diameter. The first particle diameter is smaller than the second particle diameter. The third particle diameter is smaller than the second particle diameter. The sphericity of the second active material is greater than or equal to 0.8 and less than or equal to 1.0.

Another embodiment of the present invention is the battery including the positive electrode and the negative electrode. The positive electrode includes the current collector, the first layer over the current collector, the second layer over the first layer, and the third layer over the second layer. The first layer contains the first active material with the first particle diameter. The second layer contains the second active material with the second particle diameter and a fourth active material with a fourth particle diameter. The third layer contains the third active material with the third particle diameter. The first particle diameter is smaller than the second particle diameter. The third particle diameter is smaller than the second particle diameter. The fourth particle diameter is smaller than the second particle diameter.

Another embodiment of the present invention is the battery including the positive electrode and the negative electrode. The positive electrode includes the current collector, the first layer over the current collector, the second layer over the first layer, and the third layer over the second layer. The first layer contains the first active material with the first particle diameter. The second layer contains the second active material with the second particle diameter and the fourth active material with the fourth particle diameter. The third layer contains the third active material with the third particle diameter. The first particle diameter is smaller than the second particle diameter. The third particle diameter is smaller than the second particle diameter. The fourth particle diameter is smaller than the second particle diameter. The sphericity of the second active material is greater than or equal to 0.8 and less than or equal to 1.0.

Another embodiment of the present invention is the battery including the positive electrode and the negative electrode. The positive electrode includes the current collector, the first layer over the current collector, the second layer over the first layer, and the third layer over the second layer. The first layer contains the first active material with the first particle diameter. The second layer contains the second active material with the second particle diameter. The third layer contains the third active material with the third particle diameter. The first particle diameter and the third particle diameter are smaller than the second particle diameter. The second active material includes a surface portion and an inner portion. The surface portion is a region within a depth of 10 nm or less from a surface of the second active material to the inner portion. The surface portion and the inner portion are topotaxy.

Another embodiment of the present invention is the battery including the positive electrode and the negative electrode. The positive electrode includes the current collector, the first layer over the current collector, the second layer over the first layer, and the third layer over the second layer. The first layer contains the first active material with the first particle diameter. The second layer contains the second active material with the second particle diameter. The third layer contains the third active material with the third particle diameter. The first particle diameter and the third particle diameter are smaller than the second particle diameter. The second active material includes the surface portion and the inner portion. The surface portion is the region within a depth of 10 nm or less from the surface of the second active material to the inner portion. The surface portion and the inner portion are topotaxy. The sphericity of the second active material is greater than or equal to 0.8 and less than or equal to 1.0.

Another embodiment of the present invention is the battery including the positive electrode and the negative electrode. The positive electrode includes the current collector, the first layer over the current collector, the second layer over the first layer, and the third layer over the second layer. The first layer contains the first active material with the first particle diameter. The second layer contains the second active material with the second particle diameter and a fourth active material with a fourth particle diameter. The third layer contains the third active material with the third particle diameter. The first particle diameter, the third particle diameter, and the fourth particle diameter are smaller than the second particle diameter. The second active material includes the surface portion and the inner portion. The surface portion is the region within a depth of 10 nm or less from the surface of the second active material to the inner portion. The surface portion and the inner portion are topotaxy.

Another embodiment of the present invention is the battery including the positive electrode and the negative electrode. The positive electrode includes the current collector, the first layer over the current collector, the second layer over the first layer, and the third layer over the second layer. The first layer contains the first active material with the first particle diameter. The second layer contains the second active material with the second particle diameter and the fourth active material with the fourth particle diameter. The third layer contains the third active material with the third particle diameter. The first particle diameter, the third particle diameter, and the fourth particle diameter are smaller than the second particle diameter. The second active material includes the surface portion and the inner portion. The surface portion is the region within a depth of 10 nm or less from the surface of the second active material to the inner portion. The surface portion and the inner portion are topotaxy. The sphericity of the second active material is greater than or equal to 0.8 and less than or equal to 1.0.

In any one of the above-described batteries including the first layer, the second layer, and the third layer, the following is preferable: the first layer, the second layer, and the third layer each contain a conductive material, mass of the conductive material contained in the third layer is larger than mass of the conductive material contained in the second layer, and the mass of the conductive material contained in the second layer is larger than mass of the conductive material contained in the first layer.

In any one of the above-described batteries including the first layer, the second layer, and the third layer, the following is preferable: the first layer, the second layer, and the third layer each contain a solid electrolyte, mass of the solid electrolyte contained in the first layer is larger than mass of the solid electrolyte contained in the second layer, and the mass of the solid electrolyte contained in the second layer is larger than mass of the solid electrolyte contained in the third layer.

In any one of the above-described batteries including the solid electrolyte, the following is preferable: the second active material includes the surface portion and the inner portion, the surface portion is the region within a depth of 10 nm or less from the surface of the second active material to the inner portion, and in the case where the surface portion and the inner portion are topotaxy, an edge surface of the second active material includes a region where the surface portion and the solid electrolyte are in contact with each other.

One embodiment of the present invention is a moving vehicle including any one of the above-described batteries.

One embodiment of the present invention is a power storage system including any one of the above-described batteries.

One embodiment of the present invention is an electronic device including any one of the above-described batteries.

### Effect of the Invention

A secondary battery that can have higher capacity density can be provided. A secondary battery that can be rapidly charged and discharged can be provided. A highly safe and highly reliable secondary battery can be provided.

One embodiment of the present invention can provide a positive electrode active material or a composite oxide which inhibits a decrease in charge and discharge capacity due to charge and discharge cycles. A positive electrode active material or a composite oxide whose crystal structure is not easily broken even when charging and discharging are repeated can be provided. A positive electrode active material or a composite oxide with high charge and discharge capacity can be provided. A highly safe or highly reliable secondary battery can be provided.

A fabrication method that can increase capacity density of a secondary battery can be achieved. A fabrication method of a secondary battery which enables rapid charging and rapid discharging can be achieved. A fabrication method of a highly safe and highly reliable secondary battery can be provided. A fabrication method which can reduce the number of defects generated in an active material in an electrode having sufficiently high density can be achieved. With a high-density electrode including an active material with a small number of defects, an excellent secondary battery having high capacity density, high performance, and safety in a variety of operation environments can be achieved.

Note that the description of these effects does not preclude the existence of other effects. One embodiment of the present invention does not have to have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A is an example of an electrode showing one embodiment of the present invention. FIG. 1B is a cross-sectional view of a positive electrode active material.

FIG. 2A to FIG. 2D are cross-sectional views of parts of positive electrode active materials.

FIG. 3 is an example of a TEM image where crystal orientations are substantially aligned with each other.

FIG. 4A is an example of a STEM image where crystal orientations are substantially aligned with each other. FIG. 4B is an FFT pattern of a region of a rock-salt crystal RS. FIG. 4C is an FFT pattern of a region of a layered rock-salt crystal LRS.

FIG. 5A and FIG. 5B are examples of an electrode of one embodiment of the present invention.

FIG. 6A to FIG. 6D are examples of an electrode of one embodiment of the present invention.

FIG. 7 is an example of a method for fabricating an electrode of one embodiment of the present invention.

FIG. 8A and FIG. 8B are examples of a method for fabricating an electrode of one embodiment of the present invention.

FIG. 9A and FIG. 9B are examples of a method for fabricating an electrode of one embodiment of the present invention.

FIG. 10 is an example of a method for fabricating an electrode of one embodiment of the present invention.

FIG. 11 is an example of calculation related to an electrode of one embodiment of the present invention.

FIG. 12A to FIG. 12F are examples of calculation related to an electrode of one embodiment of the present invention.

FIG. 13A to FIG. 13C are examples of calculation related to an electrode of one embodiment of the present invention.

FIG. 14A to FIG. 14C are examples of calculation related to an electrode of one embodiment of the present invention.

FIG. 15 is an example of calculation related to an electrode of one embodiment of the present invention.

FIG. 16A and FIG. 16B are examples of an electrode of one embodiment of the present invention.

FIG. 17A and FIG. 17B are examples of an electrode of one embodiment of the present invention.

FIG. 18A to FIG. 18D are examples of an electrode of one embodiment of the present invention.

FIG. 19A and FIG. 19B show an example of an electrode of one embodiment of the present invention.

FIG. 20A and FIG. 20B show an example of an electrode of one embodiment of the present invention.

FIG. 21A and FIG. 21B show an example of an electrode of one embodiment of the present invention.

FIG. 22A and FIG. 22B show an example of an electrode of one embodiment of the present invention.

FIG. 23A and FIG. 23B are examples of a battery including an electrode of one embodiment of the present invention.

FIG. 24 is an example of a battery including an electrode of one embodiment of the present invention.

FIG. 25A and FIG. 25B are examples of a battery including an electrode of one embodiment of the present invention.

FIG. 26A1 to FIG. 26B3 are diagrams showing crystal structures and calculation results.

FIG. 27A1 to FIG. 27A3 are diagrams illustrating crystal structures.

FIG. 28A and FIG. 28B are diagrams showing crystal structures and calculation results.

FIG. 29A and FIG. 29B are diagrams illustrating crystal structures.

FIG. 30 is a diagram illustrating crystal structures of a positive electrode active material.

FIG. 31 is a diagram illustrating crystal structures of a conventional positive electrode active material.

FIG. 32A and FIG. 32B are cross-sectional views of a positive electrode active material, and FIG. 32C1 and FIG. 32C2 are parts of the cross-sectional views of the positive electrode active material.

FIG. 33 is a diagram showing XRD patterns calculated from crystal structures.

FIG. 34 is a diagram showing XRD patterns calculated from crystal structures.

FIG. 35 is a cross-sectional view of a positive electrode active material.

FIG. 36A to FIG. 36C are diagrams showing a method for fabricating a positive electrode active material.

FIG. 37 is a diagram showing an example of a fabrication flow of a positive electrode active material showing one embodiment of the present invention.

FIG. 38 is a cross-sectional view illustrating a reaction vessel used for one embodiment of the present invention.

FIG. 39A is an exploded perspective view of a coin-type secondary battery, FIG. 39B is a perspective view of the coin-type secondary battery, and FIG. 39C is a cross-sectional perspective view thereof.

FIG. 40A illustrates an example of a cylindrical secondary battery. FIG. 40B illustrates the example of the cylindrical secondary battery. FIG. 40C illustrates an example of a plurality of cylindrical secondary batteries. FIG. 40D illustrates an example of a power storage system including a plurality of cylindrical secondary batteries.

FIG. 41A and FIG. 41B are diagrams illustrating examples of a secondary battery, and FIG. 41C is a diagram illustrating a state of the inside of the secondary battery.

FIG. 42A to FIG. 42C are diagrams illustrating an example of a secondary battery.

FIG. 43A and FIG. 43B are diagrams illustrating external views of secondary batteries.

FIG. 44A to FIG. 44C are diagrams illustrating a method for fabricating a secondary battery.

FIG. 45A to FIG. 45C are diagrams illustrating structure examples of a battery pack.

FIG. 46A to FIG. 46C are diagrams illustrating an example of a secondary battery.

FIG. 47A and FIG. 47B are diagrams illustrating an example of a secondary battery.

FIG. 48A is a perspective view of a battery pack showing one embodiment of the present invention, FIG. 48B is a block diagram of a battery pack, and FIG. 48C is a block diagram of a vehicle having a motor.

FIG. 49A to FIG. 49D are diagrams illustrating examples of transport vehicles. FIG. 49E is a diagram illustrating an example of an artificial satellite.

FIG. 50A and FIG. 50B are diagrams illustrating power storage devices of one embodiment of the present invention.

FIG. 51A is a diagram illustrating an electric bicycle, FIG. 51B is a diagram illustrating a secondary battery of an electric bicycle, and FIG. 51C is a diagram illustrating an electric motorcycle.

FIG. 52A to FIG. 52D are diagrams illustrating examples of electronic devices.

FIG. 53A illustrates examples of wearable devices, FIG. 53B is a perspective view of a watch-type device, and FIG. 53C is a diagram illustrating a side surface of the watch-type device.

FIG. 53D is a diagram illustrating an example of wireless earphones.

FIG. 54A and FIG. 54B are cross-sectional SEM images of an electrode in an example.

FIG. 55A and FIG. 55B are cross-sectional SEM images of an electrode in an example.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In addition, in the drawings, the size, the layer thickness, or the region is exaggerated for clarity in some cases. Therefore, the size, the layer thickness, or the region is not necessarily limited to the illustrated scale.

The ordinal numbers such as “first” and “second” in this specification and the like are used for convenience and do not denote the order of steps or the stacking order of layers. Therefore, for example, the term “first” can be replaced with the term “second”, “third”, or the like as appropriate. In addition, the ordinal numbers in this specification and the like do not sometimes correspond to the ordinal numbers that are used to specify one embodiment of the present invention.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The particle diameter of a particle can be measured by laser diffraction particle size distribution measurement, for example, and can be represented as D50. D50 is a particle diameter when the cumulative volume of a particle size distribution curve accounts for 50% in a measurement result of the particle size distribution, i.e., a median diameter. The measurement of the particle diameter of a particle is not limited to laser diffraction particle size distribution measurement: in the case where the particle diameter of a particle is less than or equal to the lower measurement limit of laser diffraction particle size distribution measurement, the cross-sectional diameter of a particle cross section may be measured by analysis with a SEM (scanning electron microscope), a TEM (transmission electron microscope), or the like. As a method for measuring the particle diameter of a particle whose cross-sectional shape is not a circle, for example, the cross-sectional area of the particle is calculated by image processing or the like, whereby the particle diameter can be estimated assuming that the particle has a circular cross section with the equivalent area.

In this specification and the like, a space group is represented using the short symbol of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations: in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with { }. A trigonal system represented by the space group R-3m is generally represented by a composite hexagonal lattice for easy understanding of the structure and, in some cases, not only (hkl) but also (hkil) is used as the Miller index. Here, i is −(h+k).

A theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of lithium nickel oxide (LiNiO₂) is 275 mAh/g, and the theoretical capacity of lithium manganese oxide (LiMn₂O₄) is 148 mAh/g.

The remaining amount of lithium that can be inserted into and extracted from a positive electrode active material is represented by x in a compositional formula, e.g., x in LixCoO₂ or x in LiₓMO₂ (M is a transition metal). Note that x can also be referred to as the occupancy rate of Li in lithium sites. In the case of a positive electrode active material in a secondary battery, x can be represented by (theoretical capacity−charge capacity)/theoretical capacity. For example, in the case where a secondary battery using LiCoO₂ as a positive electrode active material is charged to 219.2 mAh/g, it can be said that the positive electrode active material is represented by Li_{0.2}CoO₂ or x=0.2. Small x in LixCoO₂ means, for example, 0.1<x≤0.24. Note that the transition metal M can be selected from the elements belonging to Groups 4 to 13 of the periodic table and for example, at least one of manganese, cobalt, and nickel is used.

In the case where lithium cobalt oxide substantially satisfies the stoichiometric composition, the lithium cobalt oxide is LiCoO₂ and the occupancy rate x of Li in lithium sites is 1. For a secondary battery after its discharging ends, it can be said that lithium cobalt oxide is LiCoO₂ and x=1. Here, “discharging ends” means that a voltage becomes lower than or equal to 2.5 V (vs. Li counter electrode) at a current of 100 mA/g, for example. In a lithium-ion secondary battery, the voltage rapidly decreases when the occupancy rate of lithium in the lithium sites becomes x=1 and no more lithium can enter the lithium-ion secondary battery. At this time, it can be said that discharging ends. In general, in a lithium-ion secondary battery using LiCoO₂, the discharge voltage rapidly decreases before discharge voltage reaches 2.5 V; thus, discharging ends under the above-described conditions.

Charge capacity and/or discharge capacity used for calculation of x in LixCoO₂ is preferably measured under the condition where there is no influence or small influence of a short circuit and/or decomposition of an electrolyte. For example, data of a secondary battery, containing a sudden capacity change that seems to result from a short circuit, is preferably not used for calculation of x.

The space group of a crystal structure is identified by XRD, electron diffraction, neutron diffraction, or the like. Thus, in this specification and the like, belonging to a space group or being a space group can be rephrased as being identified as a space group.

Note that in a layered rock-salt crystal and a rock-salt crystal, a structure where A layer, B layer, and C layer having anions are shifted and stacked like “ABCABC” is referred to as a cubic close-packed structure. Accordingly, anions do not necessarily form a cubic lattice structure. At the same time, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

Uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface portion, a surface, a projected portion, a depressed portion, and an inner portion.

Electrodes (a positive electrode and a negative electrode) each include an active material layer and a current collector. An electrode in which one surface of a current collector is provided with an active material layer is referred to as a single-side-coated electrode, and an electrode in which both surfaces of a current collector are provided with active material layers is referred to as a double-side-coated electrode. The electrode of one embodiment of the present invention and the fabrication method thereof are applicable to both a single-side-coated electrode and a double-side-coated electrode.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a decrease in charge and discharge capacity due to repeated charging and discharging.

### Embodiment 1

In this embodiment, electrodes of one embodiment of the present invention and fabrication methods thereof will be described.

### [Electrode 1 Having Stacked-Layer Structure]

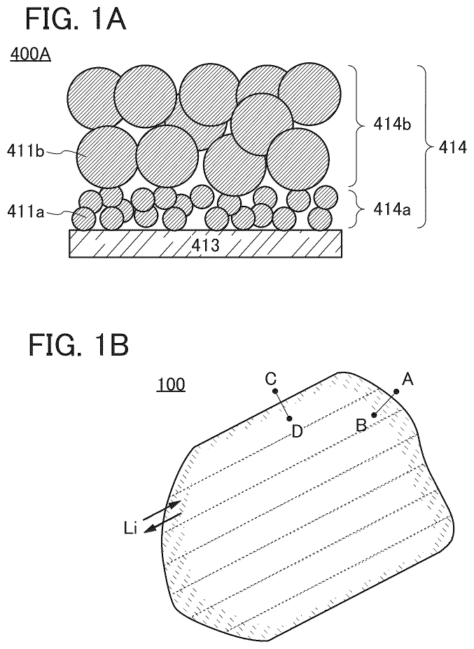

Electrodes of one embodiment of the present invention are described with reference to FIG. 1A to FIG. 6D. The electrode of one embodiment of the present invention can be used as one or both of a positive electrode and a negative electrode. A positive electrode active material is used as an active material in the case of a positive electrode, and a negative electrode active material is used as an active material in the case of a negative electrode. As the active material used for the electrode of one embodiment of the present invention, any of active materials described in Embodiment 1 to Embodiment 4 can be used.

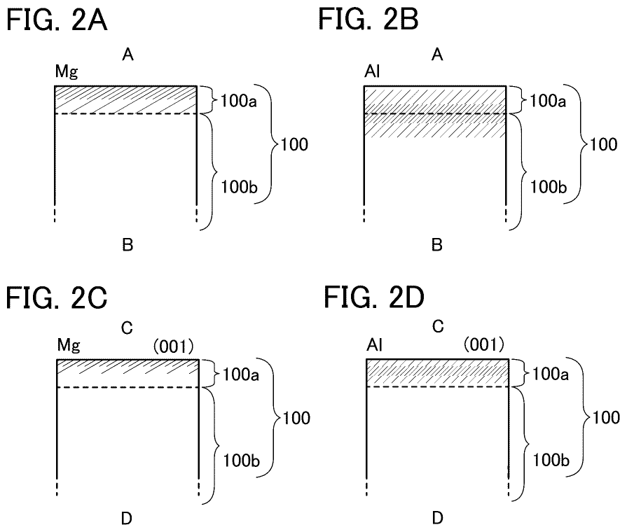

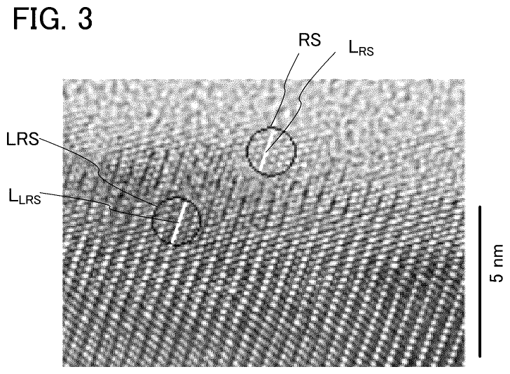

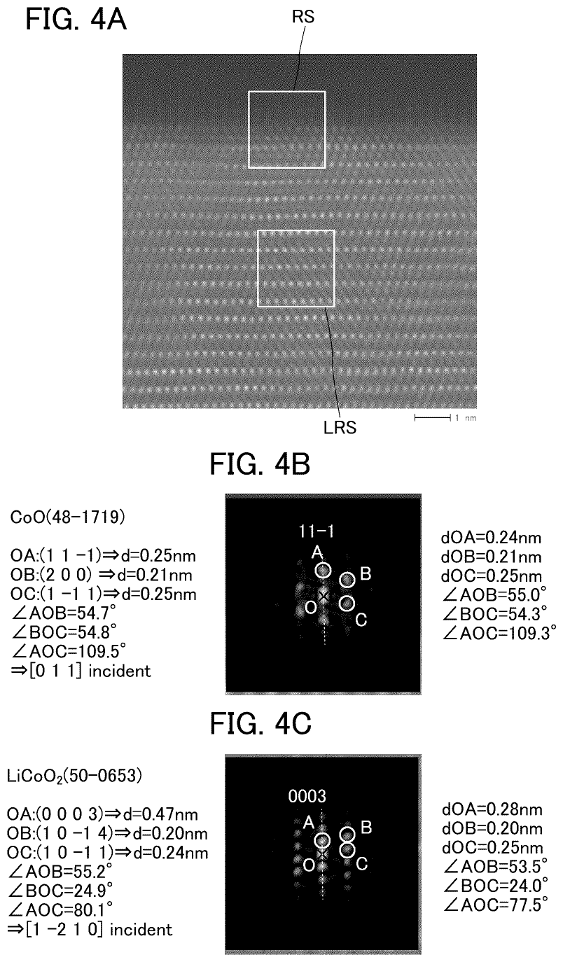

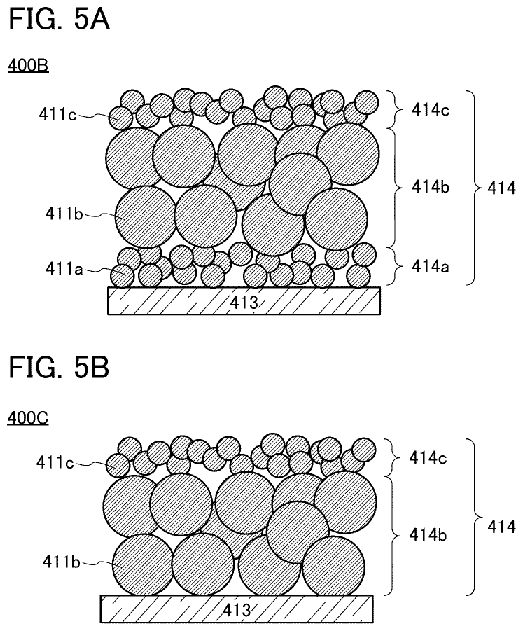

FIG. 1A, FIG. 5A, and FIG. 5B each show a schematic view of an electrode having a stacked-layer structure which is one embodiment of the present invention, seen from a side surface direction. In addition, examples that are particularly preferable as the positive electrode active material contained in a positive electrode having a stacked-layer structure are described with reference to FIG. 1B, FIG. 2A to FIG. 2D, FIG. 3, and FIG. 4A to FIG. 4C.

FIG. 1A illustrates an electrode 400A as an example of an electrode having a two-layer structure which is one embodiment of the present invention. The electrode 400A is an electrode having a two-layer structure where an active material layer 414 is included over a current collector 413, and the active material layer 414 includes a first layer 414a and a second layer 414b. The first layer 414a is included over the current collector 413, and the second layer 414b is included over the first layer 414a. The first layer 414a contains a first active material 411a, and the second layer 414b contains a second active material 411b.

A particle diameter Ra of the first active material 411a contained in the first layer 414a is preferably smaller than a particle diameter Rb of the second active material 411b contained in the second layer 414b. As the diameters, for example, the particle diameter Ra of the first active material 411a contained in the first layer 414a is preferably greater than or equal to 500 nm and less than or equal to 5 μm, further preferably greater than or equal to 1 μm and less than or equal to 5 μm. The particle diameter Rb of the second active material 411b contained in the second layer 414b is preferably greater than or equal to 1 μm and less than or equal to 35 μm, further preferably greater than or equal to 5 μm and less than or equal to 25 μm. Note that a particle diameter of an active material here refers to a median diameter of the active material which can be measured using any one of the above measuring methods.

Here, the particle diameter Rb/the particle diameter Ra, which is the size ratio of the first active material 411a to the second active material 411b, is preferably greater than or equal to 2 and less than or equal to 15, further preferably greater than or equal to 3 and less than or equal to 10, still further preferably greater than or equal to 4 and less than or equal to 8. In the case where the first active material 411a and the second active material 411b satisfy the above relation, rapid charging and rapid discharging are possible.

This is because the first active material 411a contained in the first layer 414a, which has a smaller particle diameter than the second active material 411b contained in the second layer 414b, increases the number of contact points between the current collector 413 and the active material layer 414, thereby decreasing the interface resistance between the current collector 413 and the active material layer 414.

Although not illustrated in FIG. 1A, the first layer 414a and the second layer 414b may each contain a conductive material and a binder, which will be described later. Alternatively, the first layer 414a and the second layer 414b may each contain a conductive material, a binder, and a solid electrolyte, which will be described later.

Here, the thickness of the first layer 414a is preferably greater than or equal to 1 μm and less than or equal to 20 μm, further preferably greater than or equal to 1 μm and less than or equal to 10 μm. This is because the thickness of the first layer 414a is preferably small since the first active material 411a contained in the first layer 414a, which has a smaller particle diameter in the active material layer 414, makes a small contribution to efficient storage of lithium ions, although reducing the interface resistance is an important function of the first layer 414a.

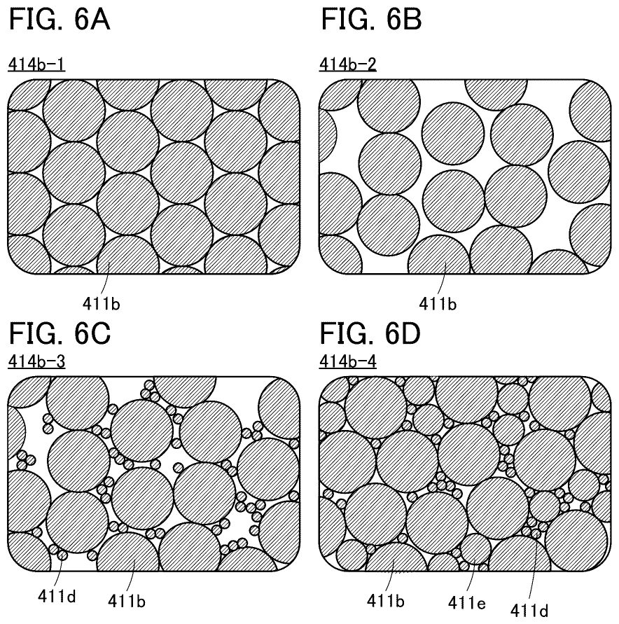

The second active material 411b contained in the second layer 414b, which has the largest particle diameter in the active material layer 414, tends to make a large contribution to efficient storage of lithium ions. In addition, as described later with reference to FIG. 6, an active material with a large particle diameter enables more efficient storage of lithium ions when used in combination with an active material with a small diameter and an active material with a medium diameter. That is, the volume capacity density of the electrode can be increased. Thus, the thickness of the second layer 414b in the active material layer 414 is preferably greater than or equal to 10 μm and less than or equal to 200 μm, further preferably greater than or equal to 20 μm and less than or equal to 150 μm. As the second layer 414b has a higher proportion in the active material layer 414, the electrode 400A can have higher volume capacity density.

Note that in FIG. 1A and the like, the cross-sectional shape of the first active material 411a contained in the first layer 414a, for example, is schematically illustrated as a circle or a perfect circle for easy understanding. The cross-sectional shape of an actual active material is sometimes a shape other than a circle and a perfect circle (a shape with unevenness, an elliptical shape, or the like), and such a shape is also included in one embodiment of the present invention.

### [Positive Electrode Active Material Contained in Positive Electrode Having Stacked-Layer Structure]

As a particularly preferable example of the positive electrode active material that is contained in the positive electrode having a stacked-layer structure of one embodiment of the present invention, FIG. 1B illustrates a positive electrode active material 100 whose surface portion includes regions that are topotaxy. FIG. 2A and FIG. 2B each show an enlarged view of a portion near the line A-B in FIG. 1B. FIG. 2C and FIG. 2D each show an enlarged view of a portion near the line C-D in FIG. 1B. Here, an example of the positive electrode active material 100 whose surface portion includes regions that are topotaxy is described.

In FIG. 1B, a crystal plane parallel to arrangement of cations is denoted by a dotted line. Arrows indicate the directions of insertion and extraction of lithium in charging and discharging. Note that the arrangement of cations here refers to the arrangement of cations other than lithium, typified by the transition metal M that is easy to observe in a STEM image or the like. The crystal plane parallel to the arrangement of cations refers to a crystal plane parallel to a direction in which lithium ions can diffuse. As illustrated in FIG. 2A to FIG. 2D, the positive electrode active material 100 includes a surface portion 100a and an inner portion 100b. In each drawing, a dashed line denotes a boundary between the surface portion 100a and the inner portion 100b. Although not illustrated, the positive electrode active material 100 may include a crystal grain boundary.

In this specification and the like, the surface portion 100a of the positive electrode active material 100 refers to a region that is within 50 nm, preferably within 35 nm, further preferably within 20 nm in depth from the surface toward the inner portion, and most preferably a region positioned within 10 nm in depth from the surface toward the inner portion. A plane generated by a split and/or a crack can be regarded as a surface. The surface portion 100a is synonymous with the vicinity of a surface, a region in the vicinity of a surface, or a shell.

The inner portion 100b refers to a region deeper than the surface portion 100a of the positive electrode active material. The inner portion 100b is synonymous with an inner region or a core.

A surface of the positive electrode active material 100 refers to a surface of a composite oxide including the surface portion 100a, the inner portion 100b, a projected portion, and the like. Therefore, the positive electrode active material 100 does not include carbonate, a hydroxy group, or the like which is chemically adsorbed after fabrication. Furthermore, an electrolyte, a binder, a conductive material, and a compound originating from any of these that are attached to the positive electrode active material 100 are not included either. The surface of the positive electrode active material 100 in, for example, a cross-sectional STEM (scanning transmission electron microscope) image is a boundary between a region where a bonding image of electron beam is observed and a region where the bonding image is not observed, and is determined as the outermost surface of a region where a bright spot derived from an atomic nucleus of a metal element having a larger atomic number than lithium is observed. The surface in a cross-sectional STEM image or the like may be determined in combination with the results of analysis with higher spatial resolution, e.g., electron energy loss spectroscopy (EELS).

The crystal grain boundary refers to, for example, a portion where the positive electrode active materials 100 adhere to each other, or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM image, a cross-sectional STEM image, or the like, i.e., a structure including another element between lattices, a hollow, or the like. The crystal grain boundary is one of plane defects. The vicinity of a crystal grain boundary refers to a region within 10 nm from the crystal grain boundary.

### <Epitaxy, Topotaxy>

In the positive electrode active material 100, the crystal structure preferably continuously changes from the inner portion 100b to the surface. Alternatively, the crystal orientations of the surface portion 100a and the inner portion 100b are preferably aligned or substantially aligned with each other. Note that in the following description, the structure where the crystal orientations are aligned or substantially aligned with each other is simply described as a structure where the crystal orientations are substantially aligned with each other in some cases. Alternatively, the surface portion 100a and the inner portion 100b are preferably topotaxy.

Topotaxy refers to a state where three-dimensional structures have similarity such that crystal orientations are substantially aligned with each other, or a state where orientations are crystallographically the same. Epitaxy refers to similarity in structures of two-dimensional interfaces.

When the surface portion 100a and the inner portion 100b are topotaxy, distortion of the crystal structure and/or shift in atomic arrangement can be reduced. This can inhibit generation of a pit. Furthermore, when the surface portion 100a contains an additive element, shift in a layered structure formed of octahedrons of the transition metal M which will be described later and oxygen can be inhibited, and/or release of oxygen from the positive electrode active material 100 can be inhibited. Accordingly, the positive electrode active material can have less deterioration even when charged at high voltage or charged and discharged in a high temperature environment. That is, it can be said that the positive electrode active material 100 whose surface portion includes regions that are topotaxy is a positive electrode active material that has less deterioration even when charged at high voltage or charged and discharged in a high temperature environment. Note that in this specification and the like, a pit refers to a hole formed by progress of a defect in a positive electrode active material.

For example, a crystal structure preferably changes continuously from the inner portion 100b having the layered-rock-salt structure toward the surface and the surface portion 100a that have a rock-salt structure or have features of both a rock-salt structure and a layered rock-salt structure. Alternatively, the orientation of the surface portion 100a that has a rock-salt structure or has the features of both a rock-salt structure and a layered rock-salt structure and the orientation of the inner portion 100b having the layered rock-salt structure are preferably substantially aligned with each other.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be judged by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt structure, for example, and on the (003) plane in a layered rock-salt structure, for example. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a lager atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ crystal described later are presumed to form a cubic close-packed structure. Thus, when a layered rock-salt crystal and a rock-salt crystal are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, a state where the orientations of the cubic close-packed structures composed of anions in the layered rock-salt crystal, the O3′ structure, and the rock-salt crystal are aligned with each other is sometimes referred to as a state where crystal orientations are substantially aligned with each other, topotaxy, or epitaxy. Note that a combination of structures having substantially aligned crystal orientations is not limited to that of the layered rock-salt structure and the rock-salt structure. In the case of a combination including another crystal structure such as a spinel structure or a perovskite structure, a state where the orientations of the cubic close-packed structures composed of anions are aligned with each other can be referred to as a state where crystal orientations are substantially aligned with each other.

The orientations of crystals in two regions being substantially aligned with each other can be judged, for example, from a TEM (Transmission Electron Microscope) image, a STEM (Scanning Transmission Electron microscope) image, a HAADF-STEM (High-angle Annular Dark Field Scanning TEM) image, an ABF-STEM (Annular Bright-Field Scanning Transmission Electron microscope) image, an electron diffraction pattern, and an FFT pattern of a TEM image, a STEM image, and the like. XRD (X-ray Diffraction), electron diffraction, neutron diffraction, and the like can also be used for judging.

FIG. 3 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., LRs and LLRS shown in FIG. 3) is greater than or equal to 0° and less than or equal to 5° or greater than or equal to 0° and less than or equal to 2.5° in the TEM image, it can be judged that the crystal planes are substantially aligned with each other, that is, the crystal orientations of are substantially aligned with each other. Similarly, when the angle between the dark lines is less than or equal to 5° or less than or equal to 2.5°, it can be judged that the crystal orientations are substantially aligned with each other. In general, it is difficult to clearly differentiate “completely aligned” from “substantially aligned”. In this specification, the expression “aligned” includes both “perfectly aligned” (where the angle between bright lines is 0°, for example) and “substantially aligned”.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number: hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are contained as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be judged that arrangements of the atoms are substantially aligned with each other, that is, orientations of the crystals are substantially aligned with each other. Similarly, when the angle between the dark lines is less than or equal to 5° or less than or equal to 2.5°, it can be judged that orientations of the crystals are substantially aligned with each other.

With an ABF-STEM, an element having a smaller atomic number is observed to be brighter, but a contrast corresponding to the atomic number is obtained as with a HAADF-STEM: hence, in an ABF-STEM image, crystal orientations can be judged as in a HAADF-STEM image.

FIG. 4A shows an example of a STEM image in which orientations of the layered rock-salt crystal LRS and the rock-salt crystal RS are substantially aligned with each other. FIG. 4B shows FFT of a region of the rock-salt crystal RS, and FIG. 4C shows FFT of a region of the layered rock-salt crystal LRS. In FIG. 4B and FIG. 4C, the composition, the JCPDS (Joint Committee on Powder Diffraction Standard) card number, and d values and angles to be calculated are shown on the left. The measured values are shown on the right. A spot denoted by O is zero-order diffraction, and X denotes the center of the spot.

A spot denoted by A in FIG. 4B is derived from 11-1 reflection of a cubic structure. A spot denoted by A in FIG. 4C is derived from 0003 reflection of a layered rock-salt structure. It is found from FIG. 4B and FIG. 4C that the direction of the 11-1 reflection of the cubic structure and the direction of the 0003 reflection of the layered rock-salt structure are substantially aligned with each other. That is, a straight line passing through AO in FIG. 4B is substantially parallel to a straight line passing through AO in FIG. 4C. Here, the terms “substantially aligned” and “substantially parallel” mean that the angle between the two is greater than or equal to 0° and less than or equal to 5° or greater than or equal to 0° and less than or equal to 2.5°.

When the orientations of the layered rock-salt crystal and the rock-salt crystal are substantially aligned with each other in the above manner in FFT and electron diffraction, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 4C is derived from 1014 reflection of the layered rock-salt structure. This is sometimes observed at a position where the difference in orientation from the reciprocal lattice point derived from the 0003 reflection of the layered rock-salt structure (A in FIG. 4C) is greater than or equal to 52° and less than or equal to 56° (i.e., ∠AOB is greater than or equal to 52° and less than or equal to 56°) and d is greater than or equal to 0.19 nm and less than or equal to 0.21 nm. Note that these indices are just examples, and the spot does not necessarily correspond with them. For example, the spot may be a reciprocal lattice point equivalent to the indices.

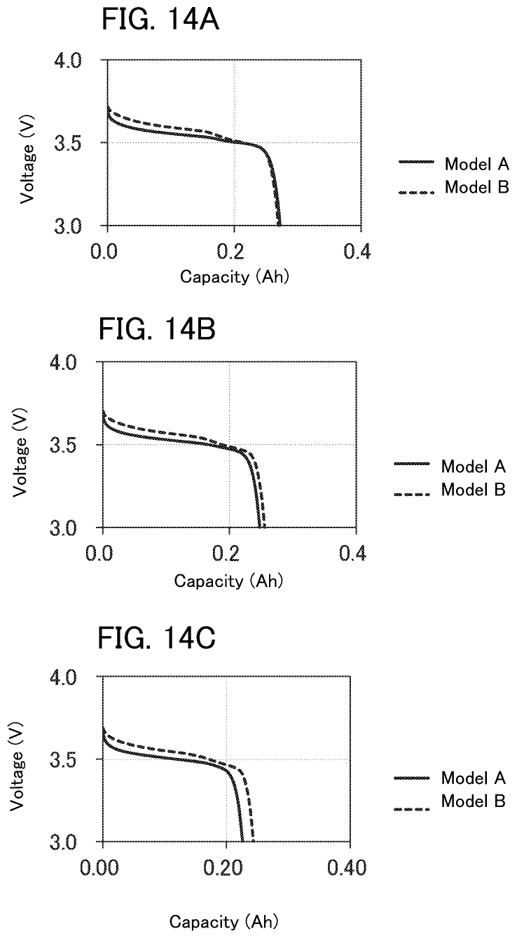

Similarly, a spot that is not derived from the 11-1 reflection of the cubic structure may be observed on a reciprocal lattice space different from the spot where the 11-1 reflection of the cubic structure is observed. For example, a spot denoted by B in FIG. 4B is derived from 200 reflection of the cubic structure. The spot derived from 200 reflection of the cubic structure is sometimes observed at a position where the difference in orientation from the reciprocal lattice point derived from the 11-1 reflection of the cubic structure (A in FIG. 14B) is greater than or equal to 54° and less than or equal to 56° (i.e., ∠AOB is greater than or equal to 54° and less than or equal to 56°). Note that these Mirror indices are just examples, and the spot does not necessarily correspond with them. For example, the spot may be a reciprocal lattice point equivalent to the indices.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

The electrode 400A illustrated in FIG. 1A preferably contains the positive electrode active material 100 whose surface portion includes regions that are topotaxy. That is, the positive electrode active material 100 whose surface portion includes regions that are topotaxy is preferably contained as one or both of the first active material 411a and the second active material 411b.

As described above, the positive electrode having a stacked-layer structure of one embodiment of the present invention preferably contains the positive electrode active material 100 whose surface portion includes regions that are topotaxy. As the positive electrode active material 100 whose surface portion includes regions that are topotaxy, a composite oxide containing an additive element can be used, for example. The details of the composite oxide containing an additive element will be described in Embodiment 2. Hereinafter, an overview of the composite oxide containing an additive element and a case where the composite oxide is used for a positive electrode having a stacked-layer structure are described.

A composite oxide containing an additive element and being obtained by any of fabrication methods to be described in Embodiment 2 and Embodiment 3 includes crystal having a hexagonal crystal layered structure. The crystal is not limited to a single crystal (also referred to as a crystallite), and in the case where the crystal is polycrystalline, some crystallites gather to form a primary particle. The primary particle indicates a particle recognized as a single grain when observed with a SEM. A secondary particle indicates a group of aggregated primary particles. For the aggregation of the primary particles, there is no particular limitation on the bonding force between the plurality of primary particles. The bonding force may be any of covalent bonding, ionic bonding, a hydrophobic interaction, the Van der Waals force, and other molecular interactions, or a plurality of bonding forces may work together.

In the case where the composite oxide is fabricated by the fabrication method to be described in Embodiment 2, a primary particle that does not aggregate is often formed, but in some cases, a secondary particle including a small number of (e.g., 10 or less) primary particles are formed. As illustrated FIG. 2A to FIG. 2D, the composite oxide fabricated by the fabrication method to be described in Embodiment 2 preferably contains an additive element in its surface portion. As the additive element contained in the surface portion of the composite oxide, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or more selected from bromine and beryllium is preferably contained. Note that the additive elements given earlier are more suitable since bromine and beryllium are elements having toxicity to living things.

As the composite oxide containing an additive element, it is possible to use any of composite oxides to be described in Embodiment 2, such as lithium cobalt oxide containing magnesium: lithium cobalt oxide containing magnesium and fluorine: lithium cobalt oxide containing magnesium and aluminum: lithium cobalt oxide containing magnesium, aluminum, and fluorine: lithium cobalt oxide containing magnesium, aluminum, and nickel: lithium cobalt oxide containing magnesium, aluminum, nickel, and fluorine: lithium cobalt oxide containing magnesium, aluminum, nickel, and barium; and lithium cobalt oxide containing magnesium, aluminum, nickel, barium, and fluorine, for example.

In the case where the composite oxide is fabricated by a coprecipitation method to be described in Embodiment 3, a secondary particle including a large number of (for example, 10 or more) primary particles is formed in some cases.

The crystal having a hexagonal crystal layered structure includes one or more selected from a first transition metal, a second transition metal, and a third transition metal. Specifically, NiCoMn-based material (also referred to as NCM) represented by LiNiₓCo_{y}Mn_{z}O₂ (x>0, y>0, 0.8<x+y+z<1.2) where the first transition metal is nickel, the second transition metal is cobalt, and the third transition metal is manganese, can be used. Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

The composite oxide containing an additive element and being obtained by the above method may contain as needed, in addition to the first transition metal, the second transition metal, and the third transition metal, one or more selected from a group consisting of magnesium, aluminum, calcium, zirconium, vanadium, chromium, iron, copper, zinc, gallium, germanium, strontium, yttrium, niobium, molybdenum, tin, barium, and lanthanum. In view of increasing the capacity retention rate of a secondary battery containing the positive electrode active material after charging and discharging cycles, one or more selected from magnesium, calcium, aluminum, and zirconium is preferably contained.

Next, another example of the electrode having a stacked-layer structure of one embodiment of the present invention is described. FIG. 1A illustrates the electrode having a two-layer structure as an example of the electrode having a stacked-layer structure of one embodiment of the present invention. Here, FIG. 5A shows a schematic view of an electrode having a three-layer structure seen from a side surface direction, as another example of the electrode having a stacked-layer structure of one embodiment of the present invention. An electrode 400B having a three-layer structure of one embodiment of the present invention includes the active material layer 414 over the current collector 413, and the active material layer 414 includes the first layer 414a, the second layer 414b, and a third layer 414c. The active material layer 414 includes the first layer 414a, the second layer 414b over the first layer 414a, and the third layer 414c over the second layer 414b. The first layer 414a contains the first active material 411a, the second layer 414b contains the second active material 411b, and the third layer 414c contains the third active material 411c. Like the electrode 400A illustrated in FIG. 1A, the electrode 400B illustrated in FIG. 5A preferably contains the positive electrode active material 100 whose surface portion includes regions that are topotaxy. That is, the positive electrode active material 100 whose surface portion includes regions that are topotaxy is preferably contained as one or more of the first active material 411a, the second active material 411b, and the third active material 411c.

The particle diameter Ra of the first active material 411a contained in the first layer 414a is preferably smaller than the particle diameter Rb of the second active material 411b contained in the second layer 414b. A particle diameter Rc of the third active material 411c contained in the third layer 414c is preferably smaller than the particle diameter Rb of the second active material 411b contained in the second layer 414b. As the particle diameters, for example, the particle diameter Ra of the first active material 411a contained in the first layer 414a is preferably greater than or equal to 500 nm and less than or equal to 5 μm, further preferably greater than or equal to 1 μm and less than or equal to 5 μm. The particle diameter Rb of the second active material 411b contained in the second layer 414b is preferably greater than or equal to 1 μm and less than or equal to 35 μm, further preferably greater than or equal to 5 μm and less than or equal to 25 μm. The particle diameter Rc of the third active material 411c contained in the third layer 414c is preferably greater than or equal to 500 nm and less than or equal to 5 μm, further preferably greater than or equal to 1 μm and less than or equal to 5 μm. Note that the particle diameter of an active material here refers to a median diameter of the active material which can be measured by any one of the above measuring methods.

Here, the particle diameter Rb/the particle diameter Ra, which is the size ratio of the first active material 411a to the second active material 411b, is preferably greater than or equal to 2 and less than or equal to 15, further preferably greater than or equal to 3 and less than or equal to 10, still further preferably greater than or equal to 4 and less than or equal to 8. The particle diameter Rb/the particle diameter Rc, which is the size ratio of the third active material 411c to the second active material 411b, is preferably greater than or equal to 2 and less than or equal to 10, further preferably greater than or equal to 3 and less than or equal to 5.

Although not illustrated in FIG. 5A, the first layer 414a, the second layer 414b, and the third layer 414c may each contain a conductive material and a binder, which will be described later. Alternatively, the first layer 414a, the second layer 414b, and the third layer 414c may each contain a conductive material, a binder, and a solid electrolyte, which will be described later.

In the case where the first active material 411a contained in the first layer 414a, the second active material 411b contained in the second layer 414b, and the third active material 411c contained in the third layer 414c satisfy the above-described relation, rapid charging and rapid discharging are possible.

This is because the first active material 411a being contained in the first layer 414a and having a smaller particle diameter than the second active material 411b contained in the second layer 414b increases the number of contact points between the current collector 413 and the active material layer 414, thereby decreasing the interface resistance between the current collector 413 and the active material layer 414.

Here, the thickness of the first layer 414a is preferably greater than or equal to 1 μm and less than or equal to 20 μm, further preferably greater than or equal to 1 μm and less than or equal to 10 μm. This is because, although reducing the interface resistance is an important function of the first layer 414a, the first active material 411a contained in the first layer 414a, which has a smaller particle diameter in the active material layer 414, makes a small contribution to efficient storage of lithium ions and thus the thickness of the first layer 414a is preferably small.

Note that in FIG. 5A and the like, for easy understanding, the cross-sectional shape of the first active material 411a contained in the first layer 414a, or the like is schematically illustrated as a circle or a perfect circle. The cross-sectional shape of an actual active material is sometimes a shape other than a circle and a perfect circle (a shape with unevenness, an elliptical shape, or the like), and such a shape is also included in one embodiment of the present invention.

Next, the relation between the second layer 414b and the third layer 414c is described. The third layer 414c is farther from the current collector 413 than the first layer 414a and the second layer 414b, and thus has a high electric resistance and a relatively low potential, and is likely to decrease the battery reaction rate. For example, unlike in the structure of the electrode of one embodiment of the present invention, in the case where the third active material 411c contained in the third layer 414c and the second active material 411b contained in the second layer 414b have substantially the same particle diameter, the battery reaction proceeds slower in a region farther from the current collector 413 (a position corresponding to the third layer 414c), which causes non-uniformity of reaction in the active material layer 414 and results in a reduction in charge and discharge capacity in rapid charging and rapid discharging.

In the structure of the electrode of one embodiment of the present invention, the third active material 411c contained in the third layer 414c has a smaller particle diameter than the second active material 411b contained in the second layer 414b; thus, the battery reaction rate in the third layer 414c is higher than the battery reaction rate in the second layer 414b. This can reduce non-uniformity of reaction in the active material layer 414 in rapid charging and rapid discharging, and thus can inhibit a reduction in charge and discharge capacity even in rapid charging and rapid discharging.

The second active material 411b contained in the second layer 414b, which has the largest particle diameter in the active material layer 414, is likely to make a large contribution to efficient storage of lithium ions. In addition, as described later with reference to FIG. 6, an active material with a large particle diameter enables more efficient storage of lithium ions when used in combination with an active material with a small diameter and an active material with a medium diameter. That is, the volume capacity density of the electrode can be increased. Thus, in the active material layer 414, the thickness of the second layer 414b is preferably greater than or equal to 10 μm and less than or equal to 200 μm, further preferably greater than or equal to 20 μm and less than or equal to 150 μm. As the second layer 414b has a higher proportion in the active material layer 414, the electrode 400B can have higher volume capacity density.

With the third layer 414c, non-uniformity of battery reaction in the active material layer 414 is reduced, thereby enabling rapid charging and rapid discharging. At this time, the thickness of the third layer 414c is preferably greater than or equal to 1 μm and less than or equal to 20 μm, further preferably greater than or equal to 1 μm and less than or equal to 10 μm.

As described above, FIG. 5A illustrates the electrode 400B having a stacked-layer structure of three layers: the first layer 414a, the second layer 414b, and the third layer 414c. The structure of the electrode including the third layer 414c which is one embodiment of the present invention is not limited to the above three-layer structure. For example, as illustrated in FIG. 5B, it is possible to employ an electrode 400C having a stacked-layer structure of two layers: the second layer 414b and the third layer 414c. The electrode 400C also can perform rapid charging and rapid discharging owing to the relation between the second layer 414b and the third layer 414c, which is described above for the electrode 400B.

Next, the second active material 411b contained in the second layer 414b is described with reference to FIG. 6A to FIG. 6D.

The second active material 411b contained in the second layer 414b, which has the largest particle diameter in the active material layer 414, is likely to make a large contribution to efficient storage of lithium ions. Here, the second layer 414b ideally has a dense structure as illustrated in FIG. 6A, but in many cases, actually has a structure including a gap as illustrated in FIG. 6B. In view of this, in the case where a fourth active material 411d with a small particle diameter is contained in addition to the second active material 411b with a large particle diameter as illustrated in FIG. 6C, the fourth active material 411d is likely to be positioned between particles of the second active materials 411b, resulting in higher density of the second layer 414b. In the case where the fourth active material 411d with a small particle diameter and a fifth active material 411e with a medium particle diameter are included in addition to the second active material 411b with a large particle diameter as illustrated in FIG. 6D, the fourth active material 411d and the fifth active material 411e are likely to be positioned between particles of the second active materials 411b, resulting in higher density of the second layer 414b.

Here, when a second layer 414b-2 illustrated in FIG. 6B is pressed, the second layer 414b can have higher density than that in FIG. 6B; however, in the case where a pressure exceeding the strength of the second active material 411b is applied, the second active material 411b might be cracked. Here, in the case where the second active material 411b has high sphericity, the second active material 411b is less likely to be cracked even when pressed with higher pressure. That is, the second layer 414b with high density can be obtained easily. Therefore, the second active material 411b preferably has high sphericity.

### <Sphericity>

The sphericity of an active material is a value representing the sphericity of an active material particle, that is, how close is the shape of the active material particle to a true sphere. In order to obtain the sphericity, for example, a particle having a particle diameter of a median diameter D50±50% is processed for cross-sectional observation, the cross-sectional observation is performed, and a perimeter length L of the cross section of the particle and an area S of the cross section of the particle are measured, whereby the sphericity (SP) can be calculated using the following formula.

[Formula]

SP=4π·S/(L²) (1)

The sphericity of the first active material 411a, the second active material 411b, and the third active material 411c is preferably greater than or equal to 0.6 and less than or equal to 1.0, further preferably greater than or equal to 0.8 and less than or equal to 1.0, most preferably greater than or equal to 0.9 and less than or equal to 1.0.

Furthermore, the second layer 414b as illustrated in FIG. 6C and FIG. 6D, where the second active material 411b with a large particle diameter is used together with the fourth active material 411d with a small particle diameter and/or the fifth active material 411e with a medium diameter, can also have higher density when pressed. As described above, the active material preferably has high sphericity also in this case. Thus, the sphericity of the fourth active material 411d with a small particle diameter and the fifth active material 411e with a medium particle diameter is preferably greater than or equal to 0.6 and less than or equal to 1.0, further preferably greater than or equal to 0.8 and less than or equal to 1.0, most preferably greater than or equal to 0.9 and less than or equal to 1.0.

### <Particle Diameter>

In the second layer 414b, it is preferable that the particle diameter of the second active material 411b be larger than that of the fifth active material 411e, and the particle diameter of the fifth active material 411e be larger than that of the fourth active material 411d. As the particle diameters of the active materials contained in the second layer 414b, for example, the particle dimeter of the second active material 411b is preferably greater than or equal to 1 μm and less than or equal to 35 μm, further preferably greater than or equal to 5 μm and less than or equal to 25 μm, as described above. The particle diameter of the fourth active material 411d contained in the second layer 414b is preferably greater than or equal to 500 nm and less than or equal to 5 μm, further preferably greater than or equal to 1 μm and less than or equal to 5 μm. The particle diameter of the fifth active material 411e contained in the second layer 414b is preferably greater than or equal to 1 μm and less than or equal to 20 μm, further preferably greater than or equal to 5 μm and less than or equal to 15 μm.

In the case where the second layer 414b contains the second active material 411b (with a large particle diameter) and the fourth active material 411d (with a small particle diameter), in the mass ratio of the second active material 411b to the fourth active material 411d which is represented by the second active material 411b: the fourth active material 411d=1: Ma, Ma is preferably greater than or equal to 0.05 and less than or equal to 0.5, further preferably greater than or equal to 0.1 and less than or equal to 0.4. In the case where the second layer 414b contains the second active material 411b (with a large particle diameter), the fourth active material 411d (with a small particle diameter), and the fifth active material 411e (with a medium particle diameter), in the mass ratio of the second active material 411b, the fourth active material 411d, and the fifth active material 411e which is represented by the second active material 411b: the fourth active material 411d: the fifth active material 411e=1: Mb: Mc, Mb is preferably greater than or equal to 0.1 and less than or equal to 0.5 and Me is preferably greater than or equal to 0.1 and less than or equal to 0.5.

Although the example of the electrode having a two-layer structure and the example of the electrode having the three-layer structure are described above, the electrode may include four or more layers. For example, in the electrode having a two-layer structure illustrated in FIG. 1A, a layer containing an active material with a medium particle diameter may be provided between the layer containing an active material with a small particle diameter (the first layer 414a) and the layer containing an active material with a large particle diameter (the second layer 20) 414b). As the electrode having a three-layer structure illustrated in FIG. 5A, the electrode having a five-layer structure may be employed where a layer containing an active material with a medium particle diameter is provided between the layer containing an active material with a small particle diameter (the first layer 414a) and the layer containing an active material with a large particle diameter (the second layer 414b), and a layer containing an active material with a medium particle diameter is provided between the layer containing an active material with a large particle diameter (the second layer 414b) and the layer containing an active material with a small particle diameter (the third layer 414c).

In the case where the composite oxide containing an additive element is used for the positive electrode having a stacked-layer structure of one embodiment of the present invention, the first active material 411a contained in the first layer 414a, the second active material 411b contained in the second layer 414b, and the third active material 411c contained in the third layer 414c may contain the same kind (and the same combination) of additive elements or may contain different additive elements. In addition, the first active material 411a contained in the first layer 414a, the second active material 411b contained in the second layer 414b, and the third active material 411c contained in the third layer 414c may contain an additive element at the same concentration or different concentrations.

For example, lithium cobalt oxide containing magnesium, aluminum, and nickel can be used as the second active material 411b contained in the second layer 414b, and lithium cobalt oxide containing magnesium can be used as the third active material 411c contained in the third layer 414c.

For example, the concentration of the additive element contained in the first active material 411a contained in the first layer 414a and the third active material 411c contained in the third layer 414c can be higher than the concentration of the additive element contained in the second active material 411b contained in the second layer 414b.

Although the active material in the active material layer 414 is described in the above example, the active material layer 414 may contain one or more of a conductive material, a binder, a solid electrolyte, and the like which will be describe later. As the active material contained in the active material layer 414, any of positive electrode active materials and negative electrode active materials to be described in Embodiment 2 to Embodiment 4 can be used.

### [Fabrication Method of Electrode 1 Having Stacked-Layer Structure]

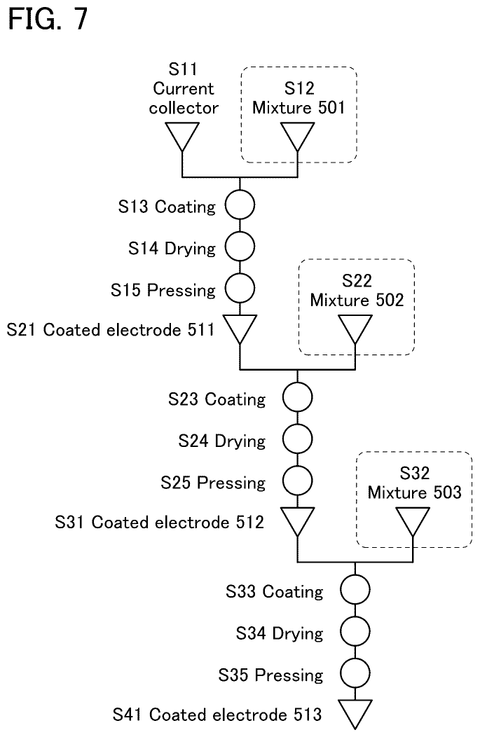

Examples of a method for fabricating an electrode of one embodiment of the present invention are described with reference to FIG. 7 to FIG. 10.

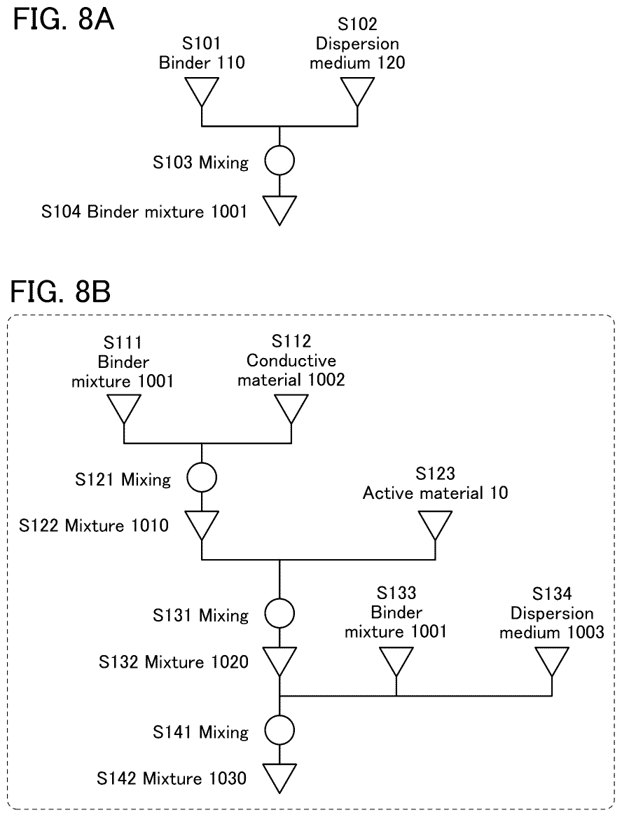

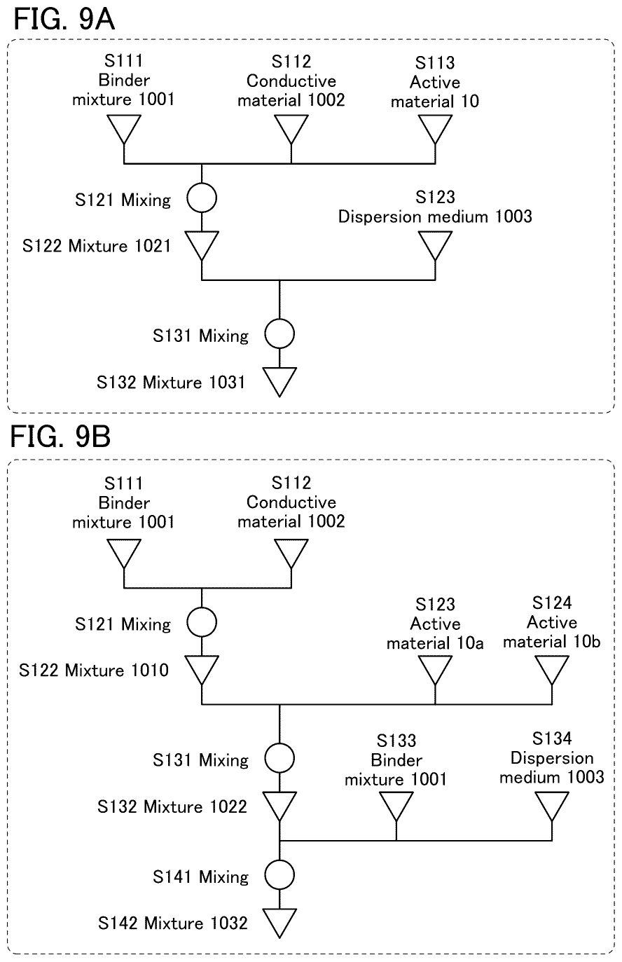

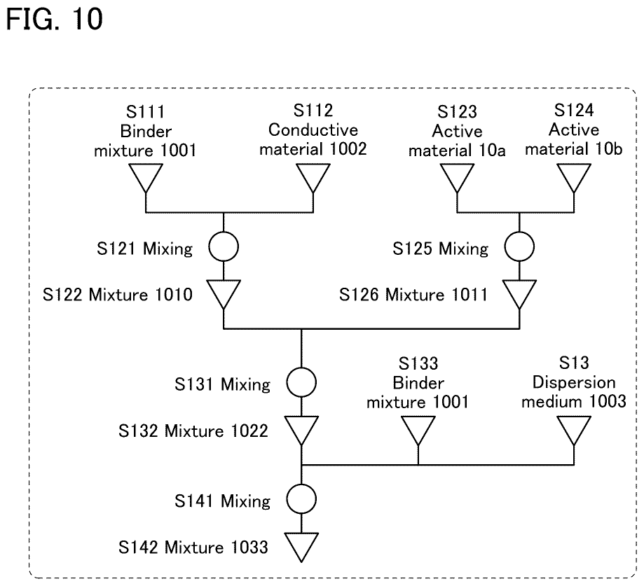

FIG. 7 shows an example of a method for fabricating an electrode, in which the first layer 414a is formed in Step S11 to Step S21, the second layer 414b is formed in Step S21 to Step S31, and the third layer 414c is formed in Step S31 to Step S41. As methods for forming a mixture 501 prepared in Step S12, a mixture 502 prepared in Step S22, and a mixture 503 prepared in Step S32 in FIG. 7, any of formation methods shown in FIG. 8B, FIG. 9A, FIG. 9B, and FIG. 10 can be used, and a plurality of formation methods can be used in combination.

In Step S11 in FIG. 7, a current collector is prepared. In Step S12, the mixture 501 is prepared.

Next, in Step S13 in FIG. 7, the mixture 501 is applied to the current collector. The current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. For the application method in Step S13, a slot die method, gravure, a blade method, or a combination of any of them can be used, for example. Furthermore, a continuous coater or the like may be used for the application. Subsequent to Step S13, the mixture 501 applied to the current collector is dried in Step S14. As the drying method, for example, a batch-type method using a hot plate, a drying furnace, a circulation drying furnace, a vacuum drying furnace, or the like, or a sequential-type method using a combination of warm-air drying, infrared drying, or the like with a continuous coater can be used. After the drying, a coated electrode 511 is obtained in Step S21.

Here, as shown in FIG. 7, pressing can be performed as Step S15 after drying in Step S14. As the pressing method, any of a flat plate press method, an isostatic press method, and a roll press method can be used. In the case of using a roll press method, the temperature of the roll is preferably adjusted such that the temperature of the active material layer is higher than or equal to 10° C. and lower than or equal to 200° C., preferably higher than or equal to 80° C. and lower than or equal to 150° C., for example.

Then, in Step S22 in FIG. 7, the mixture 502 is prepared.

Next, the mixture 502 is applied onto the coated electrode 511 in Step S23 in FIG. 7, and subsequently the mixture 502 applied onto the coated electrode 511 is dried in Step S24. Here, the method shown in description of Step S13 can be used as the application method in Step S23. The method shown in description of Step S14 can be used as the drying method in Step S24. After the drying, a coated electrode 512 is obtained in Step S31.

Here, as shown in FIG. 7, pressing can be performed as Step S25 after the drying in Step S24. As a method of the pressing, the method shown in description of Step S15 can be used.

Next, in Step S32 in FIG. 7, the mixture 503 is prepared.

Next, the mixture 503 is applied onto the coated electrode 512 in Step S33 in FIG. 7, and subsequently the mixture 503 applied onto the coated electrode 512 is dried in Step S34. Here, the method shown in description of Step S13 can be used as the application method in Step S33. The method shown in description of Step S14 can be used as the drying method in Step S34. After the drying, a coated electrode 513 is obtained in Step S41.

Here, as shown in FIG. 7, pressing can be performed as Step S35 after the drying in Step S34. As a method of the pressing, the method shown in description of Step S15 can be used. Although all of Step S15, Step S25, and Step S35 are preferably performed, in the case where the density of the active material layer 414 can be increased without performing one or two of Step S15, Step S25, and Step S35, for example, the one or two of Step S15, Step S25, and Step S35 are not necessarily performed.

Through the above-described fabrication process, the electrode 400B including the first layer 414a, the second layer 414b, and the third layer 414c can be fabricated. Note that in the fabrication method described with reference to FIG. 7, when fabrication of the electrode is completed in Step S31, the electrode 400A including the first layer 414a and the second layer 414b and the electrode 400C including the second layer 414b and the third layer 414c can be fabricated.

FIG. 8 to FIG. 10 show methods for forming a mixture that can be used as the mixture 501, the mixture 502, and the mixture 503 shown in FIG. 7.

A binder 110 is prepared in Step S101 of FIG. 8A, and a dispersion medium 120 is prepared in Step S102.

As the binder 110, for example, one kind or two or more kinds of materials such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose can be used. For example, one kind of water, methanol, ethanol, acetone, tetrahydrofuran (THF), dimethylformamide (DMF), N-methylpyrrolidone (NMP), and dimethyl sulfoxide (DMSO), or a mixed solution of two or more kinds of the above can be used as the dispersion medium 120. A combination of polyvinylidene fluoride (PVDF) and N-methylpyrrolidone (NMP) is preferably used as the combination of the binder 110 and the dispersion medium 120. The details of the binder will be described later.

Next, the binder 110 and the dispersion medium 120 are mixed in Step S103 to obtain a binder mixture 1001 in Step S104. As a mixing means, for example, a propeller mixer, a planetary mixer, or a thin-film spin mixer can be used. In the binder mixture 1001, the binder 110 is preferably dispersed well in the dispersion medium 120.

The binder mixture 1001 is prepared in Step S111 and a conductive material 1002 is prepared in Step S112 in FIG. 8B. In order to knead the mixture stiffly in a later step, the amount of the binder mixture 1001 prepared in Step S111 is set to be smaller than the total amount of the binder mixture 1001 required for forming a positive electrode active material layer to achieve a suitable mixing amount for stiff kneading. In this case, an additional binder mixture 1001 is preferably added in a step after the stiff kneading for a shortage of the binder mixture 1001. Note that stiff kneading means kneading with high viscosity.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive material 1002. The details of the conductive material will be described later.

A graphene compound in this specification and the like includes multilayer graphene, multi graphene, graphene oxide, multilayer graphene oxide, multi graphene oxide, reduced graphene oxide, reduced multilayer graphene oxide, reduced multi graphene oxide, or the like. A graphene compound contains carbon, has a plate-like shape, a sheet-like shape, or the like, and has a two-dimensional structure formed of a six-membered ring composed of carbon atoms. A graphene compound preferably has a curved shape. The two-dimensional structure formed of the six-membered ring composed of carbon atoms may be referred to as a carbon sheet. A graphene compound preferably has a functional group. The graphene compound may be rounded like a carbon nanofiber. The details of the graphene compound will be described later.

Next, the binder mixture 1001 and the conductive material 1002 are mixed in Step S121 to obtain a mixture 1010 in Step S122. As a mixing means, for example, a propeller mixer, a planetary mixer, or a thin-film spin mixer can be used.

Next, the active material 10 is prepared in Step S123 in FIG. 8B. For example, in the case where a mixture 1030 formed in FIG. 8B is used for formation of the first layer 414a, the first active material 411a is used as the active material 10. In the case where the mixture 1030 formed in FIG. 8B is used for formation of the second layer 414b, the second active material 411b is used as the active material 10. In the case where the mixture 1030 formed in FIG. 8B is use for formation of the third layer 414c, the third active material 411c is used as the active material 10.

Next, the mixture 1010 and the active material 10 are mixed in Step S131 to obtain a mixture 1020 in Step S132. As a mixing means, for example, a propeller mixer, a planetary mixer, or a thin-film spin mixer can be used. As the mixing in Step S131, kneading with high viscosity (sometimes also referred to as stiff kneading) is preferably performed. Kneading with high viscosity can weaken aggregation of powder such as the active materials.

Next, the binder mixture 1001 is prepared in Step S133, and a dispersion medium 1003 is prepared in Step S134. In the case where the amount of the binder mixture 1001 prepared in Step S111 is smaller than the total amount required for forming the active material layer, an additional binder mixture 1001 can be added in Step S132 for a shortage of the binder mixture 1001. In the case where the total amount of the binder mixture 1001 required for forming the active material layer is prepared in Step S111, it is unnecessary to prepare the binder mixture 1001 in Step S133. A disperse medium similar to that in Step S102 of FIG. 8A can be used as the disperse medium 1003. It is desirable to adjust the amount of the dispersion medium 1003 to be prepared such that the viscosity is appropriate for application in a later step.

Next, in Step S141, the mixture 1020 of Step S132 and the disperse medium 1003 of Step S134 are mixed with the binder mixture 1001 prepared in Step S133 to obtain the mixture 1030 in Step S142. In the case where a positive electrode active material is used as the active material, the mixture 1030 is referred to as positive electrode slurry in some cases. In the case where a negative electrode active material is used as the active material, the mixture 1030 is referred to as negative electrode slurry in some cases.

FIG. 9A shows an example where the binder mixture 1001, the conductive material 1002, and the active material 10 are mixed at a time in Step S121 for simplifying the fabrication method of the electrode. As the mixing method in Step S121 and the mixing method in Step S131 or in a step of adjusting the viscosity of a mixture 1031 with the amount of the dispersion medium 1003, for example, the methods described in FIG. 8B can be used.

FIG. 9B shows an example of a method for forming a mixture 1032 containing two kinds of active materials 10. The mixture 1032 can be formed by a method similar to the formation method shown in FIG. 8B except that an active material 10a is prepared in Step S123, an active material 10b is prepared in Step S124, and the mixture 1010, the active material 10a, and the active material 10b are mixed in Step S131. Although FIG. 9B shows the example where two kinds of active materials 10 are used, three kinds of active materials 10, which are the active material 10a, the active material 10b, and an active material 10c, may be used. Alternatively, four or more kinds of active materials may be contained.

Although FIG. 9B shows the example where the mixture 1010, the active material 10a, and the active material 10b are mixed at a time in Step S131, as shown in FIG. 10, the active material 10a and the active material 10b may be mixed in advance.

### [Calculation Related to Electrode 1 Having Stacked-Layer Structure]

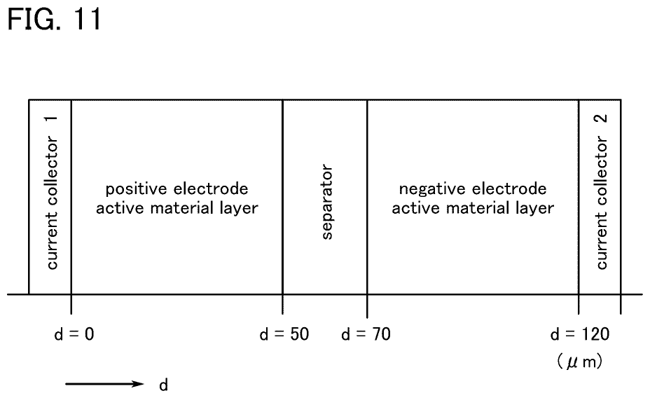

Calculation related to an example of the electrode of one embodiment of the present invention is described with reference to FIG. 11 to FIG. 15.

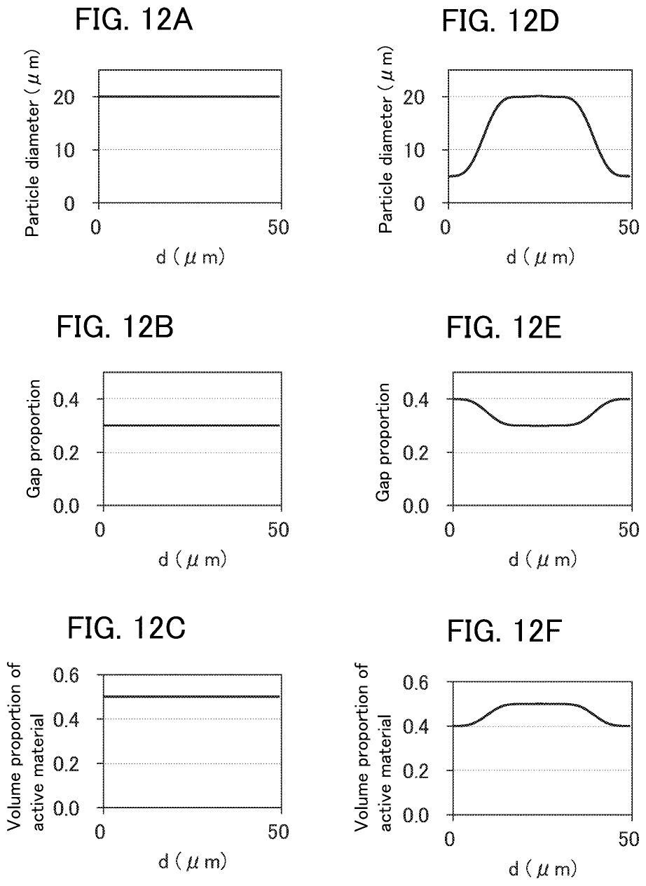

FIG. 11 shows a schematic view of a structure model used for the calculation. Although a current collector (current collector) is shown in FIG. 11 for easy understanding, the calculation is performed on a structure within a range from d=0 μm to d=120 μm, where the current collector is not included. Note that d represents a distance in a direction from an interface between a positive electrode current collector (current collector 1) and a positive electrode active material layer (positive electrode active material layer) to a negative electrode current collector (current collector 2). The interface between the positive electrode current collector and the positive electrode active material layer is positioned at d=0 μm, the interface between the positive electrode active material layer and a separator (separator) is positioned at d=50 μm, the interface between the separator and a negative electrode active material layer (negative electrode active material layer) is positioned at d=70 μm, and the interface between the negative electrode active material layer and the negative electrode current collector is positioned at d=120 μm. Here, FIG. 12A to FIG. 12C show profiles of calculation setting of a model A where a particle diameter, a gap proportion, and a volume proportion of an active material are constant from d=0 μm to d=50 μm. In addition, FIG. 12D to FIG. 12F show profiles of calculation setting of a model B having a three-layer structure from d=0 μm to d=50 μm.

In the model A, the particle diameter of an active material in the positive electrode active material layer is constant at 20 μm. The model B has the three-layer structure. The model B includes a first layer, a second layer, and a third layer in this order from d=0 μm to d=120 μm: the particle diameter of the active material in the first layer is 5 μm, the particle diameter in the second layer is 20 μm, and the particle diameter in the third layer is 5 μm. The thickness of the separator is 20 μm. As for the negative electrode active material layer, the model A and the model B have the same conditions (a film thickness of 50 μm and an active material particle diameter of 1 μm). The calculation is performed under the conditions where charge and discharge currents are 0.1 C, 1 C, 2 C, 3 C, 4 C, and 5 C.

With the calculation structure model shown in FIG. 11 and FIG. 12A to FIG. 12F, calculation is performed to obtain the voltage-capacity curve in charging and discharging. The calculation of charging and discharging simulation is performed using PyBaMM (version 0.4.0). As the calculation model, a DFN (Doyle-Fuller-Newman) model of PyBaMM is used. As parameter sets, Marquis 2019 of PyBaMM which is partly changed is used.

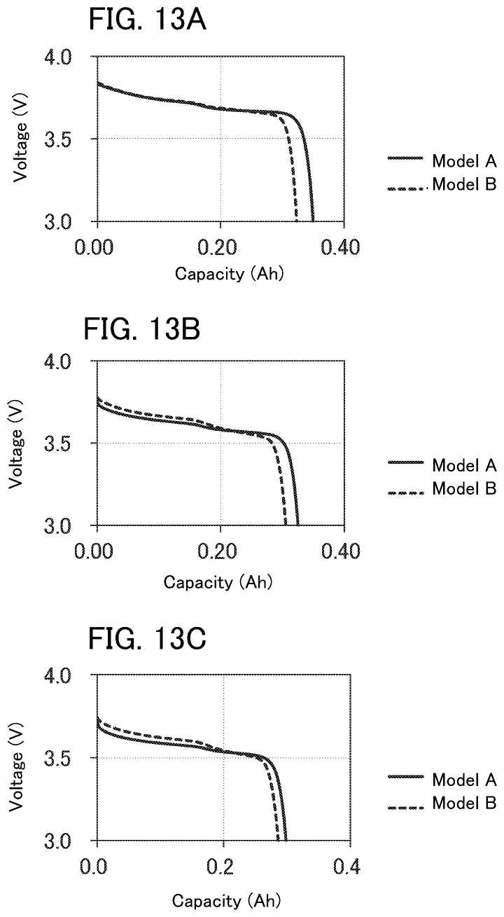

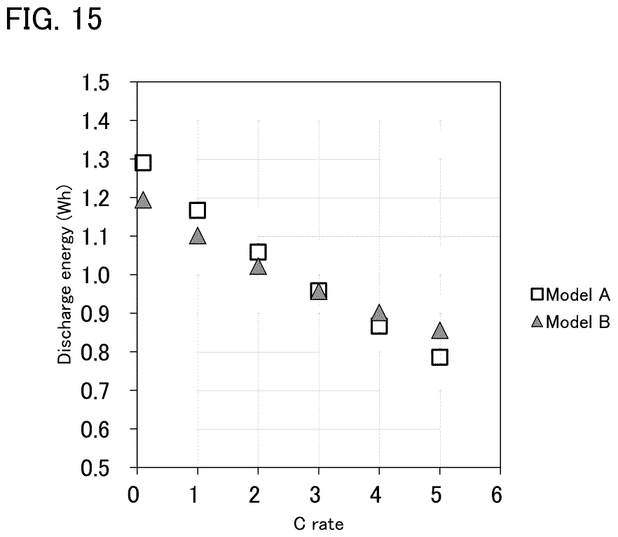

As the results of charging and discharging simulation, FIG. 13A to FIG. 14C show the calculation results of discharge curves. FIG. 13A is a discharge curve at 0.1 C, FIG. 13B is a discharge curve at 1 C, FIG. 13C is a discharge curve at 2 C, FIG. 14A is a discharge curve at 3 C, FIG. 14B is a discharge curve at 4 C, and FIG. 14C is a discharge curve at 5 C. The results of calculation under these conditions are as follows: as shown in FIG. 13A, under a condition of a low discharge rate (a condition of small discharge current), the model A has higher capacity than the model B having a three-layer structure, whereas under a condition of a high discharge rate (a condition of large discharge current) shown in FIG. 14C, the relation is inverted, and the model B having a three-layer structure has higher capacity than the model A. As for these results, FIG. 15 shows the relation between discharge energy and C rate. As shown by the above calculation, the electrode having a stacked-layer structure of one embodiment of the present invention is expected to be suitable for rapid charging and rapid discharging.

### [Electrode 2 Having Stacked-Layer Structure]

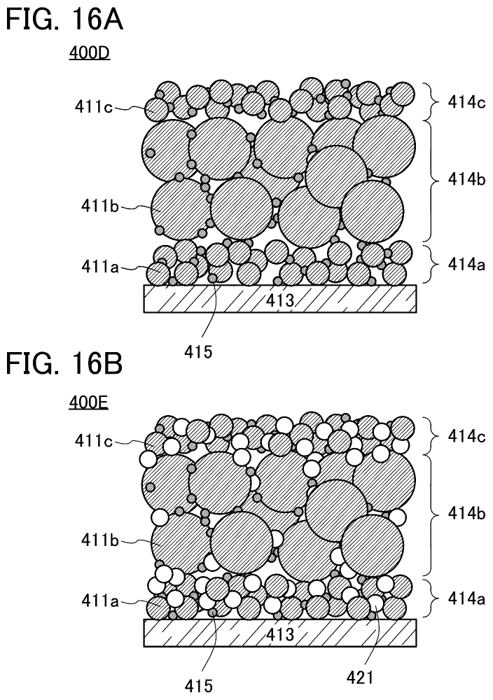

Electrodes of other embodiments of the present invention are described with reference to FIG. 16 to FIG. 21.

FIG. 16A is a schematic view illustrating an electrode 400D of the case where conductive materials 415 are uniformly provided in the electrode 400B having a three-layer structure illustrated in FIG. 5A. FIG. 16B is a schematic view illustrating an electrode 400E of the case where the conductive materials 415 and solid electrolytes 421 are uniformly provided in the electrode 400B having the three-layer structure illustrated in FIG. 5A. The electrode 400D has an electrode structure suitable for a battery that uses a liquid electrolyte. The electrode 400E has an electrode structure suitable for an all-solid-state battery and a semi-solid-state battery that use the solid electrolyte 421.

The positive electrode of one embodiment of the present invention preferably contains the positive electrode active material 100 whose surface portion includes regions that are topotaxy. That is, the positive electrode active material 100 whose surface portion includes regions that are topotaxy is preferably contained as any one or more of the first active material 411a, the second active material 411b, the third active material 411c, the fourth active material 411d, and the fifth active material 411e.

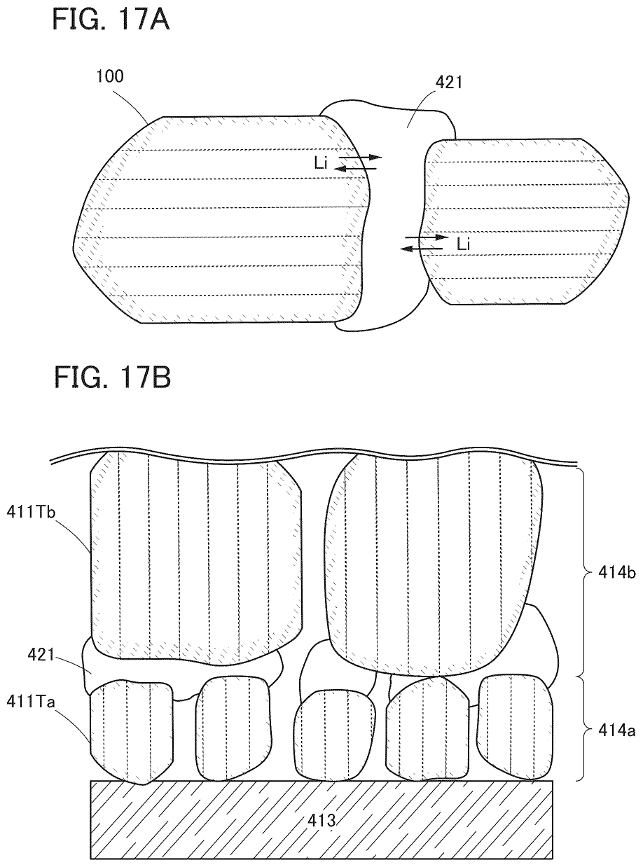

Here, a structure preferable in the case where the positive electrode active material 100 whose surface portion includes regions that are topotaxy is used for the electrode 400E is described with reference to FIG. 17A and FIG. 17B. As in FIG. 1B, a dotted line denotes a crystal plane parallel to arrangement of cations in FIG. 17A and FIG. 17B. In addition, arrows indicate the directions of insertion and extraction of lithium (Li) in charging and discharging. That is, in the positive electrode active material 100, lithium can be inserted and extracted in an end portion of arrangement of cations. Note that in a particle of the positive electrode active material 100, a surface where the end portion of arrangement of cations is exposed is referred to as an edge surface in some cases.

In an electrode containing the solid electrolyte 421, like the electrode 400E, the solid electrolyte 421 is preferably contained in the directions of insertion and extraction of lithium in the positive electrode active material 100, as illustrated in the schematic view in FIG. 17A. In other words, the edge surface of the positive electrode active material 100 preferably includes a region where the surface portion of the positive electrode active material 100 and the solid electrolyte 421 are in contact with each other. It is particularly preferable that the surface portion of the positive electrode active material 100 which is in contact with the solid electrolyte 421 be topotaxy with respect to the inside of the positive electrode active material 100, in which case lithium ions are favorably moved in the contact region between the positive electrode active material 100 and the solid electrolyte 421.

In the case where two positive electrode active materials 100 are in contact with each other with the solid electrolyte 421 therebetween as illustrated in FIG. 17A, the two positive electrode active materials 100 are preferably in contact with each other such that each of them contains the solid electrolyte 421 in the directions of insertion and extraction of lithium in the positive electrode active material 100. In other words, each of the two positive electrode active materials 100 preferably includes a region where the edge surface and the solid electrolyte 421 are in contact with each other. Although the example illustrated in FIG. 17A is an example where two positive electrode active materials 100 and one solid electrolyte 421 are in contact with each other, there is no particular limitation on the number of the positive electrode active materials 100 and the number of the solid electrolytes 421: three positive electrode active materials 100 and one solid electrolyte 421 may be in contact with each other, or two positive electrode active materials 100 and two solid electrolytes 421 may be in contact with each other, without limitation to the example.

FIG. 17B shows a schematic view of a particularly preferable structure as an example where the solid electrolytes 421 are contained in the directions of insertion and extraction of lithium in the positive electrode active material 100. FIG. 17B illustrates an electrode including the first layer 414a over the current collector 413, the second layer 414b over the first layer 414a, and the solid electrolyte 421, in which the first layer 414a contains a positive electrode active material 411Ta whose surface portion includes regions that are topotaxy, and the second layer 414b contains a positive electrode active material 411Tb whose surface portion includes regions that are topotaxy. In this manner, the positive electrode active material 411Ta and the positive electrode active material 411Tb preferably include a region where they are in contact with each other with the solid electrolyte 421 therebetween. Here, a plurality of positive electrode active materials 411Ta contained in the first layer 414a are preferably provided such that the second layer 414b is positioned at the end of the directions of insertion and extraction of lithium in the positive electrode active material 411Ta, as illustrated in FIG. 17B. Similarly, a plurality of positive electrode active materials 411Tb contained in the second layer 414b are preferably provided such that the first layer 414a is positioned at the end of the directions of insertion and extraction of lithium in the positive electrode active material 411Tb. That is, the directions of insertion and extraction of lithium in the positive electrode active material 411Ta are preferably substantially parallel to the directions of insertion and extraction of lithium in the positive electrode active material 411Tb.

In this case, the speed of lithium movement from the first layer 414a to the second layer 414b can be increased. That is, the speed of lithium movement from the first layer 414a in the direction toward the negative electrode can be increased, and thus it can be said that the structure is advantageous in rapid charging and charging in a low-temperature environment. It can also be said that the structure is advantageous in rapid discharging and discharging in a low-temperature environment in discharging (lithium movement from the negative electrode side in the direction toward the first layer 414a), as in charging.

This embodiment describes an example of an electrode having an electrode structure further developed from that illustrated in FIG. 16A and FIG. 16B, which has high capacity density and is suitably for rapid charging and rapid discharging.

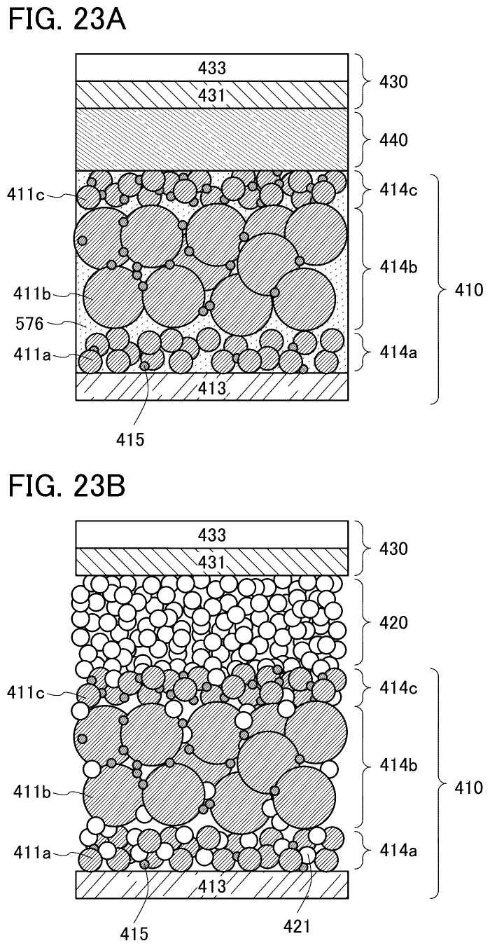

As described above, the first active material 411a contained in the first layer 414a, the second active material 411b contained in the second layer 414b, and the third active material 411c contained in the third layer 414c differ in the distance from the current collector 413. It can also be said that the active materials differ in the distance from the separator 440 as illustrated in FIG. 23A. It can also be said that the active materials differ in the distance from the solid electrolyte layer 420 as illustrated in FIG. 23B.

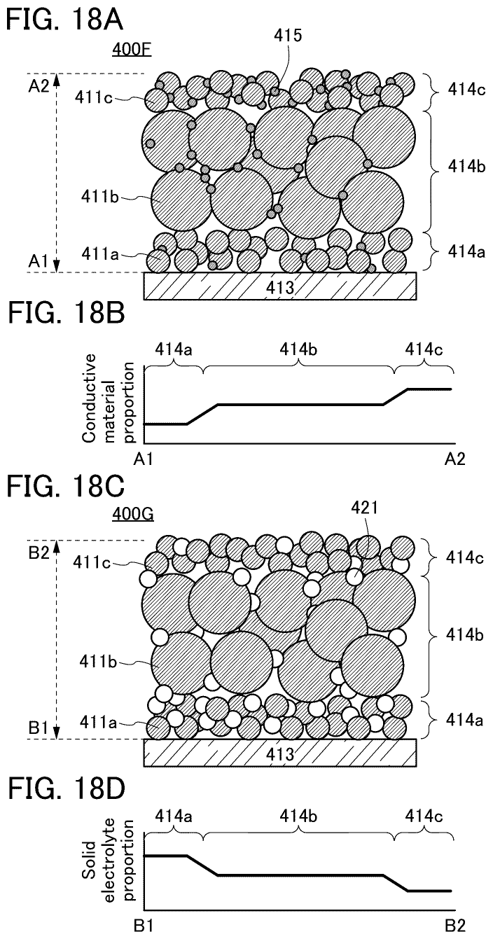

Here, the third layer 414c having a relatively long distance from the current collector 413 is considered. Due to the long distance from the current collector 413, the third layer 414c is a region with high electron transfer resistance (also referred to as a region with low electron mobility) in the active layer 414. Similarly, the second layer 414b has higher electron transfer resistance than the first layer 414a. A structure for reducing the difference in electron transfer resistance is illustrated in FIG. 18A and FIG. 18B. FIG. 18B is a diagram showing a profile of the conductive material proportion between A1-A2 in FIG. 18A. As shown in FIG. 18B, the difference in electron transfer resistance among the first layer 414a, the second layer 414b, and the third layer 414c can be reduced when the proportion of the conductive material contained in the second layer 414b is higher than the proportion of the conductive material contained in the first layer 414a, and the proportion of the conductive material contained in the third layer 414c is higher than the proportion of the conductive material contained in the second layer 414b (an electrode 400F). In other words, it is preferable that the mass of the conductive material contained in the third layer 414c be larger than the mass of the conductive material contained in the second layer 414b, and the mass of the conductive material contained in the second layer 414b be larger than the mass of the conductive material contained in the first layer 414a. This can reduce non-uniformity in battery reaction in the active material layer 414 in rapid charging and rapid discharging.

Here, the first layer 414a having a relatively long distance from the solid electrolyte layer 420 is considered. Due to the long distance from the solid electrolyte layer 420, the first layer 414a is a region with high ion transfer resistance (also referred to as a region with low ion conductivity) in the active layer 414. Similarly, the second layer 414b has higher ion transfer resistance than the third layer 414c. A structure for reducing the difference in ion transfer resistance is shown in FIG. 18C and FIG. 18D. FIG. 18D is a diagram showing a profile of the solid electrolyte proportion between B1-B2 in FIG. 18C. As shown in FIG. 18D, the difference in ion transfer resistance among the first layer 414a, the second layer 414b, and the third layer 414c can be reduced when the proportion of the solid electrolyte contained in the second layer 414b is higher than the proportion of the solid electrolyte contained in the third layer 414c, and the proportion of the solid electrolyte contained in the first layer 414a is higher than the proportion of the solid electrolyte contained in the second layer 414b (an electrode 400G). In other words, it is preferable that the mass of the solid electrolyte contained in the first layer 414a be larger than the mass of the solid electrolyte contained in the second layer 414b, and the mass of the solid electrolyte contained in the second layer 414b be larger than the mass of the solid electrolyte contained in the third layer 414c. This can reduce non-uniformity in battery reaction in the active material layer 414 in rapid charging and rapid discharging.

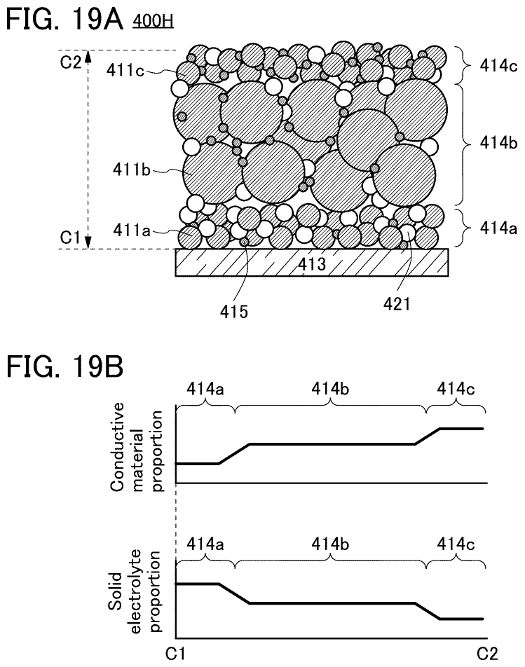

FIG. 19A and FIG. 19B show an electrode structure (an electrode 400H) of the case where the profile of the conductive material proportion shown in FIG. 18A and FIG. 18B and the profile of the solid electrolyte proportion shown in FIG. 18C and FIG. 18D overlap with each other. FIG. 19B is a diagram showing the profile of the conductive material proportion and the profile of the solid electrolyte proportion between C1-C2 in FIG. 19A. In the case where an all-solid-state battery includes the electrode 400H, the all-solid-state battery can be more suitable for rapid charging and rapid discharging when the difference in electron transfer resistance in the active material layer 414 is reduced and the difference in ion transfer resistance in the active material layer 414 is reduced.

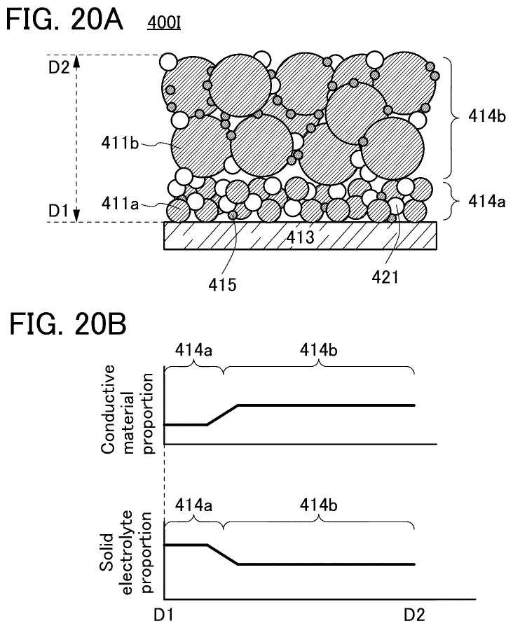

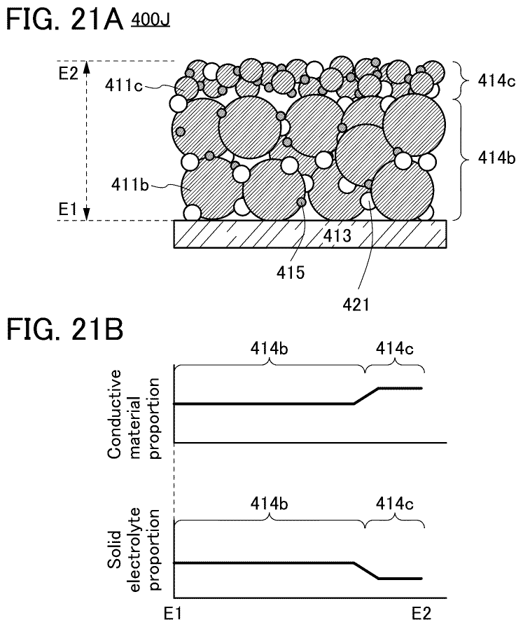

FIG. 20 and FIG. 21 show examples where the profile of the conductive material proportion and the profile of the solid electrolyte proportion shown in FIG. 18 and FIG. 19 are applied to electrodes each having a two-layer structure (an electrode 400I and an electrode 400J). Even with the electrode having a two-layer structure, an all-solid-state battery can be more suitable for rapid charging and rapid discharging by reducing the difference in electron transfer resistance in the active layer 414 and reducing the difference in ion transfer resistance in the active layer 414, as described above.

Next, in the following sections, additional descriptions are given for the positive electrode, the negative electrode, the current collector, the conductive material, the binder, the graphene compound, the separator, the electrolyte, and an exterior body, which are described above.

### [Positive Electrode]

The positive electrode includes a positive electrode active material layer and a positive electrode current collector. The positive electrode active material layer contains a positive electrode active material, and may contain a conductive material 415 described later and a binder. As a structure of the positive electrode active material layer, the above-described stacked-layer structure is preferably included.

### [Negative Electrode]

The negative electrode includes a negative electrode active material layer and a negative electrode current collector. The negative electrode active material layer contains a negative electrode active material, and may contain the conductive material 415 described later and a binder. As a structure of the negative electrode active material layer, the above-described stacked-layer structure is preferably included.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case where the negative electrode that does not contain a negative electrode active material is used, a film for making lithium deposition uniform may be provided over the negative electrode current collector. For the film for making lithium deposition uniform, for example, a solid electrolyte having lithium ion conductivity can be used. As the solid electrolyte, a sulfide-particle-based solid electrolyte, an oxide-based solid electrolyte, or a polymer-based solid electrolyte can be used, for example. In particular, the polymer-based solid electrolyte can be uniformly formed as a film over the negative electrode current collector relatively easily, and thus is suitable for the film for making lithium deposition uniform. Moreover, as the film for making lithium deposition uniform, for example, a metal film that forms an alloy with lithium can be used. As the metal film that forms an alloy with lithium, for example, a magnesium metal film can be used. Lithium and magnesium form a solid solution in a wide range of compositions, and thus is suitable for the film for making lithium deposition uniform.

In the case where the negative electrode that does not contain a negative electrode active material is used, a negative electrode current collector having unevenness can be used. In the case where the negative electrode current collector having unevenness is used, a depression of the negative electrode current collector becomes a cavity in which lithium contained in the negative electrode current collector is easily deposited, so that the lithium can be inhibited from having a dendrite-like shape when being deposited.

### [Current Collector]

For each of the positive electrode current collector and the negative electrode current collector, it is possible to use a material which has high conductivity and is not alloyed with carrier ions of lithium or the like, e.g., a metal such as stainless steel, gold, platinum, zinc, iron, copper, aluminum, or titanium, an alloy thereof, or the like. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions of lithium or the like is preferably used for the negative electrode current collector.

As the current collector, a titanium compound may be stacked over the above-described metal. As a titanium compound, for example, it is possible to use one selected from titanium nitride, titanium oxide, titanium nitride in which part of nitrogen substituted for oxygen, titanium oxynitride (TION, where 0<x<2 and 0<y<1), and titanium oxide in which part of oxygen is substituted for nitrogen, or a mixture or a stack of two or more of them. Titanium nitride is particularly preferable because it has high conductivity and has a high capability of inhibiting oxygen diffusion. Providing a titanium compound over the surface of the current collector inhibits a reaction between a material contained in the active material layer formed over the current collector and the metal, for example. In the case where the active material layer includes a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, providing a titanium compound over aluminum can inhibit an oxidation reaction between the current collector and the graphene oxide.

### [Conductive Material]

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as the positive electrode active material layer or the negative electrode active material layer preferably contains a conductive material.

For example, one kind or two or more kinds of carbon black such as acetylene black or furnace black, graphite such as artificial graphite or natural graphite, carbon fiber such as carbon nanofiber or carbon nanotube, and a graphene compound can be used as the conductive material.

As the carbon fiber, carbon fiber such as mesophase pitch-based carbon fiber or isotropic pitch-based carbon fiber can be used, for example. As the carbon fiber, carbon nanofiber, carbon nanotube, or the like can also be used. Carbon nanotube can be formed by, for example, a vapor deposition method.

The active material layer may contain, as a conductive material, metal powder or metal fiber of copper, nickel, aluminum, silver, gold, or the like, a conductive ceramic material, or the like.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Thus, discharge capacity of the secondary battery can be increased.

A particulate carbon-containing compound such as carbon black or graphite and a fibrous carbon-containing compound such as carbon nanotube easily enter a microscopic space. A microscopic space means, for example, a region or the like between a plurality of active materials. When a carbon-containing compound that easily enters a microscopic space and a sheet-like carbon-containing compound, such as graphene, that can impart conductivity to a plurality of particles are used in combination, the density of the electrode is increased and an excellent conductive path can be formed. The secondary battery obtained by the fabrication method of one embodiment of the present invention can have high capacity density and stability, and is effective as an in-vehicle secondary battery.

### [Binder]

The active material layer preferably includes a binder. The binder binds or fixes the electrolyte and the active material, for example. In addition, the binder can bind or fix the electrolyte and a carbon-based material, the active material and a carbon-based material, a plurality of active materials, a plurality of carbon-based materials, or the like.

As the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Polyimide has extremely excellent thermal, mechanical, and chemical stability.

A fluorine polymer which is a high molecular material containing fluorine, specifically, polyvinylidene fluoride (PVDF) or the like can be used. PVDF is a resin having a melting point in the range of higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or an ethylene-propylene-diene copolymer is preferably used. Fluororubber can also be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Two or more of the above materials may be used in combination for the binder.

### [Graphene Compound]

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound preferably has a bent shape. The graphene compound may be rounded like a carbon nanofiber.

In this specification and the like, for example, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms, for example. The reduced graphene oxide may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

Reducing graphene oxide can form a vacancy in a graphene compound in some cases.

Furthermore, a material in which an end portion of graphene is terminated with fluorine may be used.

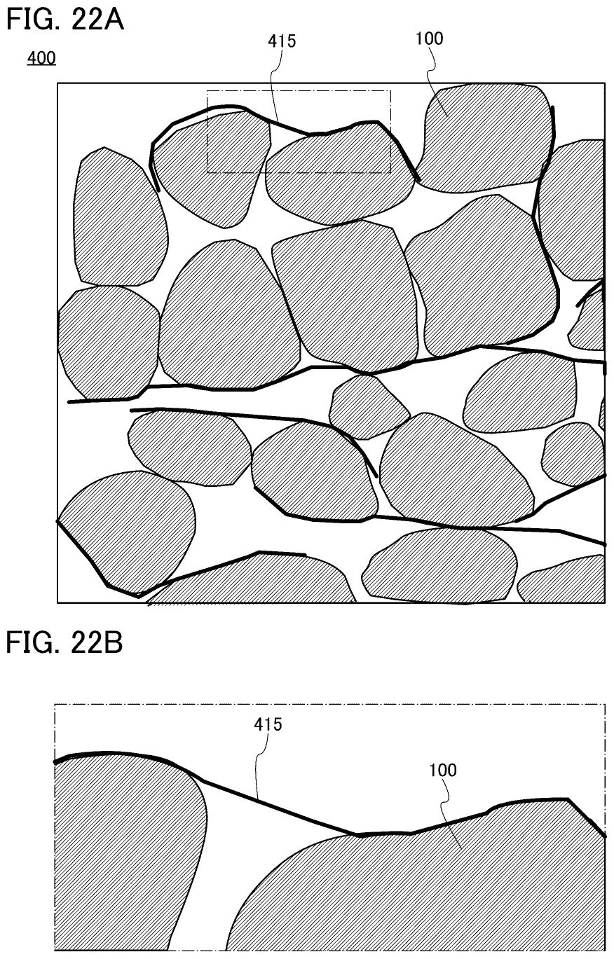

In the longitudinal cross section of the active material layer, the sheet-like graphene compounds are dispersed substantially uniformly in a region inside the active material layer. As illustrated in FIG. 22A and FIG. 22B, the plurality of graphene compounds are formed to partly cover the plurality of particulate active materials or adhere to the surfaces of the plurality of particulate active materials, so that the graphene compounds make surface contact with the particulate active materials.

Here, the plurality of graphene compounds can be bonded to each other to form a net-like graphene compound sheet (hereinafter, referred to as a graphene compound net or a graphene net). A graphene net that covers the active material can function also as a binder for bonding the active materials. Accordingly, the amount of the binder can be reduced, or the binder does not have to be used; thus, the proportion of the active material in the electrode volume and the electrode weight can be increased. That is, the charge and discharge capacity of the secondary battery can be increased.

Here, preferably, graphene oxide is used as the graphene compound and mixed with an active material to form a layer to be the active material layer, and then reduction is performed. That is, the formed active material layer preferably contains reduced graphene oxide. When graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conductive path. Note that graphene oxide can be reduced by heat treatment or with the use of a reducing agent, for example.

It is possible to form, with a spray dry apparatus, a graphene compound serving as a conductive material as a coating film to cover the entire surface of the active material in advance and to electrically connect the active materials by the graphene compound to form a conductive path.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

### [Separator]

A separator is placed between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator is a porous material including pores each with a diameter of at least 2 nm. Note that the separator preferably includes a pore with a size greater than or equal to 6.5 nm, further preferably includes a pore with a size of approximately 20 nm. In the case of the above-described semi-solid-state secondary battery, the separator can be omitted.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. As the fluorine-based material, PVDF or polytetrafluoroethylene can be used, for example. Examples of the polyamide-based material include nylon and aramid (meta-based aramid and para-based aramid).

When the separator is coated with the ceramic-based material, the oxidation resistance is improved: hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), and sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄·50LisBO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage such as stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Different solid electrolytes may be mixed and used.

In particular, Li₁₋ₓAlₓTi₂₋ₓ(PO₄)₃ (0<x<1) having a NASICON crystal structure (hereinafter, LATP) is preferable because LATP contains aluminum and titanium, each of which is the element the positive electrode active material used in the secondary battery of one embodiment of the present invention is allowed to contain, and thus a synergistic effect of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

In the case of using the liquid electrolyte 576 for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio as the electrolyte 576, for example.

Alternatively, the use of one or more ionic liquids (room temperature molten salts) that are less likely to burn and volatize as the solvent of the electrolyte 576 can prevent a secondary battery from exploding or catching fire even when the secondary battery internally shorts out or the temperature of the internal region increases owing to overcharging or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

In particular, in the case where silicon is used as the active material contained in the negative electrode in the secondary battery of one embodiment of the present invention, the liquid electrolyte 576 containing an ionic liquid is preferably used.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion.

In the case where lithium ions are used as carrier ions, the electrolyte contains lithium salt, for example. As the lithium salt, LiPF₆, LiClO₄, LiAsF₆, LIBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₂F₉SO₂) (CF₃SO₂), LIN(C₂FsSO₂)₂, or the like can be used, for example.

In addition, the electrolyte preferably contains fluorine. As the electrolyte containing fluorine, an electrolyte including one kind or two or more kinds of fluorinated cyclic carbonates and lithium ions can be used, for example. The fluorinated cyclic carbonate can improve the nonflammability and improve the safety of the lithium-ion secondary battery.

As the fluorinated cyclic carbonate, an ethylene fluoride carbonate such as monofluoroethylene carbonate (fluoroethylene carbonate, FEC or FIEC), difluoroethylene carbonate (DFEC or F2EC), trifluoroethylene carbonate (F3EC), or tetrafluoroethylene carbonate (F4EC) can be used. Note that DFEC includes an isomer such as cis-4,5 or trans-4,5. For operation at low temperatures, it is important that a lithium ion is solvated by using one kind or two or more kinds of fluorinated cyclic carbonates as the electrolyte and is transported in the electrolyte included in the electrode in charging and discharging. When the fluorinated cyclic carbonate is not used as a small amount of additive but is allowed to contribute to transportation of a lithium ion in charging and discharging, operation can be performed at low temperatures. In the secondary battery, a cluster of approximately several to several tens of lithium ions moves.

The use of the fluorinated cyclic carbonate for the electrolyte can reduce desolvation energy that is necessary for the solvated lithium ion in the electrolyte of the electrode to enter an active material particle. The reduction in the desolvation energy facilitates insertion or extraction of a lithium ion into/from the active material particle even in a low-temperature range. Although a lithium ion sometimes moves remaining in the solvated state, a hopping phenomenon in which coordinated solvent molecules are interchanged occurs in some cases. When desolvation of a lithium ion becomes easy, movement owing to the hopping phenomenon is facilitated and the lithium ion may easily move. A decomposition product of the electrolyte generated by charging and discharging of the secondary battery clings to the surface of the active material, which might cause deterioration of the secondary battery. However, since the electrolyte containing fluorine is smooth, the decomposition product of the electrolyte is less likely to attach to the surface of the active material. Therefore, the deterioration of the secondary battery can be inhibited.

In some cases, a plurality of solvated lithium ions form a cluster in the electrolyte and the cluster moves in the negative electrode, between the positive electrode and the negative electrode, or in the positive electrode, for example.

In this specification, an electrolyte is a general term of a solid electrolyte, a liquid electrolyte, a semi-solid-state electrolyte, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. In addition, a structure may be employed in which a binder, a graphene compound, or the like clings to or is held by the electrolyte containing fluorine. This structure can maintain the state where the viscosity of the electrolyte is low, i.e., the state where the electrolyte is smooth, and can improve the reliability of the secondary battery. Note that DFEC to which two fluorine atoms are bonded and F4EC to which four fluorine atoms are bonded have lower viscosities, are smoother, and are coordinated to lithium more weakly than FEC to which one fluorine atom is bonded. Accordingly, it is possible to reduce attachment of a decomposition product with a high viscosity to an active material particle. When a decomposition product with a high viscosity is attached to or clings to an active material particle, a lithium ion is less likely to move at an interface between active material particles. The solvating electrolyte containing fluorine reduces generation of a decomposition product that is to be attached to the surface of the active material (the positive electrode active material or the negative electrode active material). Moreover, the use of the electrolyte containing fluorine can prevent attachment of a decomposition product, which can prevent generation and growth of a dendrite.

The use of the electrolyte containing fluorine as a main component is also a feature, and the amount of the electrolyte containing fluorine is higher than or equal to 5 volume % or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after fabricated, the proportions of a plurality of kinds of electrolytes are difficult to quantify, but it is possible to judge whether one kind of organic compound occupies higher than or equal to 5 volume % of the whole electrolyte.

With the use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

Furthermore, an additive such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more of aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO): PVDF: polyacrylonitrile: a copolymer containing any of them; and the like can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery and an all-solid-state battery can be fabricated.

In this specification and the like, a layer provided between a positive electrode and a negative electrode is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of an electrolyte layer, a positive electrode, and a negative electrode includes a semi-solid-state material. The semi-solid-state here does not mean that the proportion of a solid-state material is 50%. The semi-solid-state means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery.

The electrolyte 576 contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound containing a polar group to which cations can be coordinated. As the polar group, an ether group, an ester group, a nitrile group, a carbonyl group, siloxane, or the like is preferably included.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure. Alternatively, the lithium-ion conductive polymer may be a copolymer. The molecular weight is preferably greater than or equal to ten thousand, further preferably greater than or equal to hundred thousand, for example.

In the lithium-ion conductive polymer, lithium ions move by changing polar groups to interact with, due to the local motion (also referred to as segmental motion) of polymer chains. In PEO, for example, lithium ions move by changing oxygen to interact with, due to the segmental motion of ether chains. When the temperature is close to or higher than the melting point or softening point of the lithium-ion conductive polymer, the crystal regions melt and amorphous regions increase, so that the motion of the ether chains becomes active and the ion conductivity increases. Thus, in the case where PEO is used as the lithium-ion conductive polymer, charging and discharging are preferably performed at higher than or equal to 60° C.

According to the ionic radius of Shannon (Shannon et al., Acta A 32 (1976) 751.), the radius of a monovalent lithium ion is 0.590×10⁻¹ nm in the case of tetracoordination, 0.76×10⁻¹ nm in the case of hexacoordination, and 0.92×10⁻¹ nm in the case of octacoordination. The radius of a bivalent oxygen ion is 1.35×10⁻¹ nm in the case of bicoordination, 1.36×10−1 nm in the case of tricoordination, 1.38×10⁻¹ nm in the case of tetracoordination, 1.40×10⁻¹ nm in the case of hexacoordination, and 1.42×10⁻¹ nm in the case of octacoordination. The distance between polar groups included in adjacent lithium-ion conductive polymer chains is preferably greater than or equal to the distance that allows lithium ions and anions contained in the polar groups to exist stably while the above ionic radius is maintained. Furthermore, the distance between the polar groups is preferably close enough to cause interaction between the lithium ions and the polar groups. Note that the distance is not necessarily always kept constant because the segmental motion occurs as described above. The distance needs to be appropriate only when lithium ions are transferred.

As the lithium salt, for example, it is possible to use a compound containing lithium and at least one of phosphorus, fluorine, nitrogen, sulfur, oxygen, chlorine, arsenic, boron, aluminum, bromine, and iodine. For example, one of lithium salts such as LiPF₆, LIN(FSO₂)₂ (lithiumbis(fluorosulfonyl)imide, LiFSI), LIN(SO₂CF₃)₂, lithium bis(trifluoromethanesulfonyl)amide, LiTFSA), LiClO₄, LiAsF₆, LIBF₄, LiAICl₄, LISCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination at an appropriate ratio.

It is particularly preferable to use LiFSI because favorable characteristics at low temperatures can be obtained. Note that LiFSI and LiTFSA are less likely to react with water than LiPF₆ or the like. This can relax the dew point control in fabricating an electrode and an electrolyte layer that use LiFSI. For example, the fabrication can be performed even in a normal air atmosphere, not only in an inert atmosphere of argon or the like in which moisture is excluded as much as possible or in a dry room in which a dew point is controlled. This is preferable because the productivity can be improved. When the segmental motion of ether chains is used for lithium conduction, it is particularly preferable to use a lithium salt that is highly dissociable and has a plasticizing effect, such as LiFSI and LiTFSA, in which case the operating temperature range can be wide.

When containing no or extremely little organic solvent, the secondary battery can be less likely to catch fire and ignite and thus can have higher level of safety, which is preferable. When the electrolyte 576 is an electrolyte layer containing no or extremely little organic solvent, the electrolyte layer can have enough strength and thus can electrically insulate the positive electrode from the negative electrode without a separator. Since a separator is not necessary, the secondary battery can have high productivity. When an electrolyte layer contains the electrolyte 576 and an inorganic filler, the secondary battery can have higher strength and higher level of safety.

### [Exterior Body]

For an exterior body included in the secondary battery, a metal material such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. As the film, a fluorine resin film is preferably used. The fluorine resin film has high stability to acid, alkali, an organic solvent, and the like and suppresses a side reaction, corrosion, or the like caused by a reaction of a secondary battery or the like, whereby an excellent secondary battery can be provided. Examples of the fluorine resin film include PTFE (polytetrafluoroethylene), PFA (perfluoroalkoxy alkane: a copolymer of tetrafluoroethylene and perfluoroalkyl vinyl ether), FEP (a perfluoroethylene-propene copolymer: a copolymer of tetrafluoroethylene and hexafluoropropylene), and ETFE (an ethylene-tetrafluoroethylene copolymer: a copolymer of tetrafluoroethylene and ethylene).

### [Internal Structure of Battery]

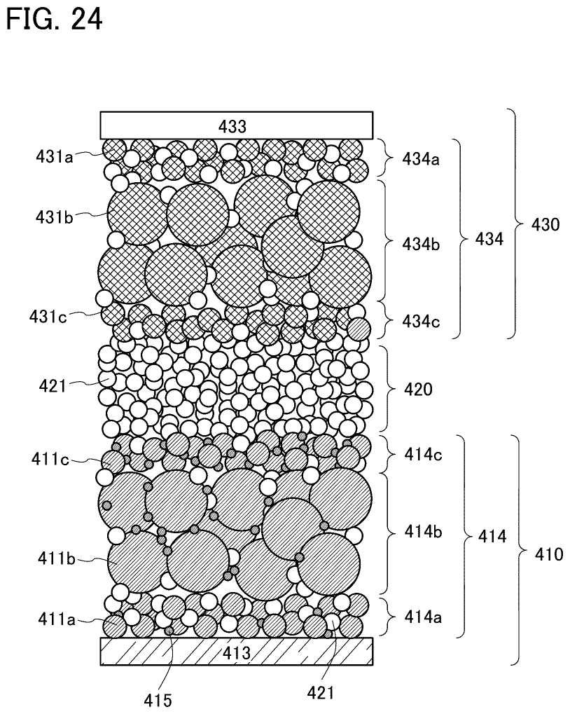

Batteries including the electrodes of one embodiment of the present invention are described with reference to FIG. 23 and FIG. 24.

As illustrated in FIG. 23A, a secondary battery of one embodiment of the present invention includes a positive electrode 410, a separator 440, and a negative electrode 430. The positive electrode 410 illustrated in FIG. 23A is a positive electrode using the above-described electrode structure illustrated in FIG. 18A, and can use any one or more of positive electrode active materials to be described in Embodiment 2 and Embodiment 3 as the positive electrode active material. The secondary battery illustrated in FIG. 23A includes a liquid electrolyte 576, and the liquid electrolyte 576 preferably fills a space between particles in a stacked-layer structure of the positive electrode 410.

As illustrated in FIG. 23B and FIG. 24, the secondary battery of one embodiment of the present invention includes the positive electrode 410, the solid electrolyte layer 420, and the negative electrode 430. The positive electrode 410 illustrated in FIG. 23B and FIG. 24 is a positive electrode using the above-described electrode structure illustrated in FIG. 19A, and can use any one or more of positive electrode active materials to be described in Embodiment 2 and Embodiment 3 as the positive electrode active material. The active material layer 414 included in the positive electrode may contain the conductive material and the binder described above.

The solid electrolyte layer 420 contains the solid electrolyte 421. The solid electrolyte layer 420 is positioned between the positive electrode 410 and the negative electrode 430 and is a region that includes neither the positive electrode 410 nor the negative electrode 430.

As illustrated in FIG. 24, the negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive material and a binder. Note that when metal lithium is used as the negative electrode active material 431, metal lithium does not need to be processed into particles; thus, the negative electrode 430 not including the solid electrolyte 421 can be formed, as illustrated in FIG. 23B. Metallic lithium is preferably used for the negative electrode 430 to increase the energy density of a secondary battery.

As the solid electrolyte 421 included in the solid electrolyte layer 420, a sulfide-based solid electrolyte, an oxide-based solid electrolyte, or a halide-based solid electrolyte can be used, for example.

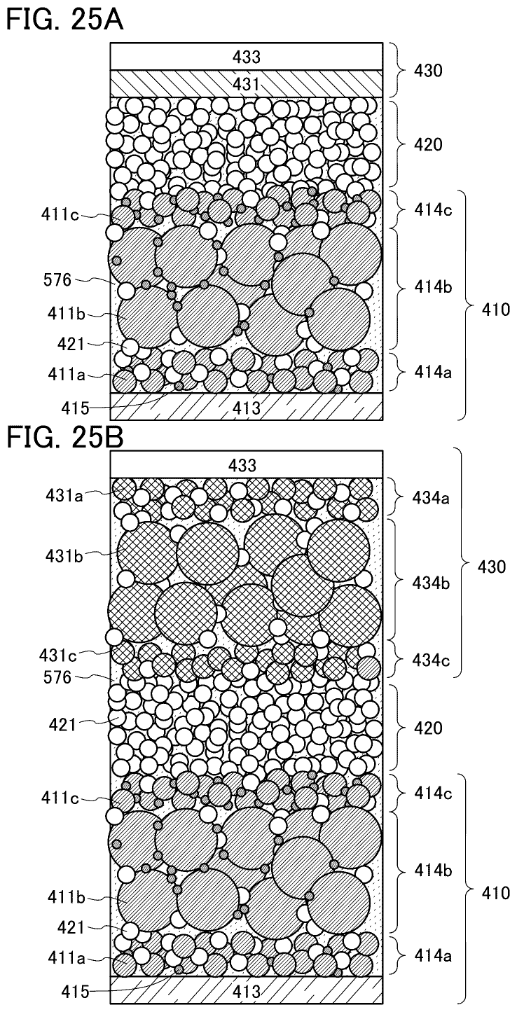

FIG. 25A and FIG. 25B illustrate modification examples of the battery containing the solid electrolyte 421 illustrated in FIG. 23B and FIG. 24. The batteries illustrated in FIG. 25A and FIG. 25B include not only the solid electrolyte 421 but also the liquid electrolyte 576. These batteries include a solid electrolyte and a liquid electrolyte, and thus are referred to as semi-solid-state batteries in some cases. A semi-solid-state battery is a battery having both flame-resistance that is an advantage of the solid electrolyte 421 and an increased contact interface between an active material and an electrolyte, which is an advantage of the liquid electrolyte 576. At this time, it is particularly preferable that an electrolyte including an ionic liquid be used as the liquid electrolyte 576, in which case the battery becomes flame-resistant.

The contents in this embodiment can be freely combined with the contents in the other embodiments.

### Embodiment 2

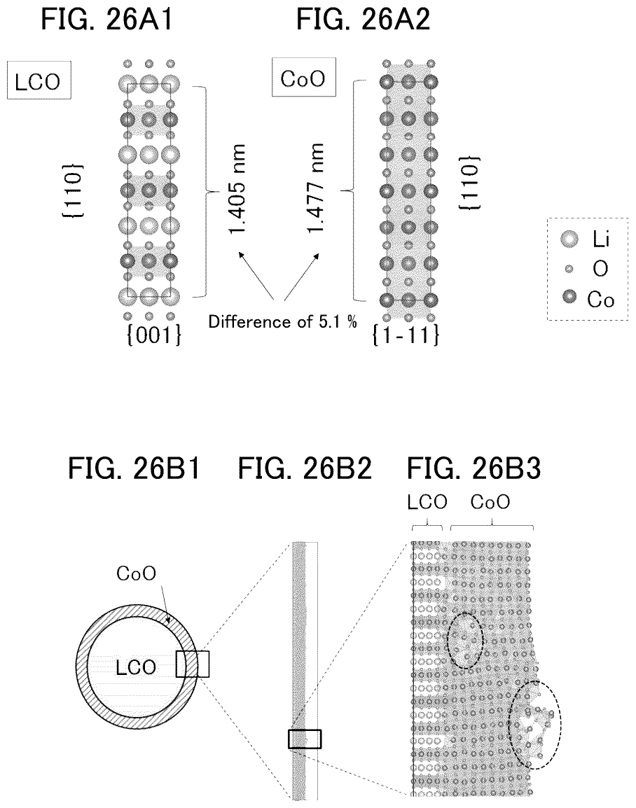

In this embodiment, a positive electrode active material 100A that is an example of the positive electrode active material 100 usable for a secondary battery of one embodiment of the present invention and a fabrication method of the positive electrode active material 100A are described with reference to FIG. 26A to FIG. 36.

### [Positive Electrode Active Material]

FIG. 1B is a cross-sectional view of the positive electrode active material 100A usable for a secondary battery of one embodiment of the present invention. FIG. 2A and FIG. 2B show enlarged views of the portion near the line A-B in FIG. 1B. FIG. 2C and FIG. 2D show enlarged views of a portion near the line C-D in FIG. 1B.

As illustrated in FIG. 1B and FIG. 2A to FIG. 2D, the positive electrode active material 100A includes the surface portion 100a and the inner portion 100b. In each drawing, a dashed line denotes a boundary between the surface portion 100a and the inner portion 100b.

### <Element Contained in Positive Electrode Active Material>

The positive electrode active material 100A contains lithium, the transition metal M, oxygen, and an additive element A. The positive electrode active material 100A can contain a composite oxide containing lithium and the transition metal M (LiMO₂) to which the additive element A is added. Note that the composition of the composite oxide is not strictly limited to Li:M:O=1:1:2. In some cases, a positive electrode active material to which the additive element A is added is referred to as a composite oxide.

A positive electrode active material of a lithium-ion secondary battery needs to contain a transition metal that can be oxidized and reduced in order to maintain a neutrally charged state even when lithium ions are inserted and extracted. It is preferable that the positive electrode active material 100A of one embodiment of the present invention mainly use cobalt as the transition metal M taking part in an oxidation-reduction reaction. In addition to cobalt, at least one or two selected from nickel and manganese may be used. Using cobalt at higher than or equal to 75 atomic %, preferably higher than or equal to 90 atomic %, further preferably higher than or equal to 95 atomic % as the transition metal M contained in the positive electrode active material 100A is preferable because it brings many advantages such as relatively easy synthesis, easy handling, and excellent cycle performance.

When cobalt is used as the transition metal M in the positive electrode active material 100A at greater than or equal to 75 atomic %, preferably greater than or equal to 90 atomic %, further preferably greater than or equal to 95 atomic %, LixCoO₂ with small x is more stable than a composite oxide in which nickel accounts for the majority of the transition metal M, such as lithium nickel oxide (LiNiO₂). This is probably because the influence of distortion by the Jahn-Teller effect is smaller in the case of using cobalt than in the case of using nickel. It is known that the Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

Using nickel at greater than or equal to 33 at %, preferably greater than or equal to 60 at %, further preferably greater than or equal to 80 at % as the transition metal M contained in the positive electrode active material 100A is preferable because in that case, the cost of the raw materials might be lower than that in the case of using a large amount of cobalt and charge and discharge capacity per weight might be increased.

As the additive element A contained in the positive electrode active material 100A, one or more magnesium, fluorine, nickel, aluminum, titanium, zirconium, vanadium, iron, manganese, chromium, niobium, cobalt, arsenic, zinc, silicon, sulfur, phosphorus, boron, bromine, and beryllium is preferably used. The total percentage of the transition metal among the additive elements A is preferably less than 25 atomic %, further preferably less than 10 atomic %, still further preferably less than 5 atomic %.

That is, the positive electrode active material 100A can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

These additive elements A further stabilize the crystal structure of the positive electrode active material 100 A in some cases as described later. In this specification and the like, the additive element A can be rephrased as part of a raw material or a mixture.

Note that as the additive element A, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

For example, when the positive electrode active material 100A is substantially free from manganese, the above advantages such as relatively easy synthesis, easy handling, and excellent cycle performance are sometimes enhanced. The weight of manganese contained in the positive electrode active material 100A is preferably less than or equal to 600 ppm, further preferably less than or equal to 100 ppm, for example. The weight of manganese can be analyzed by GD-MS (glow discharge mass spectrometry), for example.

Next, the results of calculating crystal structures of surface portions of the case where an additive element is contained and the case where no additive element is contained are described with reference to FIG. 26 to FIG. 29.

In a surface portion of lithium cobalt oxide not containing any additive element, cobalt oxide exists in some cases. The cobalt oxide might contain a metal vacancy. FIG. 26A1 illustrates the crystal structure of the lithium cobalt oxide (LCO), and FIG. 26A2 illustrates the crystal structure of the cobalt oxide (CoO). As illustrated in FIG. 26A1 and FIG. 26A2, the crystal orientations in {110} of LCO and {110} of CoO are substantially aligned with each other; however, the interplanar spacing of {001} that is a plane perpendicular to {110} of LCO is 1.405 nm and a value six times the interplanar spacing {1-11} that is a plane perpendicular to {110} of CoO is 1.477 nm; thus, there is a difference of 5.1% between the interplanar spacings.

FIG. 26B1 is a schematic view of lithium cobalt oxide (LCO) containing cobalt oxide (CoO) in a surface portion. FIG. 26B2 shows an enlarged view of the surface portion. FIG. 26B3 shows the results of classical molecular dynamic calculation performed on part of the surface portion containing LCO and CoO. There is a difference of more than 5% between the interplanar spacing of {001} that is a plane perpendicular to {110} of LCO and a value six times the interplanar spacing of {1-11} that is a plane perpendicular to {110} of CoO; thus, a plurality of shifts in atomic arrangement are generated like portions denoted by dashed circles in FIG. 26B3. It is considered that cobalt and/or oxygen is easily released in such unstable portions. Such unstable portions can thus be starting points of pits.

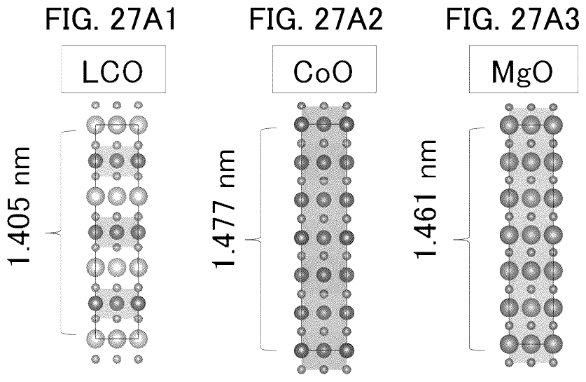

Similarly, in the case of lithium cobalt oxide containing an additive element, cobalt oxide exists in the surface portion in some cases. FIG. 27A1 illustrates the crystal structure of lithium cobalt oxide (LCO), FIG. 27A2 illustrates the crystal structure of cobalt oxide (CoO), and FIG. 27A3 illustrates the crystal structure of magnesium oxide (MgO) on the assumption that magnesium is used as the additive element. As illustrated in FIG. 27A1 to FIG. 27A3, oxygen orientations in {110} of LCO and {110} of CoO and MgO are aligned with each other, and thus the crystal structures are topotaxy. A value six times the interplanar spacing of {1-11} that is a plane perpendicular to {110} of MgO is 1.461 nm, which is longer than 1.405 nm that is the interplanar spacing of LCO and shorter than 1.477 nm that is a value six times the interplanar spacing of {1-11} of CoO. It is thus considered that there are less lattice mismatch and a smaller distortion in the case where LCO and MgO are in contact with each other than in the case where LCO and CoO are in contact with each other.

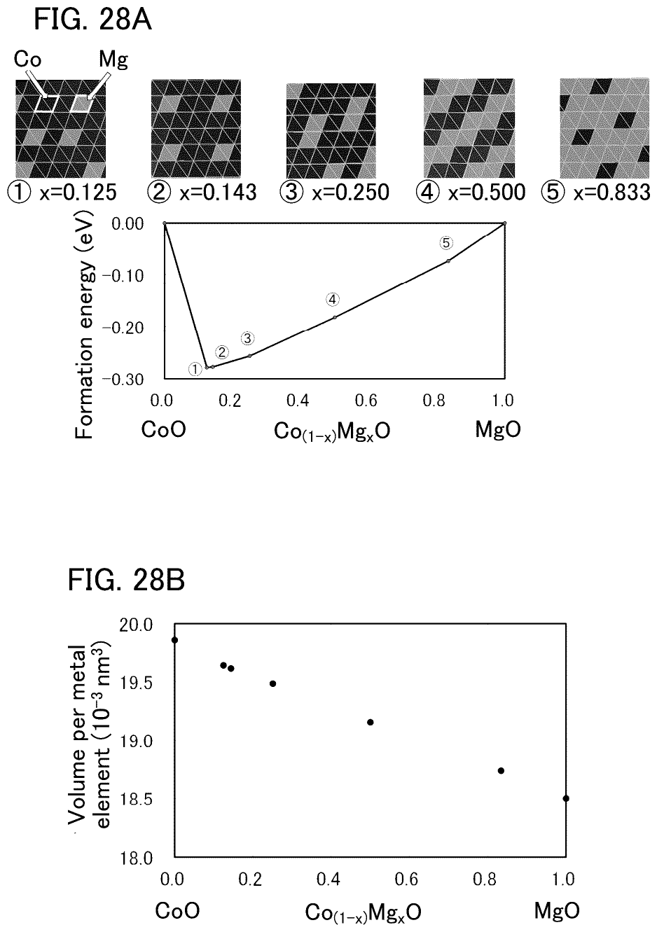

Next, to know whether CoO and MgO form a solid solution, formation energy of a solid solution Co₍₁₋ₓ₎MgₓO is analyzed using ATAT (Alloy Theoretic Automated Toolkit) software described in Non-Patent Document 5. The ATAT is software for efficiently proceeding with structure search using a combination of first-principles calculation and a cluster expansion method. As first-principles calculation software, VASP (Vienna Ab initio Simulation Package) is used, and conditions shown in Table 1 are used as calculation conditions. FIG. 28A shows the results of searching for the arrangement in Co₍₁₋ₓ₎MgₓO when x is 0.125, 0.143, 0.250, 0500, and 0.833. A gray parallelogram in FIG. 28A indicates an Mg—O octahedron (MgO₆) containing Mg in its center, and a black parallelogram indicates a Co—O octahedron (CoO₆) containing Co in its center.

TABLE 1

| Software | VASP | |
|---|---|---|
| Functional | GGA + U (DFT-D2) | |
| Pseudopotential | PAW | |
| Cut-off energy | 600 | |
| (ev) | | |
| U potential | Co | 4.91 |

| | |
|---|---|
| Calculation target | Optimizing lattice and atomic position |

As shown in FIG. 28A, the graph of formation energy of Co₍₁₋ₓ₎MgₓO has a convex downward, and the energy is more stable in a solid solution, which indicates that CoO and MgO can form a solid solution. It is also indicated that Co and Mg in a solid solution are distributed in a dispersed manner.

The Co₍₁₋ₓ₎MgₓO that is a solid solution has anisotropy in the interplanar spacing, and thus it is difficult to determine in which crystal orientation the Co₍₁₋ₓ₎MgₓO becomes topotaxy with LCO. Thus, FIG. 28B shows the results of calculating a tendency of change in interplanar spacing on the basis of a volume per metal atom (10⁻³ nm³) that is obtained by subtracting the number of metal atoms in the structure model from the volume of the structure model of each proportion. FIG. 28B indicates that, as Mg has a higher proportion in the solid solution, Co₍₁₋ₓ₎MgₓO tends to have a smaller volume and be closer to MgO. From the above, it is considered that the difference from the interplanar spacing of {001} of LCO becomes smaller in the plane where LCO and Co₍₁₋ₓ₎MgₓO are in contact with each other.

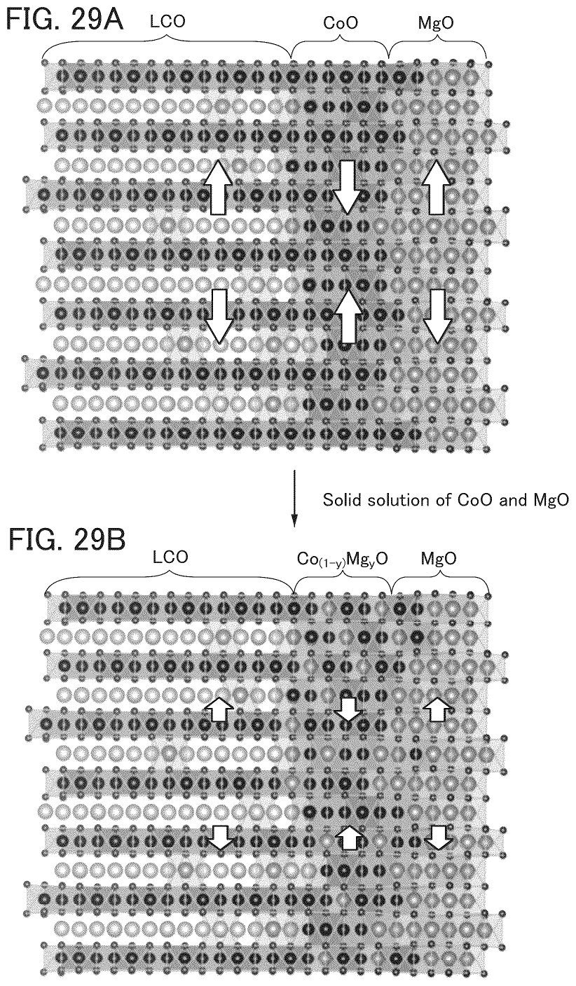

It is thus considered that CoO and MgO easily form a solid solution. When the formation of a solid solution by CoO and MgO proceeds by heating, as shown from FIG. 29A to FIG. 29B, the solid solution Co₍₁₋ₓ₎MgₓO can be formed in the surface portion 100a of the positive electrode active material 100A. The Co₍₁₋ₓ₎MgₓO has less lattice mismatch with LCO than with CoO. Thus, the surface portion 100a containing the Co₍₁₋ₓ₎MgₓO becomes topotaxy with respect to LCO of the inner portion 100b more easily. Furthermore, as indicated by the length of white arrows in FIG. 29A and FIG. 29B, the stress becomes small.

As described above, even in the case where cobalt oxide exists in the surface portion of lithium cobalt oxide, heating after addition of an additive element enables the surface portion 100a to be a solid solution of the cobalt oxide and an oxide containing the additive element. Thus, the surface portion 100a of the positive electrode active material 100A becomes topotaxy with respect to the inner portion 100b more easily. Accordingly, the positive electrode active material 100A where a pit is less likely to be formed can be obtained.

### <Crystal Structure>

<<x in LixCoO₂ being 1>>

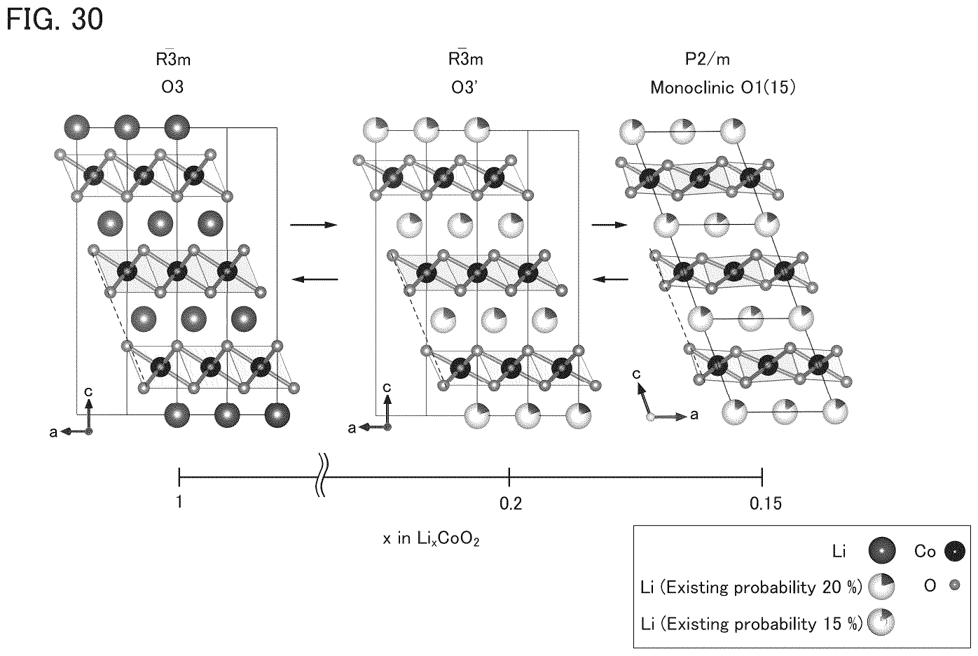

The positive electrode active material 100A of one embodiment of the present invention preferably has a layered rock-salt crystal structure belonging to the space group R-3m in a discharged state, i.e., a state where x in LixCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100A, have a layered rock-salt crystal structure. In FIG. 30, the layered rock-salt crystal structure is denoted by R-3m O3.

Meanwhile, the surface portion 100a of the positive electrode active material 100A of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100A by charging. Alternatively, the surface portion 100a preferably functions as a barrier film of the positive electrode active material 100A. Alternatively, the surface portion 100a, which is the outer portion of the positive electrode active material 100A, preferably reinforces the positive electrode active material 100A. Here, the term “reinforce” means inhibition of a change in the structures of the surface portion 100a and the inner portion 100b of the positive electrode active material 100A such as extraction of oxygen and/or inhibition of oxidative decomposition of an electrolyte on the surface of the positive electrode active material 100A.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100A of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and is a region that tends to have a lower lithium concentration than the inner portion 100b. Bonds between atoms are regarded as being partly cut on the surface of the positive electrode active material 100A contained in the surface portion 100a. Thus, the surface portion 100a is regarded as a region that tends to be unstable and tends to start deterioration of the crystal structure. Meanwhile, when the surface portion 100a can be made sufficiently stable, the layered structure, which is formed of octahedrons of the transition metal M and oxygen, of the inner portion 100b is less likely to be broken even with small x in LixCoO₂, e.g., with x of less than or equal to 0.24. Furthermore, a shift in layers, which are formed of octahedrons of the transition metal M and oxygen, of the inner portion 100b can be inhibited.

In order that the surface portion 100a can have a stable composition and a stable crystal structure, the surface portion 100a preferably contains the additive element A, further preferably contains a plurality of additive elements A. The surface portion 100a preferably has a higher concentration of one or more selected from the additive elements A than the inner portion 100b. The one or more selected from the additive elements A contained in the positive electrode active material 100A preferably have a concentration gradient. In addition, it is further preferable that the additive elements A in the positive electrode active material 100A be differently distributed. For example, it is further preferable that the additive elements A exhibit concentration peaks at different depths from a surface. The concentration peak here refers to the local maximum value of the concentration in the surface portion 100a or the concentration in 50 nm or less in depth from the surface.

For example, some of the additive elements A such as magnesium, fluorine, nickel, titanium, silicon, phosphorus, boron, and calcium preferably have a concentration gradient in which the concentration increases from the inner portion 100b toward the surface, as shown by hatching density in FIG. 2A. An element having such a concentration gradient is referred to as an additive element X.

Another additive element A such as aluminum or manganese preferably has a concentration gradient as shown in FIG. 2B by hatching density and exhibits a concentration peak in a deeper region than that in FIG. 2A. The concentration peak may be located in the surface portion 100a or located deeper than the surface portion 100a. For example, the peak is preferably located in a region of 5 nm to 30 nm inclusive in depth from the surface toward the inner portion. An element having such a concentration gradient is referred to as an additive element Y.

For example, magnesium, which is an example of the additive element X, is divalent, and a magnesium ion is more stable in lithium sites than in transition metal M sites in the layered rock-salt crystal structure and thus is likely to enter the lithium sites. An appropriate concentration of magnesium present in the lithium sites of the surface portion 100a can facilitate maintenance of the layered rock-salt crystal structure. This is probably because magnesium present in the lithium sites serves as a column supporting the CoO₂ layers. Moreover, the presence of magnesium can inhibit extraction of oxygen around magnesium in a state where x in LixCoO₂ is, for example, less than or equal to 0.24. The presence of magnesium is also expected to increase the density of the positive electrode active material 100A. In addition, a high magnesium concentration in the surface portion 100a is expected to increase the corrosion resistance to hydrofluoric acid generated by the decomposition of the electrolyte solution.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the transition metal M sites in addition to the lithium sites. Moreover, an undesired magnesium compound (e.g., an oxide or a fluoride) which is substituted for neither the lithium site nor the transition metal M site might segregate at the surface of the positive electrode active material or the like to serve as a resistance component of a secondary battery. As the magnesium concentration in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100A preferably contains an appropriate amount of magnesium. For example, the proportion of magnesium to the sum of the transition metal M (Mg/M) contained in the positive electrode active material 100A of one embodiment of the present invention is preferably higher than or equal to 0.25% and lower than or equal to 5%, further preferably higher than or equal to 0.5% and lower than or equal to 2%, still further preferably approximately 1%. The amount of magnesium contained in the entire positive electrode active material 100A here may be a value obtained by element analysis on the entire positive electrode active material 100A using GD-MS, ICP-MS, or the like, or may be a value based on the ratio of the raw materials mixed in the formation process of the positive electrode active material 100A, for example.

Nickel, which is an example of the additive element X, can be present in both the transition metal M sites and the lithium sites. Nickel is preferably present in the transition metal M sites because a lower oxidation-reduction potential can be obtained as compared with the case where only cobalt is present in the transition metal M sites, leading to an increase in discharge capacity.

In addition, when nickel is present in lithium sites, shift in the layered structure formed of octahedrons of the transition metal M and oxygen can be inhibited. Moreover, a change in volume in charging and discharging is inhibited. Furthermore, an elastic modulus becomes large, i.e., hardness increases. This is probably because nickel present in the lithium sites also serves as a column supporting the CoO₂ layers. Therefore, in particular, the crystal structure is expected to be more stable in a charged state at high temperatures, e.g., 45° C. or higher, which is preferable.

Meanwhile, excess nickel might increase the influence of distortion due to the Jahn-Teller effect. Meanwhile, excess nickel might adversely affect insertion and extraction of lithium.

Thus, the entire positive electrode active material 100A preferably contains an appropriate amount of nickel. For example, the number of nickel atoms contained in the positive electrode active material 100A is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the formation process of the positive electrode active material, for example.

Aluminum, which is one of additive elements Y, can exist in the transition metal M site in a layered rock-salt crystal structure. Since aluminum is a trivalent representative element and its valence does not change, lithium around aluminum is less likely to move even in charging and discharging. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a Co—O bond; thus, extraction of oxygen around aluminum can be inhibited. These effects improve thermal stability. Hence, a secondary battery containing aluminum as the additive element Y can have improved stability. Furthermore, the positive electrode active material 100A can have a crystal structure that is less likely to be broken by repeated charging and discharging.

Meanwhile, excess aluminum might adversely affect insertion and extraction of lithium.

Thus, the entire positive electrode active material 100A preferably contains an appropriate amount of aluminum. For example, the number of aluminum atoms contained in the entire positive electrode active material 100A is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The amount contained in the entire positive electrode active material 100A here may be a value obtained by element analysis on the entire positive electrode active material 100A using GD-MS, ICP-MS, or the like, or may be a value based on the ratio of the raw materials mixed in the formation process of the positive electrode active material 100A, for example.

When fluorine, which is an example of the additive element X, is substituted for part of oxygen in the surface portion 100a, the lithium extraction energy is lowered. This is because the change in the valence of cobalt ions associated with lithium extraction differs depending on the presence or absence of fluorine; for example, the change in the valence of cobalt ions is trivalent to tetravalent in the case of not containing fluorine and divalent to trivalent in the case of containing fluorine, and the oxidation-reduction potential of cobalt ions differs therebetween. It can thus be said that when fluorine is substituted for part of oxygen in the surface portion 100a of the positive electrode active material 100A, lithium ions near fluorine are likely to be extracted and inserted smoothly. Thus, a secondary battery including such a positive electrode active material 100A can have improved charge and discharge characteristics, improved current characteristics, or the like. When fluorine exists in the surface portion 100a, which includes a surface that is a portion in contact with the electrolyte solution, the corrosion resistance to hydrofluoric acid can be effectively increased. As will be described in detail in the following embodiment, a fluoride such as lithium fluoride that has a lower melting point than another additive element A source can serve as a fusing agent (also referred to as a flux) for lowering the melting point of another additive element source A.

An oxide of titanium, which is an example of the additive element X, is known to have superhydrophilicity. Accordingly, the positive electrode active material 100A that includes titanium oxide in the surface portion 100a presumably has good wettability with respect to a high-polarity solvent. In a secondary battery formed using the positive electrode active material 100A, the positive electrode active material 100A and a high-polarity electrolyte solution can have favorable contact at the interface therebetween, which may inhibit an internal resistance increase.

The surface portion 100a preferably contains phosphorus, which is one of the additive elements X, in which case a short circuit can be inhibited while a state with small x in LixCoO₂ is maintained in some cases. For example, a compound containing phosphorus and oxygen preferably exists in the surface portion 100a.

The positive electrode active material 100A preferably contains phosphorus, in which case the phosphorus reacts with hydrogen fluoride generated by the decomposition of the electrolyte, which can decrease the hydrogen fluoride concentration in the electrolyte.

In the case where the electrolyte contains LiPF₆, hydrogen fluoride might be generated by hydrolysis. In some cases, hydrogen fluoride might be generated by the reaction of polyvinylidene fluoride (PVDF) used as a component of the positive electrode and alkali. The decrease in hydrogen fluoride concentration in the electrolyte can inhibit corrosion of a current collector and/or separation of a coating film in some cases. Furthermore, a reduction in adhesion properties due to gelling and/or insolubilization of PVDF can be inhibited in some cases.

The positive electrode active material 100A preferably contains magnesium and phosphorus, in which case the stability in a state with small x in LixCoO₂ is extremely high. In the case where the positive electrode active material 100A contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100A by GC-MS, ICP-MS, or the like, or may be a value based on the ratio of the raw materials mixed in the formation process of the positive electrode active material 100A, for example.

In the case where the positive electrode active material 100A includes a crack, when an inner portion of the positive electrode active material with a crack as a surface, e.g., a filling portion, includes phosphorus, more specifically, a compound containing phosphorus and oxygen or the like, crack development is inhibited in some cases.

In the case where the surface portion 100a contains both magnesium and nickel, divalent magnesium might be able to be present more stably in the vicinity of divalent nickel. Thus, elution of magnesium can be inhibited even in LixCoO₂ with small x. This can contribute to stabilization of the surface portion 100a.

Additive elements A that are differently distributed, such as the additive element X and the additive element Y, are preferably contained at a time, in which case the crystal structure of a wider region can be stabilized. For example, the crystal structure of a wider region can be stabilized in the case where the positive electrode active material 100A contains all of magnesium and nickel, which are examples of the additive element X, and aluminum, which is an example of the additive element Y, than in the case where only one of the additive element X and the additive element Y is contained. In the case where the positive electrode active material 100A contains both the additive element X and the additive element Y as described above, the surface can be sufficiently stabilized by the additive element X such as magnesium and nickel; thus, the additive element Y such as aluminum is not necessary for the surface. On the contrary, aluminum is preferably widely distributed in a deep region, e.g., in a region that is 5 nm to 50 nm in depth from the surface, in which case the crystal structure in a wider region can be stabilized.

When a plurality of the additive elements A are contained as described above, the effects of the additive elements A contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of the additive element A and oxygen is not preferred because the surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, and also contain lithium in a discharged state to have the path through which lithium is inserted and extracted.

To ensure the sufficient path through which lithium is inserted and extracted, the concentration of cobalt is preferably higher than that of magnesium in the surface portion 100a.

For example, the ratio Mg/Co of the number of magnesium atoms Mg to the number of cobalt atoms Co is preferably greater than or equal to 0.62. The concentration of cobalt is preferably higher than that of nickel in the surface portion 100a. The concentration of cobalt is preferably higher than that of aluminum in the surface portion 100a. The concentration of cobalt is preferably higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably one sixth or less that of magnesium atoms.

It is preferable that some additive elements A, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of the transition metal M and oxygen can be inhibited in a manner similar to the above. Also in the case where both magnesium and nickel are contained, a synergistic effect of suppressing dissolution of magnesium can be expected since divalent magnesium can be present more stably in the vicinity of divalent nickel.

<<The State where x in LixCoO₂ is Small>>

The crystal structure in a state where x in LixCoO₂ is small of the positive electrode active material 100A of one embodiment of the present invention is different from that of a conventional positive electrode active material because the positive electrode active material 100A has the above-described distribution and/or crystal structure of the additive element A in a discharged state. Here, “x is small” means 0.1<x≤0.24.

A conventional positive electrode active material and the positive electrode active material 100A of one embodiment of the present invention are compared, and changes in the crystal structure due to a change of x in LixCoO₂ will be described with reference to FIG. 30 to FIG. 34.

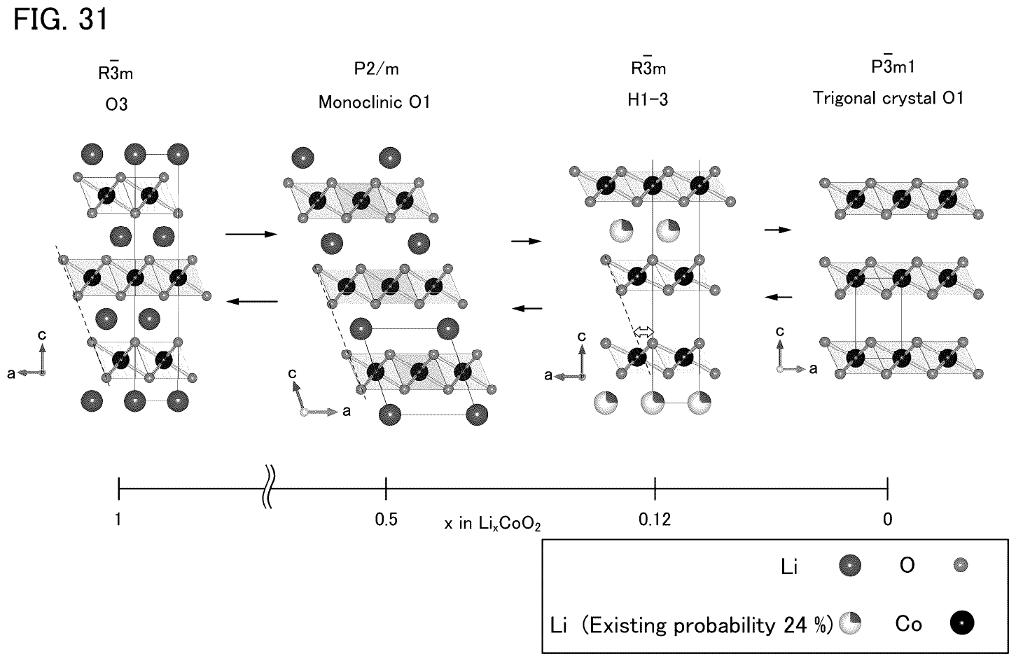

A change in the crystal structure of the conventional positive electrode active material is illustrated in FIG. 31. The conventional positive electrode active material illustrated in FIG. 31 is lithium cobalt oxide (LiCoO₂) not containing the additive element A in particular. A change in the crystal structure of lithium cobalt oxide not containing the additive element A in particular is described in Non-Patent Document 1 to Non-Patent Document 3 and the like.

In FIG. 31, the crystal structure of lithium cobalt oxide with x in LixCoO₂ of 1 is denoted by R-3m 03. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P₂/m. This structure includes one CoO₂ layer in a unit cell. Thus, this crystal structure is referred to as an O₁ type structure or a monoclinic O₁ type structure in some cases.

When x=0, the positive electrode active material has a trigonal crystal structure belonging to the space group P-3 m1, and one CoO₂ layer exists in a unit cell. Thus, this crystal structure is referred to as an O1 type structure or a trigonal O₁ type structure in some cases. Moreover, in some cases, this crystal structure is referred to as a hexagonal O₁ type structure when a trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O₁ type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. Moreover, the number of cobalt atoms per unit cell in the actual H1-3 type crystal structure is twice as large as that of cobalt atoms per unit cell in other structures. However, in this specification including FIG. 31, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charging that makes x in LixCoO₂ be 0.24 or less and discharging are repeated, the crystal structure of conventional lithium cobalt oxide repeatedly changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrow in FIG. 31, the CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

Meanwhile, in the positive electrode active material 100A of one embodiment of the present invention illustrated in FIG. 30, a change in the crystal structure between a discharged state with x in LixCoO₂ being 1 and a state with x being 0.24 or less is smaller than that in a conventional positive electrode active material. Specifically, a shift in the CoO₂ layers between the state with x being 1 and the state with x being 0.24 or less can be small. Furthermore, a change in the volume can be small in the case where the positive electrode active materials have the same number of cobalt atoms. Thus, the positive electrode active material 100A of one embodiment of the present invention can have a crystal structure that is difficult to break even when charging that makes x be 0.24 or less and discharging are repeated, and obtain excellent cycle performance. In addition, the positive electrode active material 100A of one embodiment of the present invention with x in LixCoO₂ being 0.24 or less can have a more stable crystal structure than a conventional positive electrode active material. Thus, the positive electrode active material 100A of one embodiment of the present invention with x in LixCoO₂ being kept at 0.24 or less inhibits a short circuit. This is preferable because the safety of the secondary battery is improved.

FIG. 30 shows crystal structures of the inner portion 100b of the positive electrode active material 100A in a state where x in LixCoO₂ is 1 and in a state where x in LixCoO₂ is approximately 0.2. The inner portion 100b, accounting for the majority of the volume of the positive electrode active material 100A, largely contributes to charging and discharging and is accordingly a portion where a shift in CoO₂ layers and a volume change matter most.

The positive electrode active material 100A with x being 1 has the R-3m O3 type crystal structure, which is the same as that of conventional lithium cobalt oxide.

However, the positive electrode active material 100A has a crystal structure different from the H1-3 type crystal structure in a state where x is 0.24 or less, e.g., approximately 0.2 or approximately 0.15, with which conventional lithium cobalt oxide has the H1-3 type crystal structure.

The positive electrode active material 100A of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 30, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤ x≤0.25. In the unit cell, the lattice constant of the a-axis is preferably 2.797≤ a≤2.837 (×10−1 nm), further preferably 2.807≤ a≤2.827 (×10-1 nm), typically a=2.817(×10-1 nm). The lattice constant of the c-axis is preferably 13.681≤ c≤13.881 (×10-1 nm), further preferably 13.751≤ c≤ 13.811, typically c=13.781 (×10-1 nm).

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 30, the CoO₂ layers hardly shift between the R-3m O3 type crystal structure in a discharged state and the O3′ type crystal structure.

The R-3m O3 type crystal structure in a discharged state and the O3′ type crystal structure which contain the same number of cobalt atoms have a difference in volume of 2.5% or less, specifically 2.2% or less, typically 1.8%.

As described above, in the positive electrode active material 100A of one embodiment of the present invention, a change in the crystal structure caused when x in LixCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material 100A is less likely to break even when charging that makes x be 0.24 or less and discharging are repeated. Therefore, a decrease in charge and discharge capacity of the positive electrode active material 100A in charge and discharge cycles is inhibited. Furthermore, the positive electrode active material 100A can stably use a larger amount of lithium than a conventional positive electrode active material and thus has high discharge capacity per weight and per volume. Thus, with the use of the positive electrode active material 100A, a secondary battery with high discharge capacity per weight and per volume can be fabricated.

Note that the positive electrode active material 100A is confirmed to have the O3′ type crystal structure in some cases when x in LixCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LixCoO₂ but also the number of charge and discharge cycles, a charge current and a discharge current, temperature, an electrolyte, and the like, so that the range of x is not limited to the above.

Hence, when x in LixCoO₂ in the positive electrode active material 100A is greater than 0.1 and less than or equal to 0.24, not all of the inner portion 100b of the positive electrode active material 100A has to have the O3′ type crystal structure. The positive electrode active material 100A may have another crystal structure or may be partly amorphous.

In order to make x in LixCoO₂ small, charging with a high charge voltage is necessary in general. Therefore, the state where x in LixCoO₂ is small can be rephrased as a state where charging with a high charge voltage has been performed. For example, when CC/CV charging is performed at 25° C. and 4.6 V or higher using the potential of a lithium metal as a reference, the H1-3 type crystal structure appears in a conventional positive electrode active material. Therefore, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 100A of one embodiment of the present invention is preferable because the crystal structure with the symmetry of R-3m O3 can be maintained even when charging with a high charge voltage of 4.6 V or higher is performed at 25° C., for example. Moreover, the positive electrode active material 100A of one embodiment of the present invention is preferable because the O3′ type crystal structure can be obtained when charging with a higher charge voltage, e.g., a voltage higher than or equal to 4.65 V and lower than or equal to 4.7 V is performed at 25° C.

In the positive electrode active material 100A, when the charge voltage is increased, the H1-3 type crystal is eventually observed in some cases. As described above, the crystal structure is influenced by the number of charge and discharge cycles, a charge current and a discharge current, an electrolyte, and the like, so that the positive electrode active material 100A of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Therefore, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ in FIG. 30, one embodiment of the present invention is not limited thereto. Lithium may exist unevenly in only some of the lithium sites; for example, lithium may symmetrically exist as in the monoclinic O1 (Li_{0.5}CoO₂) shown in FIG. 31. Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ crystal structure in general.

The concentration gradient of the additive element A is preferably similar in a plurality of portions of the surface portion 100a of the positive electrode active material 100A. In other words, it is preferable that the reinforcement derived from the additive element A uniformly occurs in the surface portion 100a. When the surface portion 100a partly has reinforcement, stress might be concentrated on parts that do not have reinforcement. The concentration of stress on part of the positive electrode active material 100A might cause defects such as cracks from that part, leading to breakage of the positive electrode active material and a decrease in discharge capacity.

Note that the additive elements A do not necessarily have similar concentration gradients throughout the surface portion 100a of the positive electrode active material 100A. For example, FIG. 2C illustrates an example of distribution of the additive element X in the portion near the line C-D in FIG. 1B and FIG. 2D illustrates an example of distribution of the additive element Y in the portion near the line C-D.

Here, the surface near the line C-D is parallel to the arrangement of cations. The distribution of the additive elements A in the surface parallel to the arrangement of cations may be different from that in other surfaces. For example, in the surface parallel to arrangement of cations and the surface portion 100a thereof, concentration peak distribution of one or more selected from the additive element X and the additive element Y may be limited to a portion at a shallower depth from the surface than a surface having other orientations. Alternatively, the surface parallel to the arrangement of cations and the surface portion 100a thereof may have a lower concentration of one or more selected from the additive element X and the additive element Y than a surface having other orientations. Further alternatively, in the surface parallel to the arrangement of cations and the surface portion 100a thereof, the concentration of one or more selected from the additive element X and the additive element Y may be lower than or equal to the lower detection limit.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

Since a CoO₂ layer is relatively stable, a plane where the CoO₂ layer exists in a surface is relatively stable. A main diffusion path of lithium ions in charging and discharging is not exposed at this plane.

Meanwhile, a diffusion path of lithium ions is exposed at a plane not parallel to the arrangement of cations, i.e., a plane not parallel to the CoO₂ layer. Thus, the surface not parallel to the arrangement of cations and the surface portion 100a thereof easily lose stability because they are regions where extraction of lithium ions starts as well as important regions for maintaining a diffusion path of lithium ions. It is thus extremely important to reinforce the surface not parallel to the arrangement of cations and the surface portion 100a thereof so that the crystal structure of the whole positive electrode active material 100A is maintained.

Thus, in the positive electrode active material 100A of another embodiment of the present invention, it is important that the additive elements A are not distributed only in the outermost layer in the plane not parallel to the arrangement of cations and the surface portion 100a thereof, but exist within a preferred depth, as illustrated in FIG. 2A and FIG. 2B. By contrast, at the plane parallel to the arrangement of cations and the surface portion 100a thereof, the concentration of the additive element A may be low as described above or the additive element A may be absent.

In the fabrication method to be described in the following embodiment, in which high-purity LiCoO₂ is fabricated, the additive element A is mixed afterwards, and heating is performed, the additive element A spreads mainly through the diffusion path of lithium ions. Thus, the additive elements A are easily distributed within a preferred range in the surface not parallel to the arrangement of cations and the surface portion 100a thereof.

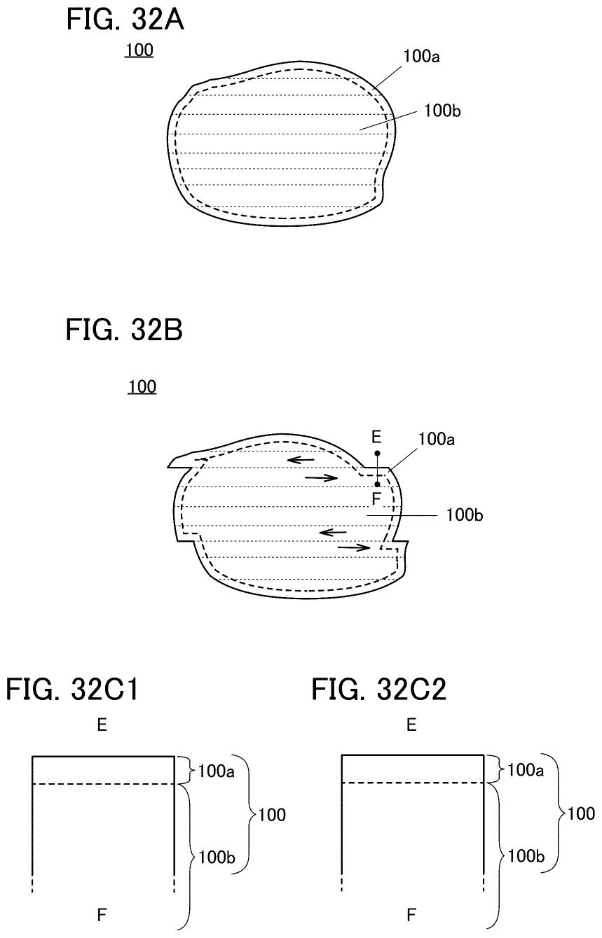

The positive electrode active material 100A preferably has a smooth surface with little unevenness; however, it is not necessary that the entire positive electrode active material 100A be in such a state. In a composite oxide with a layered rock-salt crystal structure belonging to R-3m, slipping easily occurs at a plane parallel to arrangement of cations, e.g., a plane where lithium atoms are arranged. For example, when there is a plane where lithium ions are arranged as illustrated in FIG. 32A, after a step such as pressing, slipping occurs parallel to the plane where lithium ions are arranged, as denoted by arrows in FIG. 32B, resulting in deformation in some cases.

In this case, at a surface newly formed as a result of slipping and the surface portion 100a thereof, the additive element A is not present or present at a concentration lower than or equal to the lower detection limit in some cases. The line E-F in FIG. 32B denotes examples of the surface newly formed as a result of slipping and the surface portion 100a thereof. FIG. 32C1 and FIG. 32C2 show enlarged views of the vicinity of the line E-F. In FIG. 32C1 and FIG. 32C2, unlike in FIG. 2A to FIG. 2D, there exists neither distribution of the additive element X nor that of the additive element Y.

However, since slipping easily occurs parallel to the arrangement of cations, the newly formed surface and the surface portion 100a thereof easily become parallel to a diffusion path of lithium. Since a diffusion path of lithium ions is not exposed and the newly formed surface is relatively stable in this case, substantially no problem is caused even when the additive element A is not present or present at a concentration lower than or equal to the lower detection limit.

Note that as described above, in a composite oxide having a composition of LiCoO₂ and a layered rock-salt crystal structure belonging to R-3m, cobalt and lithium are arranged parallel to the (001) plane. In a HAADF-STEM image, the luminance of cobalt, which has the largest atom number in LiCoO₂, is the highest. Thus, in a HAADF-STEM image, arrangement of atoms with a high luminance may be regarded as arrangement of cobtalt. Repetition of such arrangement with a high luminance can be rephrased as crystal fringes or lattice fringes.

### <<Crystal Grain Boundary>>

It is further preferable that the additive element A contained in the positive electrode active material 100A of one embodiment of the present invention be distributed as described above and unevenly distributed at least partly at the crystal grain boundary and the vicinity thereof.

Note that in this specification and the like, uneven distribution means that the concentration of an element in a certain region differs from those in other regions. Uneven distribution may be rephrased as segregation, precipitation, unevenness, deviation, or a mixture of a high-concentration portion and a low-concentration portion.

For example, the magnesium concentration in the crystal grain boundary and its vicinity of the positive electrode active material 100A is preferably higher than that in the other regions in the inner portion 100b. In addition, the fluorine concentration at the crystal grain boundary and the vicinity thereof is preferably higher than that in the other regions in the inner portion 100b. In addition, the nickel concentration at the crystal grain boundary and the vicinity thereof is preferably higher than that in the other regions in the inner portion 100b. In addition, the aluminum concentration at the crystal grain boundary and the vicinity thereof is preferably higher than that in the other regions in the inner portion 100b.

The crystal grain boundary is a type of plane defect. Thus, the crystal grain boundary tends to be unstable and the crystal structure easily starts to change like the surface of the particle. Therefore, the higher the concentration of the additive element A in the crystal grain boundary and its vicinity is, the more effectively the change in the crystal structure can be inhibited.

When the magnesium concentration and the fluorine concentration are high at the crystal grain boundary and the vicinity thereof, the magnesium concentration and the fluorine concentration in the vicinity of a surface generated by a crack are also high even when the crack is generated along the crystal grain boundary of the positive electrode active material 100A of one embodiment of the present invention. Thus, the positive electrode active material including a crack can also have an increased corrosion resistance to hydrofluoric acid.

### <Particle Diameter>

Too large a particle diameter of the positive electrode active material 100A of one embodiment of the present invention causes problems such as difficulty in lithium diffusion and too much surface roughness of an active material layer in coating to a current collector. By contrast, too small a particle diameter causes problems such as difficulty in loading of the active material layer in coating to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to 40 μm.

### <Analysis Method>

Whether or not a given positive electrode active material is the positive electrode active material 100A of one embodiment of the present invention, which has the O3′ type crystal structure when x in LixCoO₂ is small, can be judged by analyzing a positive electrode including the positive electrode active material with small x in LixCoO₂ by XRD, electron diffraction, neutron diffraction, electron spin resonance (ESR), nuclear magnetic resonance (NMR), or the like.

XRD is particularly preferable because the symmetry of the transition metal M such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example. A diffraction peak reflecting the crystal structure of the inner portion 100b of the positive electrode active material 100A, which accounts for the majority of the volume of the positive electrode active material 100A, is obtained through XRD, in particular, powder XRD.

As described above, the positive electrode active material 100A of one embodiment of the present invention has a feature of a small change in the crystal structure between when x in LixCoO₂ is 1 and when x is less than or equal to 0.24. A material where 50% or more of the crystal structure largely changes in high-voltage charging is not preferable because the material cannot withstand high-voltage charging and discharging.

It should be noted that the O3′ type crystal structure is not obtained in some cases only by addition of the additive element A. For example, when x in LixCoO₂ is less than or equal to 0.24, lithium cobalt oxide containing magnesium and fluorine or lithium cobalt oxide containing magnesium and aluminum has the O3′ type crystal structure at 60% or more in some cases, and has the H1-3 type crystal structure at 50% or more in other cases, depending on the concentration and distribution of the additive element A.

In addition, in the case where x is too small, e.g., 0.1 or less, or under the condition where charge voltage is higher than 4.9 V, the positive electrode active material 100A of one embodiment of the present invention sometimes has the H1-3 type crystal structure or the trigonal O₁ type crystal structure. Thus, determining whether or not a positive electrode active material is the positive electrode active material 100A of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the additive element A contained in a given positive electrode active material is in the above-described state can be judged by, for example, analysis using XPS, energy dispersive X-ray spectroscopy (EDX), EPMA (electron probe microanalysis), or the like.

The crystal structure of the surface portion 100a, the crystal grain boundary, or the like can be analyzed by electron diffraction of a cross section of the positive electrode active material 100A, for example.

### <<Charging Method>>

Whether or not a certain composite oxide is the positive electrode active material 100A of one embodiment of the present invention can be determined by high-voltage charging. For example, the high-voltage charging is performed on a coin cell (CR2032 type with a diameter of 20 mm and a height of 3.2 mm) formed using the composite oxide for a positive electrode and a lithium counter electrode for a negative electrode.

More specifically, a positive electrode can be formed by application of slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC: DEC=3:7 (volume ratio) and vinylene carbonate (VC) at 2 wt % are mixed can be used.

As the separator, a 25-μm-thick polypropylene porous film can be used.

Stainless steel (SUS) can be used for a positive electrode can and a negative electrode can.

Constant current charging at a current value of 10 mA/g is performed on the coin cell fabricated with the above conditions to a freely selected voltage (e.g., 4.5 V, 4.55 V, 4.6 V, 4.65 V, 4.7 V, 4.75 V, or 4.8 V). To observe a phase change of the positive electrode active material, charging with such a small current value is desirably performed. The temperature is set to 25° C. or 45° C. After the charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode active material enclosed in an airtight container with an argon atmosphere. After charging is completed, the positive electrode is preferably taken out immediately and subjected to the analysis. Specifically, the positive electrode is subjected to the analysis preferably within an hour, further preferably within 30 minutes after the completion of charging.

In the case where the crystal structure in a charged state after charging and discharging are performed multiple times is analyzed, the conditions of the charging and discharging performed multiple times may be different from the above-described charge conditions. For example, the charging can be performed in the following manner: constant current charging is performed at a current value of 100 mA/g to a freely selected voltage (e.g., 4.6 V, 4.65 V, 4.7 V, 4.75 V, or 4.8 V) and then, constant voltage charging is performed until the current value becomes 10 mA/g. As the discharging, constant current discharging can be performed at 100 mA/g to 2.5 V.

Also in the case where the crystal structure in a discharged state after the charging and discharging are performed multiple times is analyzed, constant current discharging can be performed at a current value of 100 mA/g to 2.5 V, for example.

### <<XRD>>

The apparatus and conditions for the XRD measurement are not particularly limited. The measurement can be performed with the apparatus and conditions as described below, for example.
XRD apparatus: D8 ADVANCE produced by Bruker AXS
X-ray source: CuKα₁ radiation
Output: 40 KV, 40 mA
Slit width: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

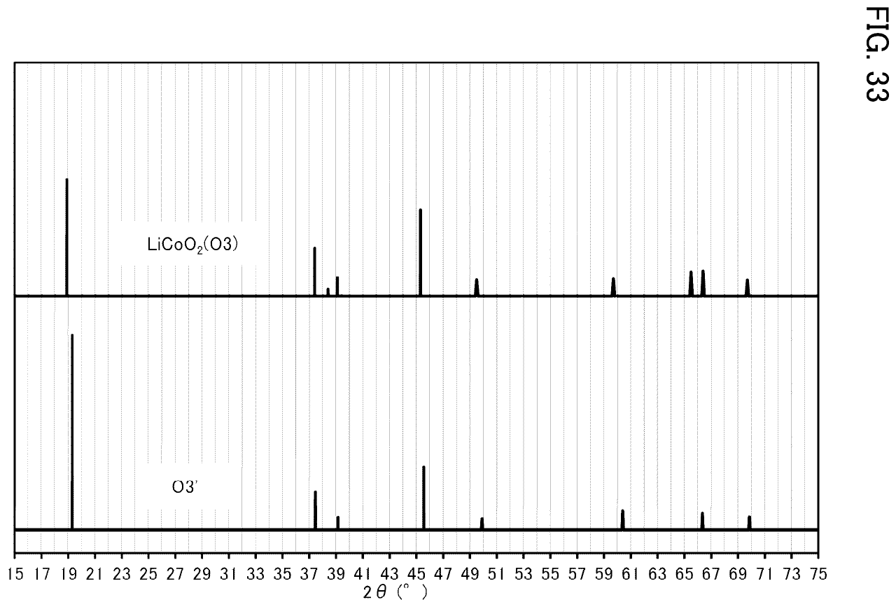

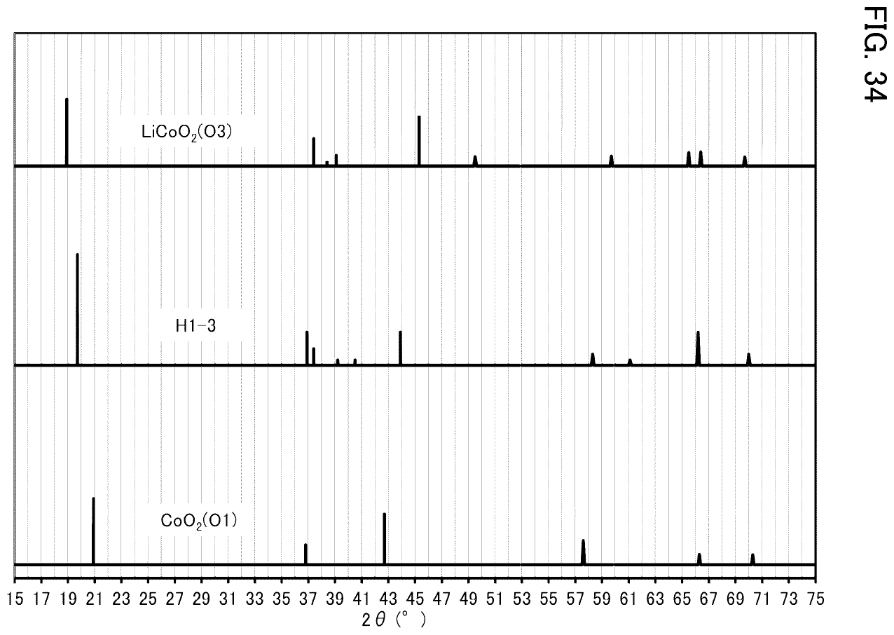

FIG. 33 and FIG. 34 show ideal powder XRD patterns with CuKα₁ radiation that are calculated from models of the O3′ type crystal structure and the H1-3 type crystal structure. For comparison, ideal XRD patterns calculated from the crystal structure of LiCoO₂O₃ with x in LixCoO₂ of 1, the crystal structure of the H1-3 type, and the crystal structure of the trigonal O1 with x of 0 are also shown in FIG. 34. Note that the patterns of LiCoO₂ (O3) and CoO₂ (O1) are made from crystal structure data obtained from the ICSD (Inorganic Crystal Structure Database) (see Non-Patent Document 4) with Reflex Powder Diffraction, which is a module of Materials Studio (BIOVIA). The range of 20 is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The O3′ type crystal structure is estimated from the XRD pattern of the positive electrode active material of one embodiment of the present invention, the crystal structure is fitted with TOPAS Ver. 3 (crystal structure analysis software produced by Bruker Corporation), and the XRD pattern of the O3′ type crystal structure is made in a manner similar to that for other structures.

As shown in FIG. 33, the O3′ type crystal structure exhibits diffraction peaks at 2θ of 19.25±0.12° (greater than or equal to 19.13° and less than 19.37°) and 2θ of 45.47±0.10° (greater than or equal to 45.37° and less than 45.57°).

However, as shown in FIG. 34, the H1-3 type crystal structure and the trigonal O1 do not exhibit peaks at these positions. Thus, the peaks at 2θ of 19.25±0.12° (greater than or equal to 19.13° and less than 19.37°) and 2θ of 45.47±0.10° (greater than or equal to 45.37° and less than 45.57°) exhibited in a state where x in LixCoO₂ is small can be the features of the positive electrode active material 100A of one embodiment of the present invention.

It can be said that the positions of the XRD diffraction peaks exhibited by the crystal structure with x being 1 and the crystal structure with x being 0.24 or less are close to each other. More specifically, it can be said that a difference in 2θ between the main diffraction peak exhibited by the crystal structure with x being 1 and the main diffraction peak exhibited by the crystal structure with x being 0.24 or less, which are exhibited at 2θ of greater than or equal to 42° and less than or equal to 46°, is 0.7° or less, preferably 0.5° or less.

Although the positive electrode active material 100A of one embodiment of the present invention has the O3′ type crystal structure when x in LixCoO₂ is small, not all the positive electrode active material 100A necessarily have the O3′ type crystal structure. Some of the particles may have another crystal structure or be amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50%, preferably greater than or equal to 60%, further preferably greater than or equal to 66% can have sufficiently good cycle performance.

Furthermore, even after 100 or more cycles of charging and discharging after the measurement starts, the O3′ type crystal structure preferably accounts for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions and/or the 2θ value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity contributes to stability of the crystal structure after sufficient charging.

The crystallite size of the O3′ type crystal structure included in the positive electrode active material 100A does not decrease to less than approximately one-twentieth that of LiCoO₂ (O3) in a discharged state. Thus, a clear peak of the O3′ type crystal structure can be observed when x in LixCoO₂ is small, even under the same XRD measurement conditions as those of a positive electrode before the charging and discharging. In contrast, conventional LiCoO₂ has a small crystallite size and a broad and small peak even when it can have a structure part of which is similar to the O3′ type crystal structure. The crystallite size can be calculated from the half width of the XRD peak.

### <<XPS>>

In an inorganic oxide, a region that is approximately 2 nm to 8 nm (typically, less than or equal to 5 nm) in depth from a surface can be analyzed by X-ray photoelectron spectroscopy (XPS) using monochromated aluminum Kα radiation as an X-ray source; thus, the concentrations of elements in approximately half the depth of the surface portion 100a can be quantitatively analyzed.

The bonding states of the elements can be analyzed by narrow scanning.
Note that in many cases, the quantitative accuracy of XPS is approximately ±1 atomic %, and the lower detection limit is approximately 1 atomic % but depends on the element.

In the positive electrode active material 100A of one embodiment of the present invention, the concentration of one or more selected from the additive elements A is preferably higher in the surface portion 100a than in the inner portion 100b. This means that the concentration of one or more selected from the additive elements A in the surface portion 100a is preferably higher than the average concentration of the selected element(s) in the entire the positive electrode active material 100A. For this reason, for example, it is preferable that the concentration of one or more additive elements A selected from the surface portion 100a, which is measured by XPS or the like, be higher than the average concentration of the additive element(s) A in the entire the positive electrode active material 100A, which is measured by ICP-MS, GD-MS, or the like. For example, the concentration of magnesium of at least part of the surface portion 100a, which is measured by XPS or the like, is preferably higher than the average concentration of magnesium of the entire positive electrode active material 100A. The concentration of nickel of at least part of the surface portion 100a is preferably higher than the average concentration of nickel of the entire the positive electrode active material 100A. The concentration of aluminum of at least part of the surface portion 100a is preferably higher than the average concentration of aluminum of the entire the positive electrode active material 100A. The concentration of fluorine of at least part of the surface portion 100a is preferably higher than the average concentration of fluorine of the entire the positive electrode active material 100A.

Note that the surface and the surface portion 100a of the positive electrode active material 100A of one embodiment of the present invention do not contain carbonate, a hydroxy group, or the like which is chemically adsorbed after formation of the positive electrode active material 100A. Furthermore, an electrolyte solution, a binder, a conductive material, and a compound originating from any of these that are attached to the surface of the positive electrode active material 100A are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element A is not easily dissolved even in that case; thus, the atomic ratio of the additive element A is not affected.

The concentration of the additive element A may be compared using the ratio of the additive element A to cobalt. The use of the ratio of the additive element A to cobalt enables comparison while reducing the influence of a carbonate or the like which is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, in the surface portion 100a of the positive electrode active material 100A, the concentrations of lithium and cobalt are preferably higher than that of the additive elements A so that sufficient paths through lithium is inserted and extracted are ensured. It can be said that the concentrations of lithium and cobalt in the surface portion 100a are preferably higher than the concentration of one or more additive elements A selected from the additive elements A contained in the surface portion 100a, which is measured by XPS or the like. For example, the concentration cobalt in at least part of the surface portion 100a is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than that of aluminum. Similarly, the concentration of lithium is preferably higher than the concentration of aluminum. The concentration of cobalt is preferably higher than that of fluorine. Similarly, the concentration of lithium s preferably higher that of fluorine.

It is further preferable that the additive element Y such as aluminum be widely distributed in a region that is 5 nm to 50 nm in depth from the surface, for example. Therefore, the additive element Y such as aluminum is detected by analysis on the entire the positive electrode active material 100A by ICP-MS, GD-MS, or the like, but the concentration of the additive element Y such as aluminum is preferably lower than or equal to the lower detection limit in XPS or the like.

When XPS analysis is performed on the positive electrode active material 100A of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms.

In the XPS analysis, monochromatic aluminum Kα radiation can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μm ϕ
Detection depth: approximately 4 to 5 nm (extraction angle 45°)
Measurement spectrum: wide scanning, narrow scanning of each detected element

In addition, when the positive electrode active material 100A of one embodiment of the present invention is analyzed by XPS, a peak indicating the bonding energy of fluorine with another element is preferably at greater than or equal to 682 eV and less than 685 eV, further preferably at approximately 684.3 eV. The above value is different from 685 eV, which is the bonding energy of lithium fluoride, and 686 eV, which is the bonding energy of magnesium fluoride. That is, in the case where the positive electrode active material 100A of one embodiment of the present invention contains fluorine, the fluorine is preferably in the bonding state other than lithium fluoride and magnesium fluoride.

Furthermore, when the positive electrode active material 100A of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to a value of the bonding energy of magnesium oxide. That is, in the case where the positive electrode active material 100A of one embodiment of the present invention contains magnesium, the magnesium is preferably in the bonding state other than magnesium fluoride.

### <<EDX>>

The one or more selected from the additive elements A contained in the positive electrode active material 100A preferably have a concentration gradient. It is further preferable that the additive elements A in the positive electrode active material 100A exhibit concentration peaks at different depths from a surface. The concentration gradient of the additive element A can be evaluated by exposing a cross section of the positive electrode active material 100A using FIB (Focused Ion Beam) or the like and analyzing the cross section using energy dispersive X-ray Spectrocropy (EDX), EPMA (electron probe microanalysis), or the like.

In the EDX measurement, to measure a region while scanning is performed and evaluate the region two-dimensionally is referred to as EDX area analysis. The measurement by line scan, which is performed to evaluate the atomic concentration distribution in a positive electrode active material, is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element A in the surface portion 100a, the inner portion 100b, the vicinity of a crystal grain boundary, and the like of the positive electrode active material 100A can be semi-quantitatively analyzed. By EDX line analysis, the concentration distribution and the highest concentration of the additive element A can be analyzed. An analysis method using a thinned sample, such as STEM-EDX, is preferred because the method makes it possible to analyze the concentration distribution in the depth direction from the surface toward the center in a specific region of a positive electrode active material regardless of the distribution in the front-back direction.

EDX area analysis or EDX point analysis of the positive electrode active material 100A of one embodiment of the present invention preferably reveals that the concentration of each additive element A, in particular, the additive element X in the surface portion 100a is higher than that in the inner portion 100b.

For example, EDX area analysis or EDX point analysis of the positive electrode active material 100A containing magnesium as the additive element A preferably reveals that the magnesium concentration in the surface portion 100a is higher than that in the inner portion 100b. Thus, in the EDX line analysis, a peak of the magnesium concentration in the surface portion 100a preferably appears in a region from the surface of the positive electrode active material 100A to a depth of 3 nm, further preferably to a depth of 1 nm, still further preferably to a depth of 0.5 nm toward the center. In addition, the magnesium concentration preferably attenuates, at a depth of 1 nm from the peak position, to less than or equal to 60% of the peak concentration. In addition, the magnesium concentration preferably attenuates, at a depth of 2 nm from the peak position, to less than or equal to 30% of the peak concentration.

When the positive electrode active material 100A contains magnesium and fluorine as the additive elements X, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

Thus, in the EDX line analysis, a peak of the fluorine concentration in the surface portion 100a preferably appears in a region from the surface of the positive electrode active material 100A to a depth of 3 nm, further preferably to a depth of 1 nm, still further preferably to a depth of 0.5 nm toward the center. It is further preferable that a peak of the fluorine concentration be exhibited slightly closer to the surface than a peak of the magnesium concentration is, which increases resistance to hydrofluoric acid. For example, it is preferable that a peak of the fluorine concentration be exhibited slightly closer to the surface than a peak of the magnesium concentration is by 0.5 nm or more, further preferably 1.5 nm or more.

In the positive electrode active material 100A containing nickel as the additive element X, a peak of the nickel concentration in the surface portion 100a preferably appears in a region from the surface of the positive electrode active material 100A to a depth of 3 nm, further preferably to a depth of 1 nm, still further preferably to a depth of 0.5 nm toward the center. When the positive electrode active material 100A contains magnesium and nickel, the distribution of nickel preferably overlaps with the distribution of magnesium. For example, a difference in the depth direction between a peak of the magnesium concentration and a peak of the magnesium concentration is preferably within 10 nm, further preferably within 3 nm, still further preferably within 1 nm.

In the case where the positive electrode active material 100A contains aluminum as the additive element Y, the peak of the magnesium concentration, the nickel concentration, or the fluorine concentration is preferably closer to the surface than the peak of the aluminum concentration in the surface portion 100a in the EDX line analysis. For example, the peak of the aluminum concentration preferably appears in a region from the surface of the positive electrode active material 100A to a depth of greater than or equal to 0.5 nm and less than or equal to 50 nm, further preferably to a depth of greater than or equal to 5 nm and less than or equal to 50 nm toward the center.

EDX line, area, or point analysis of the positive electrode active material 100A preferably reveals that the atomic ratio of magnesium to cobalt (Mg/Co) at a peak of the magnesium concentration is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the aluminum concentration is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the nickel concentration is preferably greater than or equal to 0 and less than or equal to 0.2, further preferably greater than or equal to 0.01 and less than or equal to 0.1. The atomic ratio of fluorine F to cobalt Co (F/Co) at a peak of the fluorine concentration is preferably greater than or equal to 0 and less than or equal to 1.6, further preferably greater than or equal to 0.1 and less than or equal to 1.4.

According to results of the EDX line analysis, where a surface of the positive electrode active material 100A is can be estimated in the following manner, for example. A point where the detected amount of an element which uniformly exists in the inner portion 100b of the positive electrode active material 100A, e.g., oxygen or cobalt, is ½ of the detected amount thereof in the inner portion 100b is assumed to be the surface.

Since the positive electrode active material 100A is a composite oxide, the detected amount of oxygen can be used to estimate where the surface is. Specifically, an average value Oₐᵥₑ of the oxygen concentration in a region of the inner portion 100b where the detected amount of oxygen is stable is calculated first. At this time, in the case where oxygen O_{background} which is probably led from chemical adsorption or the background is detected in a region that is obviously outside the surface, O_{background} can be subtracted from the measurement value to obtain the average value Oₐᵥₑ of the oxygen concentration. The measurement point where the measurement value which is closest to ½ of the average value Oₐᵥₑ, i.e., ½Oₐᵥₑ, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is less likely to be affected by chemical adsorption and is thus suitable for estimating where the surface is.

When the line analysis or the area analysis is performed on the positive electrode active material 100A, the atomic ratio of the additive element A to cobalt Co (A/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the linear analysis or area planar analysis is performed on the positive electrode active material 100A containing magnesium as the additive element X, the atomic ratio of magnesium to cobalt (Mg/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.02 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

### <<EPMA>>

Quantitative analysis of elements can be conducted also by electron probe microanalysis (EPMA). In area analysis, distribution of each element can be analyzed.

EPMA area analysis of a cross section of the positive electrode active material 100A of one embodiment of the present invention preferably reveals that one or more selected from the additive elements A have a concentration gradient, as in the EDX analysis results. For example, it is further preferable that the additive elements A exhibit concentration peaks at different depths from a surface. The preferred ranges of the concentration peaks of the additive elements A are the same as those in the case of EDX.

Note that In EPMA, a region from a surface to a depth of approximately 1 μm is analyzed. Thus, the quantitative value of each element is sometimes different from measurement results obtained by other analysis methods. For example, when area analysis is performed by EPMA on the positive electrode active material 100A, the concentrations of the additive elements A present in the surface portion 100a might be lower than the results obtained in XPS.

<<Charge Curve and dQ/dV Vs V Curve>>

The positive electrode active material 100A of one embodiment of the present invention sometimes shows a characteristic voltage change along with charging. A voltage change can be read from a dQ/dV vs V curve, which can be obtained by differentiating capacitance (Q) in a charge curve with voltage (V) (dQ/dV). There should be an unbalanced phase change and a significant change in the crystal structure between before and after a peak in the dQ/dV vs V curve. Note that in this specification and the like, an unbalanced phase change refers to a phenomenon that causes a nonlinear change in physical quantity.

The positive electrode active material 100A of one embodiment of the present invention sometimes shows a broad peak at around 4.55 V in a dQ/dV vs V curve. The peak at around 4.55 V reflects a change in voltage at the time of the phase change from the O3 type structure to the O3′ type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dV vs V curve of a charge curve is a first peak, the first peak preferably has a full width at half maximum of greater than or equal to 0.10 V to be sufficiently broad.

The charging at the time of obtaining a dQ/dV vs V curve can be, for example, constant current charging to 4.9 V at 10 mA/g. In obtaining a dQ/dV value of the initial charging, the above charging is preferably started after discharging to 2.5 V at 100 mA/g before measurement.

Data acquisition at the time of charging can be performed in the following manner, for example: a voltage and a current are acquired at intervals of 1 second or at every 1-mV voltage change. The value obtained by adding the current value and time is charge capacity.

The difference between the n-th data and the n+1-th data of the above charge capacity is the n-th value of a capacity change dQ. Similarly, the difference between the n-th data and the n+1-th data of the above voltage is the n-th value of a voltage change dV.

Note that minute noise has considerable influence when the above data is used; thus, the dQ/dV value may be calculated from the moving average for a certain number of class intervals of the differences in the voltage and the moving average for a certain number of class intervals of the differences in the charge capacity. The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value of the n-th to n+500-th class intervals can be used for the voltage on the horizontal axis of a dQ/dV vs V graph. In the case where the above-described moving average value of the n-th to n+500-th class intervals is used, the 501^{st} data from the last to the last data are largely influenced by noise and thus are not preferably used for the dQ/dV vs V graph.

In the case where a dQ/dV vs V curve after charging and discharging are performed multiple times is analyzed, the conditions of the charging and discharging performed multiple times may be different from the above-described charge conditions. For example, the charging can be performed in the following manner: constant current charging is performed at 100 mA/g to a freely selected voltage (e.g., 4.6 V, 4.65 V, 4.7 V, 4.75 V, or 4.8 V) and then, constant voltage charging is performed until the current value becomes 10 mA/g. As the discharging, constant current discharging can be performed at 100 mA/g to 2.5 V.

Note that the O3 type structure at the time of the phase change to the O3′ type structure at around 4.55 V has x in LixCoO₂ of approximately 0.3. This O3 type structure has the same symmetry as the O3 type structure with x of 1 illustrated in FIG. 31, but is slightly different in the distance between the CoO₂ layers. In this specification and the like, when O3 type structures with different x are distinguished from each other, the O3 type structure with x of 1 is referred to as O3 (20=18.85°) and the O3 type structure with x of approximately 0.3 is referred to as O3 (20=18.57°). This is because the position of the peak appearing at 2θ of approximately 19° in XRD measurement corresponds to the distance between the CoO₂ layers.

<<Discharge Curve and dQ/dV Vs V Curve>>

Moreover, when the positive electrode active material 100A of one embodiment of the present invention is discharged at a low current of, for example, 40 mA/g or lower after high-voltage charging, a characteristic change in voltage appears just before the end of discharging, in some cases. This change can be clearly observed by the fact that at least one peak appears within the range to 3.5 V at a voltage lower than that of a peak which appears around 3.9 V in dQ/dV vs V calculated from a discharge curve.

### <<ESR>>

The positive electrode active material 100A of one embodiment of the present invention preferably contains cobalt, and nickel and magnesium as the additive elements A. It is preferable that Ni³⁺ be substituted for part of Co³⁺ and Mg²⁺ be substituted for part of Li⁺ accordingly. Accompanying the substitution of Mg²⁺ for Lit, the Ni³⁺ might be reduced to be Ni²⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of 100A of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material 100A is preferably greater than or equal to 2.0×10¹⁷ spins/g and less than or equal to 1.0×10²¹ spins/g. The positive electrode active material 100A preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by an electron spin resonance (ESR) method, for example.

### <<Surface Roughness and Specific Surface Area>>

The positive electrode active material 100A of one embodiment of the present invention preferably has a smooth surface with little unevenness. A smooth surface with little unevenness indicates that a fusing agent described later adequately functions and the surfaces of the additive element A source and a composite oxide melt. Thus, a smooth surface with little unevenness is a factor indicating favorable distribution of the additive element A in the surface portion 100a. Favorable distribution means, for example, uneven distribution of the concentration of the additive element A in the surface portion 100a.

A smooth surface with little unevenness can be recognized from, for example, a cross-sectional SEM image or a cross-sectional TEM image of the positive electrode active material 100A or the specific surface area of the positive electrode active material 100A.

The level of the surface smoothness of the positive electrode active material 100A can be quantified from its cross-sectional SEM image, as described below, for example.

First, the positive electrode active material 100A is processed with an FIB or the like such that its cross section is exposed. At this time, the positive electrode active material 100A is preferably covered with a protective film, a protective agent, or the like. Next, a SEM image of the interface between the positive electrode active material 100A and the protective film or the like is taken. The SEM image is subjected to noise processing using image processing software. For example, the Gaussian Blur (σ−2) is performed, followed by binarization. In addition, interface extraction is performed using image processing software. Moreover, an interface line between the positive electrode active material 100A and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness of part of the particle periphery (at least 400 nm) of the positive electrode active material.

On the surface of the particle of the positive electrode active material 100A of this embodiment, root-mean-square (RMS) surface roughness, which is an index of roughness, is preferably less than 3 nm, further preferably less than 1 nm, still further preferably less than 0.5 m.

Note that the image processing software used for the noise processing, the interface extraction, or the like is not particularly limited, and for example, “ImageJ” described in Non-Patent Document 6 to Non-Patent Document 8 can be used.

For example, the level of surface smoothness of the positive electrode active material 100A can also be quantified from the ratio of an actual specific surface area S_{R} measured by a constant-volume gas adsorption method to an ideal specific surface area Sᵢ.

The ideal specific surface area S₁ is calculated on the assumption that all the positive electrode active materials have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100A of one embodiment of the present invention, the ratio of the actual specific surface area S_{R} to the ideal specific surface area Ai obtained from the median diameter D50 (S_{R}/Sᵢ) is preferably greater than or equal to 1.0 and less than or equal to 2.1.

The level of the surface smoothness of the positive electrode active material 100A can be quantified from its cross-sectional SEM image by the following method, for example.

First, a surface SEM image of the positive electrode active material 100A is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., “ImageJ”). The grayscale image includes luminance (brightness information). For example, in an 8-bit grayscale image, luminance can be represented by 28=256 gradation levels. A dark portion has a low gradation level and a bright portion has a high gradation level. A variation in luminance can be quantified in relation to the number of gradation levels. The value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100A of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <<Current-Rest-Method>>

The distribution of the additive element A contained in the surface portion of the positive electrode active material 100A of one embodiment of the present invention, such as magnesium, sometimes slightly changes during repeated charging and discharging. For example, in some cases, the distribution of the additive element A becomes more favorable, so that the electronic conduction resistance decreases. Thus, in some cases, the electric resistance, i.e., a resistance component R(0.1 s) with a high response speed measured by a current-rest-method, decreases at the initial stage of the charge and discharge cycles.

For example, when the n-th (n is a natural number greater than 1) charging and the n+1-th charging are compared, the resistance component R(0.1 s) with a high response speed measured by a current-rest-method is lower in the n+1-th charging than in the n-th charging. Accordingly, the n+1-th discharge capacity is higher than the n-th discharge capacity in some cases. Also in the case of a positive electrode active material that does not contain any additive element, the second charge capacity can be higher than the initial charge capacity, i.e., n=1; thus, n is preferably greater than or equal to 2 and less than or equal to 10, for example. However, n is not limited to the above for the initial stage of the charge and discharge cycles. The stage where the charge and discharge capacity is substantially the same as the rated capacity or is greater than or equal to 97% of the rated capacity can be regarded as the initial stage of the charge and discharge cycles.

### <Pit>

When a positive electrode active material undergoes charging and discharging under conditions, including charging at 4.5 V or more, or at a high temperature, e.g., 45° C. or higher, a progressive defect that progresses deeply from the surface toward the inner portion might be generated. Progress of a defect in a positive electrode active material to form a hole can be referred to as pitting corrosion, and the hole generated by this phenomenon is also referred to as a pit in this specification. Note that as the opening shape of the hole, a wide groove-like shape may be included in addition to a circular shape, an elliptical shape, a rectangular shape, and the like.

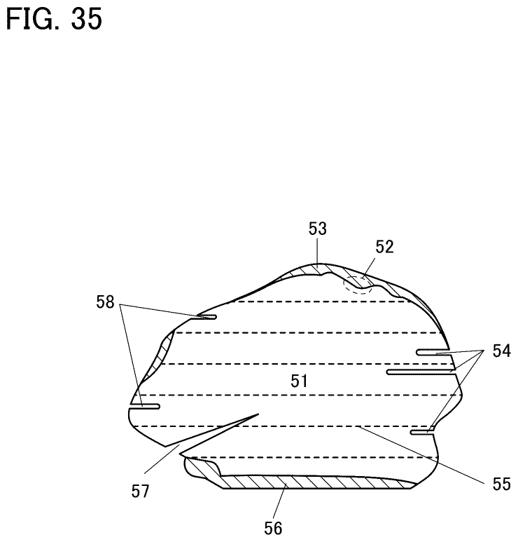

FIG. 35 is a cross-sectional schematic view of a positive electrode active material 51 including pits. A crystal plane 55 parallel to the arrangement of cations is also illustrated. Although a pit 54 and a pit 58 are illustrated as holes since FIG. 35 is a cross-sectional view, their opening shapes are not circular but a wide groove-like shape. Unlike a depression 52, the pit 54 and the pit 58 are likely to be generated parallel to the arrangement of lithium ions as illustrated in the drawing.

In the positive electrode active material 51, surface portions where the additive elements A exist are denoted by reference numerals 53 and 56. A surface portion where the pit is generated contains a smaller amount of the additive element than the surface portions 53 and 56 or contains the additive element A at a concentration lower than or equal to the lower detection limit, and thus probably has a poor function of a barrier film. Presumably, the crystal structure of a composite oxide in the vicinity of a portion where a pit is formed is broken and differs from a layered rock-salt crystal structure. The breakage of the crystal structure might inhibit diffusion and release of lithium ions that are carrier ions; thus, a pit is probably a cause of deterioration of cycle performance.

A source of a pit can be a point defect. It is considered that a pit is generated when a point defect included in a positive electrode active material changes due to repetitive charging and discharging, and the positive electrode active material undergoes chemical or electrochemical erosion or degradation due to the electrolyte or the like surrounding the positive electrode active material. This degradation does not occur uniformly in the surface of the positive electrode active material but occurs locally in a concentrated manner.

In addition, like the crack 57 illustrated in FIG. 35, a defect such as a crack (also referred to as crevice) is sometimes generated by expansion and contraction of the positive electrode active material due to charging and discharging. In this specification, a crack and a pit are different from each other. Immediately after formation of a positive electrode active material, a crack can exist but a pit does not exist. A pit can also be regarded as a hole formed by extraction of some layers of the transition metal M and oxygen due to charging and discharging under high-voltage conditions at 4.5 V or more, or at a high temperature (45° C. or higher), i.e., a portion from which the transition metal M has been eluted. A crack refers to, for example, a surface newly generated by application of physical pressure or a crevice generated owing to a crystal grain boundary. A crack might be caused by expansion and contraction of a positive electrode active material due to charging and discharging. A pit might be generated from a void inside a positive electrode active material and/or a crack.

### [Formation Method of Positive Electrode Active Material]

A way of adding the additive element A is important in forming the positive electrode active material 100A having the distribution of the additive element A, the composition, and/or the crystal structure that were/was described in the above embodiment. Favorable crystallinity of the inner portion 100b is also important.

Thus, in the formation process of the positive electrode active material 100A, preferably, a composite oxide containing lithium and a transition metal is synthesized first, then the additive element A source is mixed, and heat treatment is performed.

In a method of synthesizing a composite oxide containing the additive element A, lithium, and the transition metal M by mixing the additive element A source concurrently with the transition metal M source and a lithium source, it is sometimes difficult to increase the concentration of the additive element A in a surface portion 100a. In addition, after a composite oxide containing lithium and the transition metal M is synthesized, only mixing the additive element A source without performing heating causes the additive element to be just attached to, not dissolved in, the composite oxide containing lithium and the transition metal M. It is difficult to distribute the additive element A favorably without sufficient heating. Therefore, it is preferable that lithium cobalt oxide be synthesized, and then the additive element A source be mixed and heat treatment be performed. The heat treatment after mixing of the additive element A source may be referred to as annealing.

However, annealing at an excessively high temperature may cause cation mixing, which increases the possibility of entry of the additive element A such as magnesium into the transition metal M sites. Magnesium that exists at the transition metal M sites does not have an effect of maintaining a layered rock-salt crystal structure belonging to R-3m when x in LixCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element A source. The material can be regarded as functioning as a fusing agent when having a melting point lower than that of the composite oxide containing lithium and the transition metal M. For example, a fluorine compound such as lithium fluoride is preferably used. Adding the fusing agent decreases the melting points of the additive element A source and the composite oxide containing lithium and the transition metal M. The decrease in the melting point makes it easier to favorably distribute the additive element A at a temperature where the cation mixing is less likely to occur.

Furthermore, after the synthesis of the composite oxide containing lithium and the transition metal M, heating is preferably performed before the additive element A is mixed. This heating is referred to as initial heating in some cases.

Owing to influence of lithium extraction from part of the surface portion 100a of the composite oxide containing lithium and the transition metal M by the initial heating, the distribution of the additive element A becomes more favorable.

Specifically, the distributions of the additive elements A can be easily made different from each other by the initial heating in the following mechanism. First, lithium is extracted from part of the surface portion 100a by the initial heating. Next, the additive element A sources such as a nickel source, an aluminum source, and a magnesium source and the composite oxide containing lithium and the transition metal M including the surface portion 100a that is deficient in lithium are mixed and heated. Among the additive elements A, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed.

Among the additive elements A, nickel is likely to form a solid solution and is diffused to the inner portion 100b in the case where the surface portion 100a is a composite oxide containing lithium and the transition metal M and having a layered rock-salt crystal structure, but nickel is likely to remain in the surface portion 100a in the case where part of the surface portion 100a has a rock-salt crystal structure.

Furthermore, in such a rock-salt crystal structure, the bond distance between a metal Me and oxygen (Me-O distance) tends to be longer than that in a layered rock-salt crystal structure.

For example, Me-O distance is 2.09×10⁻¹ nm and 2.11×10⁻¹ nm in Ni_{0.5}Mg_{0.5}O having a rock-salt crystal structure and MgO having a rock-salt crystal structure, respectively. Even when a spinel phase is formed in part of the surface portion 100a, Me-O distance is 2.0125×10⁻¹ nm and 2.02×10⁻¹ nm in NiAl₂O₄ having a spinel structure and MgAl₂O₄ having a spinel structure, respectively. In each case, Me-O distance is longer than 2×10⁻¹ nm.

Meanwhile, in a layered rock-salt crystal structure, the bond distance between oxygen and a metal other than lithium is shorter than the above distance. For example, Al—O distance is 1.905× 10−1 nm (Li—O distance is 2.11×10⁻¹ nm) in LiAlO₂ having a layered rock-salt crystal structure. In addition, Co—O distance is 1.9224×10⁻¹ nm (Li—O distance is 2.0916×10⁻¹ nm) in LiCoO₂ having a layered rock-salt crystal structure.

According to Shannon et al., Acta A 32 (1976) 751., the ion radius of hexacoordinated aluminum and the ion radius of hexacoordinated oxygen are 0.535×10⁻¹ nm and 1.4×10⁻¹ nm, respectively, and the sum of those values is 1.935×10⁻¹ nm.

From the above, aluminum is considered to exist at sites other than lithium sites more stably in a layered rock-salt crystal structure than in a rock-salt crystal structure. Thus, in the surface portion 100a, aluminum is more likely to be distributed in a region having a layered rock-salt phase at a larger depth and/or the inner portion 100b than in a region having a rock-salt phase that is close to the surface.

Moreover, the initial heating is expected to increase the crystallinity of the layered rock-salt crystal structure of the inner portion 100b.

However, the initial heating is not necessarily performed. In some cases, by controlling atmosphere, temperature, time, or the like in another heating step, e.g., annealing, the positive electrode active material 100A having the O3′ type structure when x in LixCoO₂ is small can be fabricated.

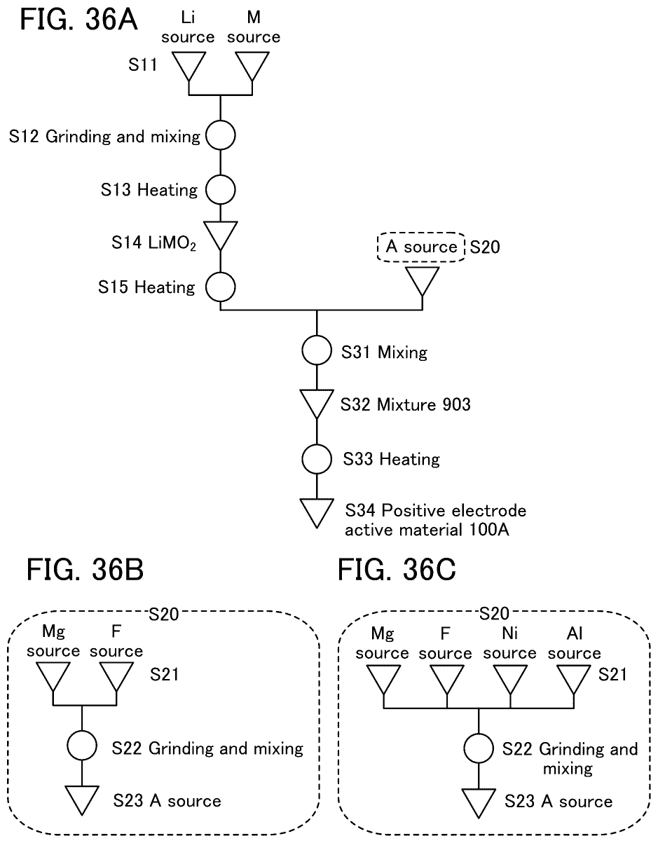

An example of a formation flow of the positive electrode active material 100A, in which annealing and the initial heating are performed, is described with reference to FIG. 36A to FIG. 36C.

### <Step S11>

In Step S11 shown in FIG. 36A, a lithium source (Li source) and a transition metal M source (M source) are prepared as materials for lithium and the transition metal M which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal M can be selected from the elements belonging to Group 3 to Group 11 of the periodic table and for example, at least one of manganese, cobalt, and nickel is used. That is, as the transition metal M, for example, cobalt alone; nickel alone; two metals of cobalt and manganese: two metals of cobalt and nickel; or three metals of cobalt, manganese, and nickel may be used. In the case where cobalt alone is used, the positive electrode active material to be obtained contains lithium cobalt oxide (LCO); in the case where three metals of cobalt, manganese, and nickel are used, the positive electrode active material to be obtained contains lithium nickel cobalt manganese oxide (NCM).

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal M source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the transition metal M source preferably has high crystallinity, and preferably includes single crystal particles, for example. To evaluate the crystallinity of the transition metal M source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, an enhanced Hollow-Cone Illumination-TEM image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal M source.

In the case of using two or more transition metal M sources, the two or more transition metal M sources are preferably prepared to have proportions (mixing ratio) such that a layered rock-salt crystal structure would be obtained.

### <Step S12>

Next, in Step S12 shown in FIG. 36A, the lithium source and the transition metal M source are ground and mixed to form a mixed material (mixture). The grinding and mixing can be performed by a dry method or a wet method. A wet method is preferable because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal M source be mixed into dehydrated acetone whose moisture content is less than or equal to 10 ppm and which has a purity higher than or equal to 99.5% in the crushing and mixing. With the use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 36A, the above mixed material is heated. The heating temperature is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the transition metal M source. An excessively high temperature might lead to a defect due to evaporation of lithium from the lithium source and/or excessive reduction of the metal used as the transition metal M source, for example. The defect is, for example, an oxygen defect which could be induced by a change of trivalent cobalt into divalent cobalt due to excessive reduction, in the case where cobalt is used as the transition metal M.

When the heating time is too short, LiMO₂ is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa as measured by a differential pressure gauge, and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of alumina (aluminum oxide), mullite cordierite, magnesia, or zirconia, i.e., preferably includes a highly heat-resistant material. Since aluminum oxide is a material where impurities do not easily enter, the purity of a crucible or a sagger made of alumina is higher than or equal to 99%, preferably higher than or equal to 99.5%. In this embodiment, a crucible made of aluminum oxide with a purity of 99.9% is used. The heating is preferably performed with the crucible or the saggar covered with a lid. Volatilization of the materials can be prevented.

The heated material is ground as needed and may be made to pass through a sieve. Before collection of the heated material, the material may be moved from the crucible to a mortar. As the mortar, a mortar made of aluminum oxide is suitably used. A mortar made of aluminum has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, a composite oxide containing the transition metal M (LiMO₂) can be obtained in Step S14 shown in FIG. 36A. The composite oxide needs to have a crystal structure of a lithium composite oxide represented by LiMO₂, but the composition is not strictly limited to Li:M:O=1:1:2. In the case where cobalt is used as the transition metal M, the composite oxide is referred to as a composite oxide containing cobalt and is represented by LiCoO₂. The composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 36A, the above composite oxide is heated. The heating in Step S15 is the heating performed on the composite oxide, and thus is sometimes referred to as the initial heating. The heating is performed before Step S20 described below, and thus is sometimes referred to as preheating or pretreatment.

By the initial heating, lithium is extracted from part of the surface portion 100a of the composite oxide as described above. In addition, an effect of increasing the crystallinity of the inner portion 100b can be expected. The lithium source and/or transition metal M source prepared in Step S11 and the like might contain impurities. The initial heating can reduce impurities in the composite oxide completed in Step 14.

Through the initial heating, an effect of smoothing a surface of the composite oxide is obtained. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

For the initial heating, there is no need to prepare a lithium compound source. Alternatively, there is no need to prepare the additive element A source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the composite oxide formed in Step S13.

The heating in Step S13 might cause a temperature difference between the surface and an inner portion of the above composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S15. This is also rephrased as modification of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery including a composite oxide with a smooth surface as a positive electrode active material, deterioration by charging and discharging is suppressed and a crack in the positive electrode active material can be prevented.

It can be said that when surface unevenness information in one cross section of a composite oxide is quantified with measurement data, a smooth surface of the composite oxide has a surface roughness at least less than or equal to 10 nm. The one cross section is, for example, a cross section obtained in observation using a scanning transmission electron microscope (STEM).

Note that in Step S14, a composite oxide containing lithium, the transition metal M, and oxygen, synthesized in advance may be used. In this case, Step S11 to Step S13 can be omitted. When Step S15 is performed on the pre-synthesized composite oxide, a composite oxide with a smooth surface can be obtained.

The initial heating might reduce lithium in the composite oxide. The additive element A described for Step S20 or the like below might easily enter the composite oxide owing to the reduction in lithium.

### <Step S20>

The additive element A may be added to the composite oxide having a smooth surface as long as a layered rock-salt crystal structure can be obtained. When the additive element A is added to the composite oxide having a smooth surface, the additive element A can be uniformly added. It is thus preferable that the initial heating precede the addition of the additive element A. The step of adding the additive element A is described with reference to FIG. 36B and FIG. 36C.

### <Step S21>

In Step S21 shown in FIG. 36B, the additive element A sources (A sources) to be added to the composite oxide are prepared. A lithium source may be prepared together with the additive element A sources.

As the additive element A, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or more selected from bromine and beryllium can be used. Note that the additive elements given earlier are more suitably used since bromine and beryllium are elements having toxicity to living things.

When magnesium is selected as the additive element A, the additive element A source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element A source can be referred to as a fluorine source. As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, sodium aluminum hexafluoride, or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as the lithium source. Another example of the lithium source that can be used in Step S21 is lithium carbonate.

The fluorine source may be a gas, and fluorine, carbon fluoride, sulfur fluoride, oxygen fluoride, or the like may be used and mixed in the atmosphere in a heating step described later. Two or more of these fluorine sources may be used.

In this embodiment, lithium fluoride is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤ x≤1.9), further preferably x:1 (0.1≤ x≤0.5), still further preferably x:1 (x=0.33 or the neighborhood thereof). Note that in this specification and the like, the neighborhood means a value greater than 0.9 times and less than 1.1 times a given value.

Meanwhile, magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, relative to LiCoO₂. When magnesium is added at less than or equal to 0.1 at %, the initial discharge capacity is high but repeated charging and discharging with a large charge depth rapidly lowers the discharge capacity. In the case where magnesium is added at greater than 0.1 at % and less than or equal to 3 at %, both the initial discharge characteristics and charge and discharge cycle performance are excellent even when charging and discharging with a large charge depth are repeated. By contrast, in the case where magnesium is added at greater than 3 at %, both the initial discharge capacity and the charge and discharge cycle performance tend to gradually degrade.

### <Step S22>

Next, in Step S22 shown in FIG. 36B, the magnesium source and the fluorine source are ground and mixed. Any of the conditions for the grinding and mixing that are described for Step S12 can be selected to perform this step.

A heating step may be performed after Step S22 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### <Step S23>

Next, in Step S23 shown in FIG. 36B, the materials ground and mixed in the above step are collected to give the additive element A source (A source). Note that the additive element A source shown in Step S23 contains a plurality of starting materials and can be referred to as a mixture.

As for the particle diameter of the mixture, the D50 (median diameter) is preferably greater than or equal to 600 nm and less than or equal to 2θ μm, further preferably greater than or equal to 1 μm and less than or equal to 10 μm. Also when one kind of material is used as the additive element A source, the D50 (median diameter) is preferably greater than or equal to 600 nm and less than or equal to 2θ μm, further preferably greater than or equal to 1 μm and less than or equal to 10 μm.

Such a pulverized mixture (which may contain only one kind of the additive element A) is easily attached to the surface of a composite oxide uniformly in a later step of mixing with the composite oxide. The mixture is preferably attached uniformly to the surface of the composite oxide, in which case fluorine and magnesium are easily distributed or dispersed uniformly in a surface portion of the composite oxide after heating. The region where fluorine and magnesium are distributed can be referred to as a surface portion. When there is a region containing neither fluorine nor magnesium in the surface portion, an O3′ type crystal structure, which is described later, might be unlikely to be obtained in a charged state. Note that although fluorine is used in the above description, chlorine may be used instead of fluorine, and a general term “halogen” for these elements can replace “fluorine”.

### <Step S21>

A process different from that in FIG. 36B is described with reference to FIG. 36C. In Step S21 shown in FIG. 36C, four kinds of additive element A sources to be added to the composite oxide are prepared. In other words, FIG. 36C is different from FIG. 36B in the kinds of the additive element A sources. A lithium source may be prepared together with the additive element A sources.

As the four kinds of additive element A sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 36B. As a nickel source, nickel oxide, nickel hydroxide, or the like can be used. As an aluminum source, aluminum oxide, aluminum hydroxide, or the like can be used.

<Step S22> and <Step S23>

Next, Step S22 and Step S23 shown in FIG. 36C are similar to the steps described with reference to FIG. 36B.

### <Step S31>

Next, in Step S31 shown in FIG. 36A, the composite oxide and the additive element A source (A source) are mixed. The ratio of the number M of the transition metal atoms in the composite oxide containing lithium, the transition metal M, and oxygen to the number Mg of magnesium atoms contained in the additive element A is preferably M:Mg=100:y (0.1≤ y≤6), further preferably M:Mg=100:y (0.3≤ y≤3).

The conditions of the mixing in Step S31 are preferably milder than those of the mixing in Step S12 in order not to damage the composite oxide. For example, conditions with a lower rotation frequency or shorter time than those for the mixing in Step S12 are preferable. In addition, it can be said that a dry method has a milder condition than a wet method. For example, a ball mill or a bead mill can be used for the mixing. When the ball mill is used, a ball made of zirconium oxide is preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 36A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal M source in Step S11, i.e., at the stage of the starting materials of the composite oxide. Then, the heating in Step S13 is performed, so that LiMO₂ to which magnesium and fluorine are added can be obtained. In this case, there is no need to separately perform Step S11 to Step S14 and Step S21 to Step S23. This method can be regarded as being simple and highly productive.

Alternatively, a composite oxide to which magnesium and fluorine are added in advance may be used. When a composite oxide to which magnesium and fluorine are added is used, Step S11 to Step S32 and Step S20 can be skipped. This method can be regarded as being simple and highly productive.

Alternatively, to the composite oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 36A, the mixture 903 is heated. Any of the heating conditions described for Step S13 can be selected to perform this step. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element A source proceeds. The temperature at which the reaction proceeds is the temperature at which interdiffusion of the elements contained in LiMO₂ and the additive element A source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° ° C., yet still further preferably higher than or equal to 500° C. and lower than or equal to 900° ° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step 13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element A such as magnesium in the surface portion and fabrication of the positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiMO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the mixtures 903 are not adhered to each other. Adhesion of the particles of the mixture 903 during the heating might decrease the area of contact with oxygen in the atmosphere and inhibit a path of diffusion of the additive element A (e.g., fluorine), thereby hindering distribution of the additive element A (e.g., magnesium and fluorine) in the surface portion.

It is considered that uniform distribution of the additive element A (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions such as the heating temperature and the size and composition of LiMO₂ in Step S14. In the case where LiMO₂ is small, the heating is preferably performed at a lower temperature or for a shorter time than annealing in the case where LiMO₂ is large, in some cases.

When the median diameter (D50) of the composite oxide (LiMO₂) in Step S14 in FIG. 36A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than tor equal to 10 hours and shorter than or equal to 50 hours.

When the median diameter (D50) of the composite oxide (LiMO₂) in Step $14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than tor equal to 10 hours and shorter than or equal to 50 hours.

### <Step S34>

Next, the heated material is collected in Step S34 shown in FIG. 36A, in which crushing is performed as needed; thus, the positive electrode active material 100A is obtained. Here, the collected positive electrode active material 100A is preferably made to pass through a sieve. Through the above steps, the positive electrode active material 100A of one embodiment of the present invention can be fabricated. The positive electrode active material of one embodiment of the present invention has a smooth surface.

Note that the positive electrode active material 100A described in this embodiment can be used as any one or more of the first active material 411a, the second active material 411b, the third active material 411c, the fourth active material 411d, and the fifth active material 411e in Embodiment 1.

### Embodiment 3

### [Fabrication Method of Positive Electrode Active Material]

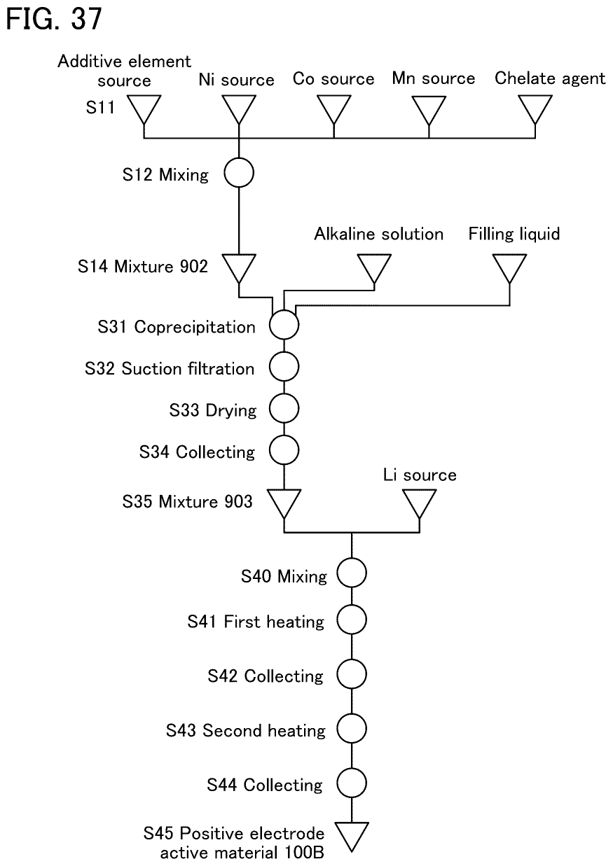

This embodiment describes an example of a fabrication method of a positive electrode active material 100B that is an example of the positive electrode active material 100 usable for a secondary battery of one embodiment of the present invention, with reference to FIG. 37. A positive electrode active material to which an additive element is added is also referred to as a composite oxide containing the additive element.

In this embodiment, a coprecipitation method is employed where a coprecipitation precursor where Co, Ni, and Mn exist in one particle is formed, a Li salt is mixed with the coprecipitation precursor, and then heating is performed.

In Step S11 in FIG. 37, first, an aqueous solution of source materials (an additive element source, a Ni source, a Co source, a Mn source, and a chelate agent) is prepared.

A Ni salt, specifically nickel sulfate, nickel carbonate, nickel hydroxide, nickel acetate, or nickel nitrate is used as the Ni source: a cobalt salt, specifically cobalt sulfate, cobalt acetate, or cobalt nitrate is used as the Co source; and a manganese salt, specifically manganese sulfate, manganese carbonate, manganese oxide, manganese acetate, or manganese nitrate is used as the Mn source.

As the additive element source, one or more selected from an aluminum salt, a magnesium salt, and a calcium salt are used. As the additive element source, one or more selected from aluminum oxide, aluminum hydroxide, magnesium oxide, magnesium hydroxide, basic magnesium carbonate ((MgCO₃)₃Mg(OH)₂·3H₂O), calcium oxide, calcium carbonate, and calcium hydroxide are used. In this embodiment, a sulfate of aluminum is used as the additive element source.

In this embodiment, nickel sulfate, cobalt sulfate, manganese sulfate, and the sulfate of aluminum are weighed out to have desired amounts and mixed (Step S12). A mixed solution 902 obtained by mixing these materials and pure water, and an alkaline solution are prepared (Step S14). As an aqueous medium other than pure water used for the mixed solution 902, a chelate agent may be used.

For pH adjustment, one kind or more kinds selected from sodium hydroxide, potassium hydroxide, and lithium hydroxide is used as the alkaline solution. In this embodiment, an aqueous solution of sodium hydroxide is used as the alkaline solution.

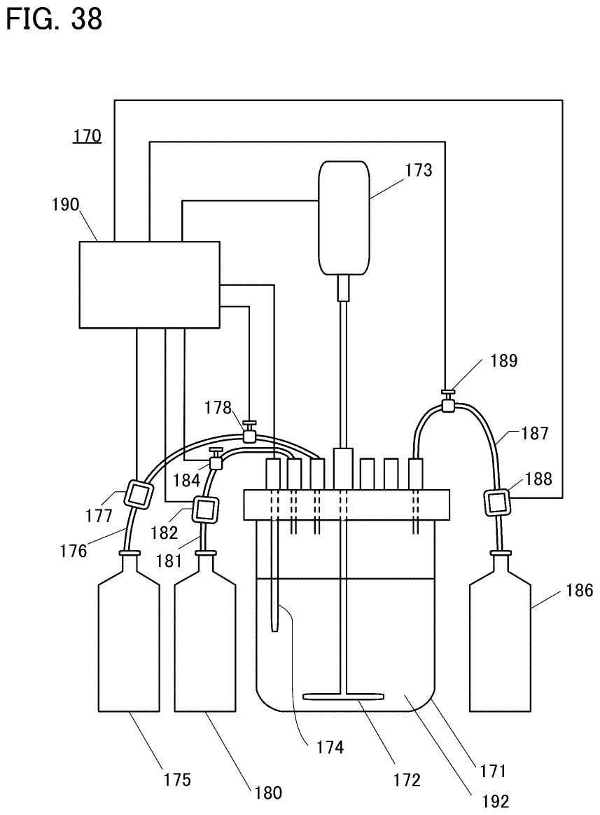

Then, with the use of a coprecipitation synthesis apparatus illustrated in FIG. 38, the mixed solution 902 and the alkaline solution are concurrently supplied to what is called a filling liquid that is put in a reaction container 171 in advance. Note that what is called the filling liquid put in the reaction container 171 is a mixed solution of glycine and pure water. Note that the reaction container 171 is filled with a nitrogen atmosphere. Note that the filling liquid is referred to as a component adjustment aqueous solution in some cases.

FIG. 38 is a schematic cross-sectional view illustrating an example of a coprecipitation synthesis apparatus 170. The coprecipitation synthesis apparatus 170 includes a reaction container 171, a stirrer 172, a stirrer motor 173, a thermometer 174, a tank 175, a tube 176, a pump 177, a valve 178, a tank 180, a tube 181, a pump 182, a valve 184, a tank 186, a tube 187, a pump 188, a valve 189, and a control device 190. The stirrer 172 can stir an inner liquid 192 in the reaction container 171. The stirrer motor 173 functions as a power source for rotating the stirrer 172 of a paddled agitator blade (referred to as a puddle blade). The thermometer 174 measures the temperature of the inner liquid 192. Different aqueous solutions of source materials can be pooled in the tanks, and the aqueous solutions of source materials can be injected to the reaction container 171 from the tanks through the tubes.

In each tank, the mixed solution 902, an alkaline solution, and a filling liquid are prepared.

The amount of the delivered aqueous solution of source materials can be controlled with the valve. The control device 190 is electrically connected to the stirrer motor 173, the thermometer 174, the pump 177, the pump 182, the valve 184, the pump 188, and the valve 189, and can control the rotational frequency of the stirrer 172, the temperature of the inner liquid 192, the amount of each aqueous solution of source materials, and the like. When a heater (not illustrated) is attached to the periphery of the reaction container 171, the inner liquid 192 can be heated. When a refrigerant is circulated around the reaction container 171, the inner liquid 192 in the reaction container 171 can be cooled. Note that the inner liquid 192 is referred to as a reaction aqueous solution in some cases.

The filling liquid is injected to the reaction container, and the mixed solution 902 is dropped at a constant rate while stirring with the paddle blade provided with the stirrer motor is performed. Note that without limitation to the constant rate, it also possible to adjust the dropping by changing the rate in accordance with the amount of the liquid in the reaction container or to adjust the dropping for keeping pH constant. In addition, the rotation number of the paddle blade is not limited to a constant number, and can be adjusted as appropriate. Furthermore, the alkaline solution is dropped concurrently with the dropping of the mixed solution 902, and pH of the inner liquid 192 in the reaction container 171 is automatically adjusted within the range from 9 to 11, preferably from 9.8 to 10.3 for co-precipitation (also referred to as coprecipitation) (Step S31). Note that Step S31 is referred to as a coprecipitation step in some cases.

As a method for precipitating a hydroxide in an inner liquid, either of the following methods can be used: a method where extraction is performed on a mixed solution using a filtration material and a precipitation reaction is caused while a hydroxide is concentrated (a concentration method) and a method where extraction is performed on a mixed solution together with a hydroxide without using a filtration material and a precipitation reaction is caused while the concentration of the hydroxide is kept low (an overflow method).

Next, particles of coprecipitated salts generated in the reaction container are separated with a suction filtration apparatus, sodium ions attached to the particles are removed by cleaning (Step S32), and drying is performed using an electric furnace at higher than or equal to 60° C. and lower than or equal to 200° C. under a reduced pressure (Step S33). The drying is not limited to being performed under a reduced pressure, and may be performed under an atmospheric pressure. Note that the sodium ions are removed by cleaning in such a manner that cleaning with pure water is performed and then replacement with acetone is performed. The drying time is set appropriately depending on the amount, and is longer than or equal to 1 hour and shorter than or equal to 100 hours.

The particles are ground or crushed in a mortar to have a uniform particle diameter, and then collected (Step S34). The grinding and crushing in a mortar can be omitted if they are unnecessary.

In such a manner, the mixture 903 that is a precursor is formed. A Li source is prepared in accordance with the amount of the obtained the mixture 903 (Step S35). As the Li source, one kind selected from lithium hydroxide, lithium carbonate, and lithium nitrate is used.

Although this embodiment describes the example where the additive element source is added in Step S11, a procedure where the additive element source is added in Step S35 may be employed. In that case, the additive element source is prepared in accordance with the amount of the obtained the mixture 903.

Then, the mixture 903 and the Li source are mixed (Step S40). For the mixing, a mortar or a stirring mixer is used.

Next, first heating is performed (Step S41). An electric furnace or a rotary kiln furnace can be used as a firing device for the first heating.

The first heat treatment is preferably performed at a temperature higher than or equal to 400° C. and lower than or equal to 700° C. The time of the first heating is preferably longer than or equal to 1 hour and shorter than or equal to 10 hours.

Sequentially, the particles are ground or crushed in a mortar to have a uniform particle diameter, and then collected (Step S42). Furthermore, classification may be performed using a sieve. In this embodiment, a crucible made of aluminum oxide (also referred to as alumina) with a purity of 99.9% is used. It is suitable to collect the heated materials after the materials are transferred from the crucible to the mortar in order to prevent impurities from entering the materials. The mortar is suitably made of a material which does not easily release impurities. Specifically, it is suitable to use a mortar made of alumina with a purity higher than or equal to 90%, preferably higher than or equal to 99%.

Next, second heating is performed (Step S43). An electric furnace or a rotary kiln furnace can be used as a firing device for the second heating.

The temperature of the second heating is at least higher than the temperature of the first heating and is preferably higher than 700° C. and lower than or equal to 1050° C. The time of the second heating is preferably longer than or equal to 1 hour and shorter than or equal to 2θ hours. The second heating is preferably performed in an oxygen atmosphere, and in particular, preferably performed while oxygen is supplied. The oxygen supply rate is, for example, 10 L/min per litter of furnace inner capacity. Specifically, the heating is preferably performed in a state where a container containing the mixture 903 is covered with a lid.

Sequentially, the particles are ground or crushed in a mortar to have a uniform particle diameter, and then collected (Step S44). Furthermore, classification may be performed using a sieve.

Through the above steps, the positive electrode active material 100B can be fabricated (Step S45).

Note that the positive electrode active material 100B described in this embodiment can be used as any one or more of the first active material 411a, the second active material 411b, the third active material 411c, the fourth active material 411d, and the fifth active material 411e in Embodiment 1.

### Embodiment 4

### [Negative Electrode Active Material]

As the negative electrode active material, it is preferable to use a material that can be reacted with a carrier ion of a secondary battery, a material into and from which a carrier ion can be inserted and extracted, a material capable of an alloying reaction with a metal that is to be a carrier ion, a material that can dissolve and precipitate a metal that is to be a carrier ion, or the like.

An example of the negative electrode active material is described below.

In addition, a metal or a compound containing one or more elements selected from silicon, tin, gallium, aluminum, germanium, lead, antimony, bismuth, silver, zinc, cadmium, and indium can be used as the negative electrode active material. Examples of an alloy-based compound using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

A material whose resistance is lowered by addition of an impurity element such as phosphorus, arsenic, boron, aluminum, or gallium to silicon may be used. A silicon material pre-doped with lithium may also be used. Examples of a pre-doping method include annealing of a mixture of silicon with lithium fluoride, lithium carbonate, or the like and mechanical alloying of a lithium metal and silicon. A secondary battery may be fabricated in the following manner: an electrode containing silicon is formed; lithium doping is performed through charge and discharge reaction with a combination of the electrode and an electrode of a lithium metal or the like; and then the electrode subjected to doping is combined with a counter electrode (e.g., a positive electrode for a negative electrode subjected to pre-doping).

Silicon nanoparticles can be used as the negative electrode active material, for example. The median diameter D50 of a silicon nanoparticle is, for example, preferably greater than or equal to 5 nm and less than 1 μm, further preferably greater than or equal to 10 nm and less than or equal to 300 nm, still further preferably greater than or equal to 10 nm and less than or equal to 100 nm.

The silicon nanoparticles may have crystallinity. The silicon nanoparticles may include a region with crystallinity and an amorphous region.

As a material containing silicon, a material represented by SiOₓ (x is preferably less than 2, further preferably greater than or equal to 0.5 and less than or equal to 1.6) can be used, for example.

As the negative electrode active material, a carbon-based material such as graphite, graphitizing carbon, non-graphitizing carbon, carbon nanotube, carbon black, or a graphene compound can be used, for example.

Furthermore, as the negative electrode active material, an oxide containing one or more elements selected from titanium, niobium, tungsten, and molybdenum can be used, for example.

As the negative electrode active material, a plurality of the above-described metals, materials, compounds, and the like can be used in combination.

As the negative electrode active material, an oxide such as SnO, SnO₂, titanium dioxide (TiO₂), lithium titanium oxide (Li₄TisO₁₂), a lithium-graphite intercalation compound (LiₓC₆), niobium pentoxide (Nb₂O₅), tungsten oxide (WO₂), or molybdenum oxide (MoO₂) can be used, for example.

Alternatively, as the negative electrode active material, Li₃₋ₓMₓN (M is Co, Ni, or Cu) with a Li₃N structure, which is a composite nitride of lithium and a transition metal, can be used. For example, Li_{2.6}CO_{0.4}N₃ is preferable because of high charge and discharge capacity (900 mAh/g).

A composite nitride of lithium and a transition metal is preferably used as the negative electrode material, in which case the negative electrode material can be used in combination with a material for a positive electrode material which does not contain lithium ions, such as V₂O₅ or Cr₃O₈. Note that in the case of using a material containing lithium ions as a positive electrode material, the composite nitride of lithium and a transition metal can be used as the negative electrode material by extracting the lithium ions contained in the positive electrode material in advance.

Alternatively, a material that causes a conversion reaction can be used as the negative electrode active material. For example, a transition metal oxide that does not cause an alloying reaction with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, CusN, and Ge₃N₄, phosphides such as NiP₂, FeP₂, and CoP₃, and fluorides such as FeF₃ and BiF₃.

Note that the negative electrode active material described in this embodiment can be used as any one or more of the first active material 411a, the second active material 411b, the third active material 411c, the fourth active material 411d, and the fifth active material 411e in Embodiment 1.

### Embodiment 5

This embodiment describes examples of shapes of several types of secondary batteries including a positive electrode or a negative electrodeformed by the formation method described in the above embodiment.

### [Coin-Type Secondary Battery]

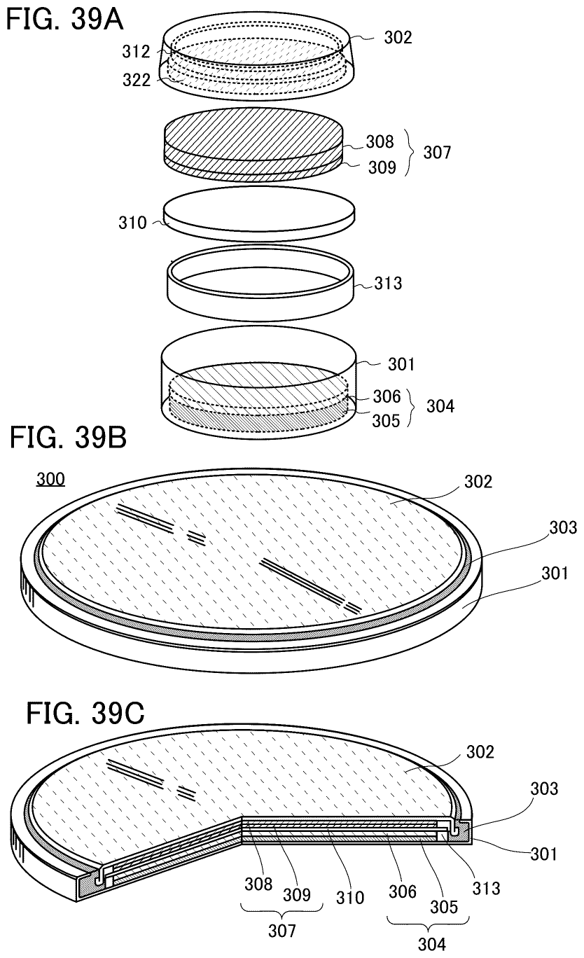

An example of a coin-type secondary battery is described. FIG. 39A is an exploded perspective view of a coin-type (single-layer flat type) secondary battery, FIG. 39B is an external view, and FIG. 39C is a cross-sectional view thereof. Coin-type secondary batteries are mainly used in small electronic devices. In this specification and the like, coin-type batteries include button-type batteries.

For easy understanding, FIG. 39A is a schematic view illustrating overlap (a vertical relation and a positional relation) between components. Thus, FIG. 39A and FIG. 39B do not completely correspond with each other.

In FIG. 39A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 39A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 39B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 39C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

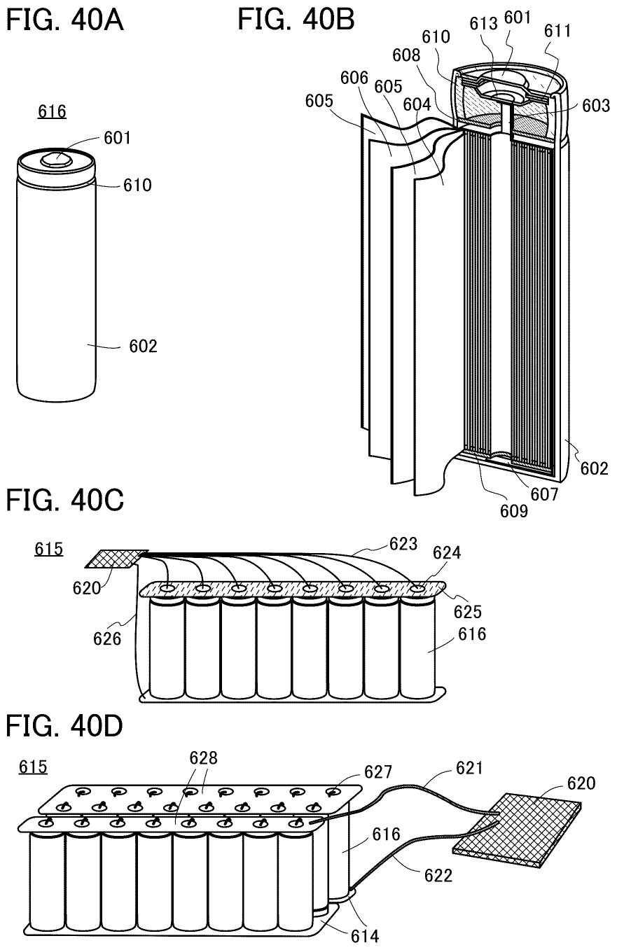

An example of a cylindrical secondary battery is described with reference to FIG. 40A. As illustrated in FIG. 40A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 40B schematically illustrates a cross section of a cylindrical secondary battery. The cylindrical secondary battery illustrated in FIG. 40B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 interposed therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 40A to FIG. 40D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in the above embodiment is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the increased internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 40C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharging or overdischarging or the like can be used, for example.

FIG. 40D illustrates an example of the power storage system 615. The power storage system 615 includes the plurality of secondary batteries 616, and the plurality of secondary batteries 616 are interposed between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 40D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

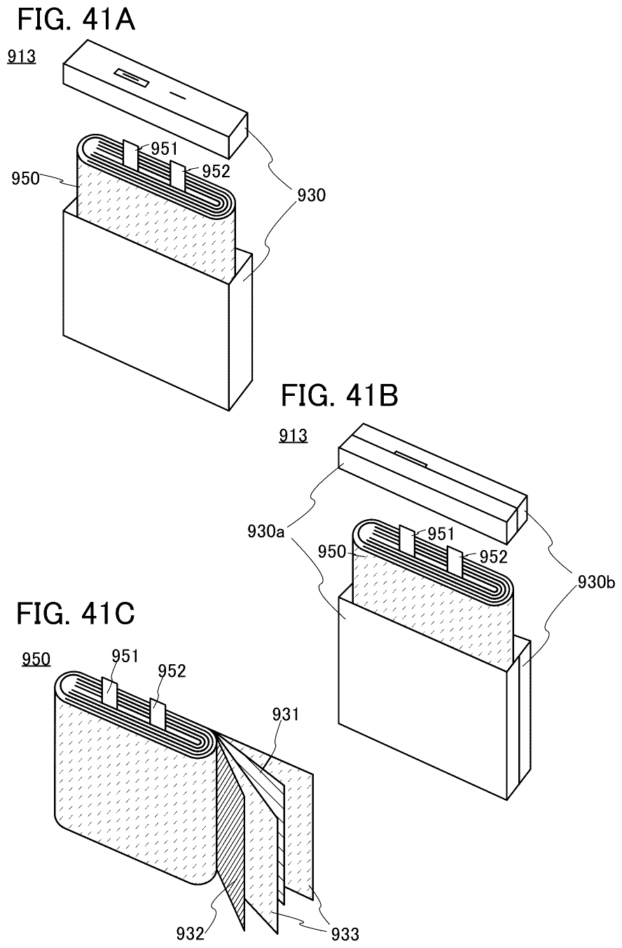

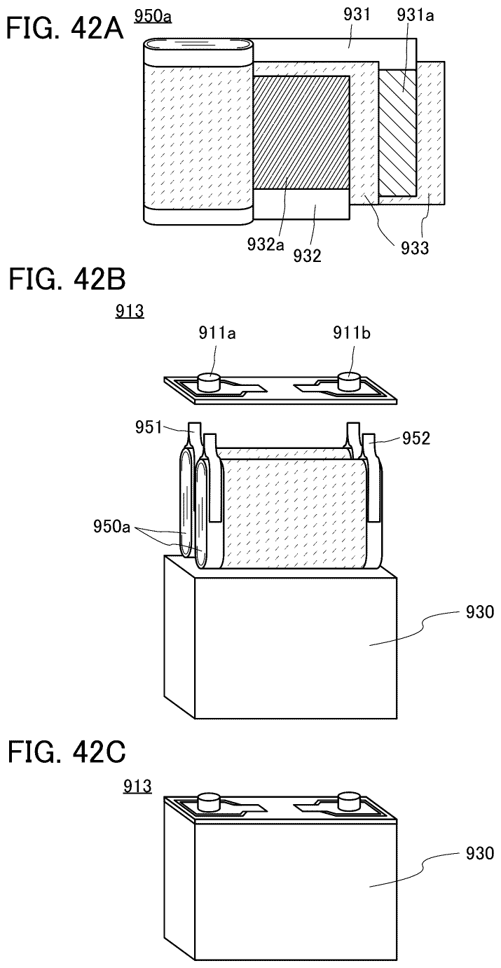

Structure examples of secondary batteries are described with reference to FIG. 41 and FIG. 42.

The secondary battery 913 illustrated in FIG. 41A includes a wound body 950 provided with the terminal 951 and the terminal 952 inside a housing 930. The wound body 950 is immersed in an electrolyte solution inside the housing 930. The terminal 952 is in contact with the housing 930. The use of an insulator or the like prevents contact between the terminal 951 and the housing 930. Note that in FIG. 41A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 41B, the housing 930 illustrated in FIG. 41A may be formed using a plurality of materials. For example, in the secondary battery 913 illustrated in FIG. 41B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 41C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 42A to FIG. 42C, the secondary battery 913 may include a wound body 950a. The wound body 950a illustrated in FIG. 42A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in the above embodiment is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 42B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 42C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 42B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 41A to FIG. 41C can be referred to for the other components of the secondary battery 913 illustrated in FIG. 42A and FIG. 42B.

### <Laminated Secondary Battery>

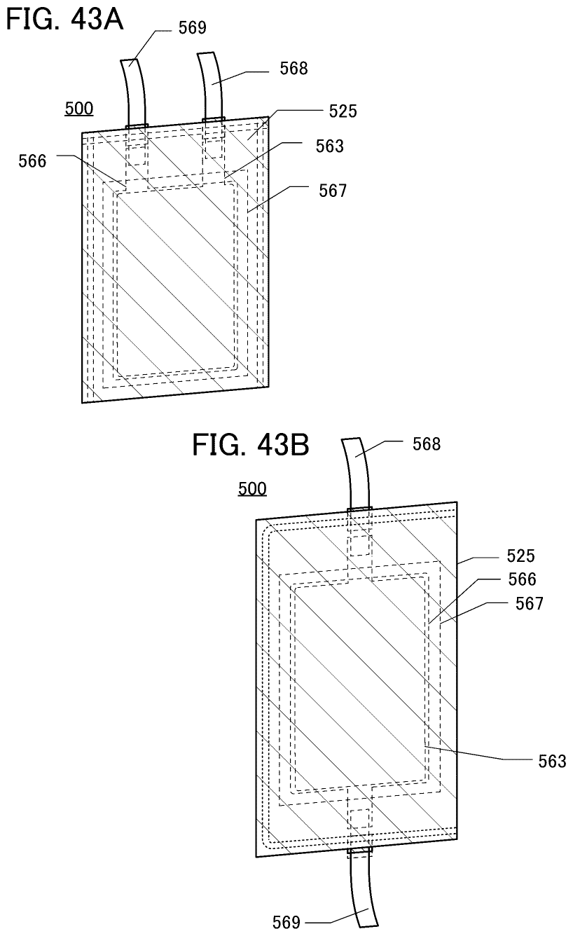

Next, examples of the appearance of a laminated secondary battery are illustrated in FIG. 43A and FIG. 43B. In FIG. 43A and FIG. 43B, a positive electrode 563, a negative electrode 566, a separator 567, an exterior body 525, a positive electrode lead electrode 568, and a negative electrode lead electrode 569 are included.

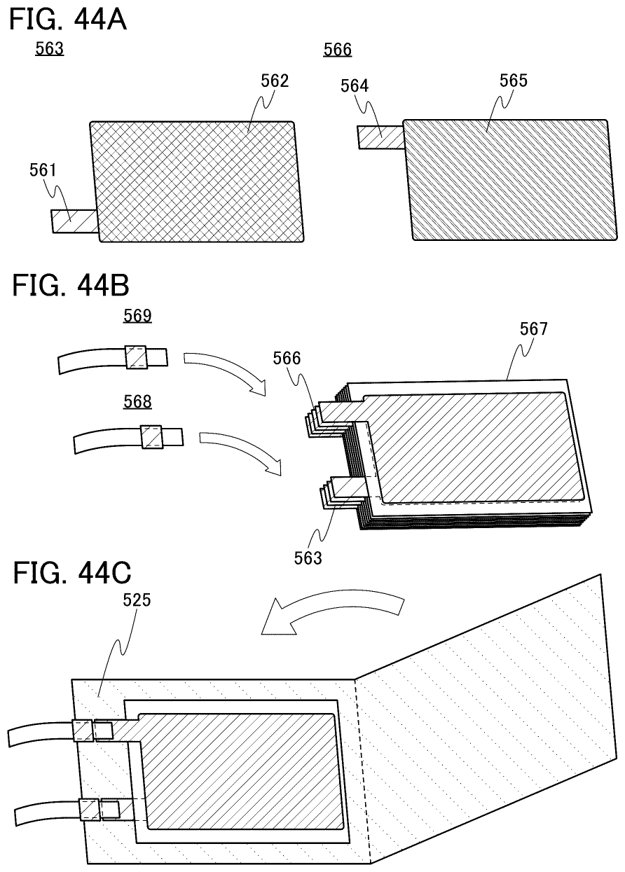

FIG. 44A illustrates external views of the positive electrode 563 and the negative electrode 566. The positive electrode 563 includes a positive electrode current collector 561, and a positive electrode active material layer 562 is formed on a surface of the positive electrode current collector 561. The positive electrode 563 also includes a region where the positive electrode current collector 561 is partly exposed (hereinafter, referred to as a tab region). The negative electrode 566 includes a negative electrode current collector 564, and a negative electrode active material layer 565 is formed on a surface of the negative electrode current collector 564. The negative electrode 566 also includes a region where the negative electrode current collector 564 is partly exposed, that is, a tab region. The areas and the shapes of the tab regions included in the positive electrode and the negative electrode are not limited to the examples illustrated in FIG. 44A.

### <Fabrication Method of Laminated Secondary Battery>

Here, an example of a method for fabricating the laminated secondary battery whose external view is illustrated in FIG. 43A is described with reference to FIG. 44B and FIG. 44C.

First, the negative electrode 566, the separator 567, and the positive electrode 563 are stacked. FIG. 44B illustrates the negative electrode 566, the separator 567, and the positive electrode 563 that are stacked. Here, an example in which five negative electrodes and four positive electrodes are used is shown. The stacked negative electrodes, separators, and positive electrodes can be referred to as a stack. Next, the tab regions of the positive electrodes 563 are bonded to each other, and the positive electrode lead electrode 568 is bonded to the tab region of the positive electrode on the outermost surface. The bonding can be performed by ultrasonic welding, for example. In a similar manner, the tab regions of the negative electrodes 566 are bonded to each other, and the negative electrode lead electrode 569 is bonded to the tab region of the negative electrode on the outermost surface.

After that, the negative electrodes 566, the separators 567, and the positive electrodes 563 are placed over the exterior body 525.

Next, the exterior body 525 is bent along a portion shown by a dashed line, as illustrated in FIG. 44C. Then, the outer edges of the exterior body 525 are bonded to each other. The bonding can be performed by thermocompression, for example. At this time, an unbonded region (hereinafter referred to as an inlet) is provided for part (or one side) of the exterior body 525 so that an electrolyte solution can be introduced later.

Next, the electrolyte solution is introduced into the exterior body 525 from the inlet of the exterior body 525. The electrolyte solution is preferably introduced in a reduced pressure atmosphere or in an inert atmosphere. Lastly, the inlet is sealed by bonding. In this manner, the laminated secondary battery 500 can be fabricated.

The electrode 400 obtained in the above embodiment is used as the positive electrode 563, whereby the secondary battery 500 can have high capacity, high charge and discharge capacity, and excellent cycle performance.

### [Examples of Battery Pack]

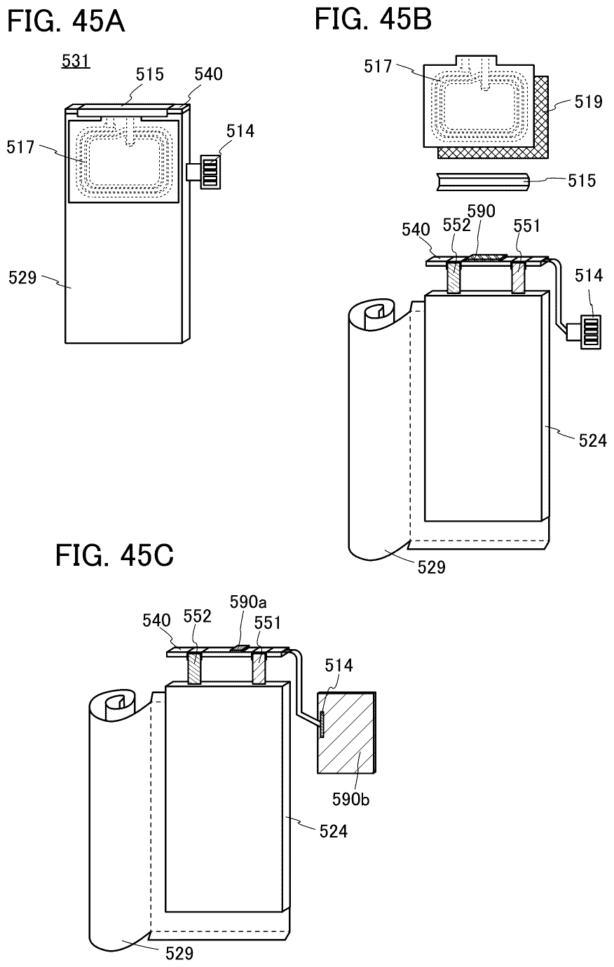

Examples of a secondary battery pack of one embodiment of the present invention that is capable of wireless charging using an antenna will be described with reference to FIG. 45A to FIG. 45C.

FIG. 45A is a diagram illustrating the appearance of a secondary battery pack 531 that has a rectangular solid shape with a small thickness (also referred to as a flat plate shape with a certain thickness). FIG. 45B is a diagram illustrating a structure of the secondary battery pack 531. The secondary battery pack 531 includes a circuit board 540 and a secondary battery 524. A label 529 is attached to the secondary battery 524. The circuit board 540 is fixed by a sealant 515. The secondary battery pack 531 also includes an antenna 517.

A wound body or a stack may be included inside the secondary battery 524.

In the secondary battery pack 531, a control circuit 590 is provided over the circuit board 540 as illustrated in FIG. 45B, for example. The circuit board 540 is electrically connected to a terminal 514. The circuit board 540 is electrically connected to the antenna 517, one 551 of a positive electrode lead and a negative electrode lead of the secondary battery 524, and the other 552 of the positive electrode lead and the negative electrode lead.

Alternatively, as illustrated in FIG. 45C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 524. The layer 519 has a function of blocking an electromagnetic field from the secondary battery 524, for example. As the layer 519, a magnetic material can be used, for example.

The contents in this embodiment can be freely combined with the contents in the other embodiments.

### Embodiment 6

In this embodiment, an example in which an all-solid-state battery is fabricated using the positive electrode active material 100 obtained in the above embodiment will be described.

### [Exterior Body and Shape of Secondary Battery]

An exterior body of the secondary battery of one embodiment of the present invention can be formed using a variety of materials and have a variety of shapes, and preferably has a function of applying pressure to the positive electrode, the solid electrolyte layer, and the negative electrode.

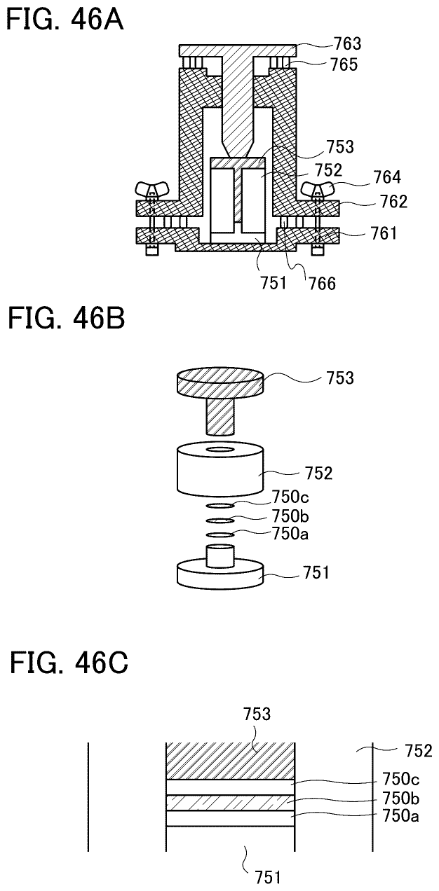

FIG. 46 illustrates an example of a cell for evaluating materials of an all-solid-state battery, for example.

FIG. 46A is a cross-sectional schematic view of the evaluation cell, and the evaluation cell includes a lower component 761, an upper component 762, and a fixation screw or a butterfly nut 764 for fixing these components: by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 46B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 46C. Note that the same portions in FIG. 46A to FIG. 46C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

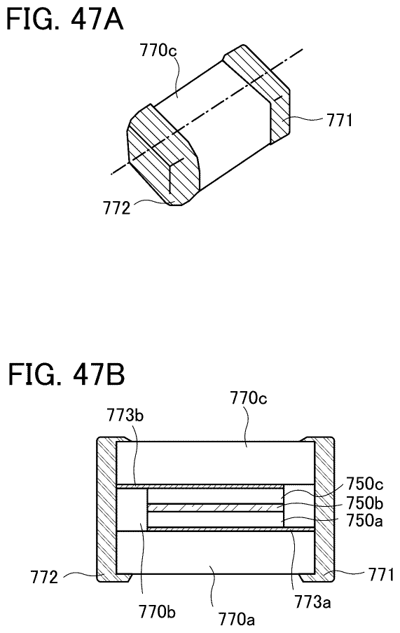

FIG. 47A shows a perspective view of a secondary battery of one embodiment of the present invention that has an exterior body and a shape different from those in FIG. 47. The secondary battery in FIG. 47A includes external electrodes 771 and 772 and is sealed with an exterior body including a plurality of package components.

FIG. 47B illustrates an example of a cross section along the dashed-dotted line in FIG. 47A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in the above embodiment can achieve an all-solid-state secondary battery having a high energy density and favorable output characteristics.

The contents in this embodiment can be combined with the contents in the other embodiments as appropriate.

### Embodiment 7

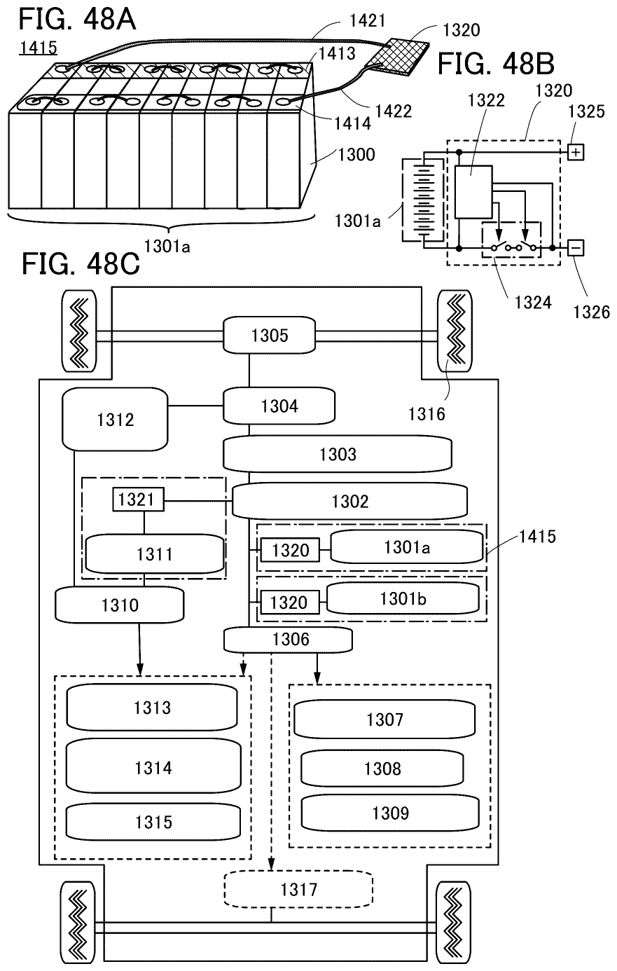

In this embodiment, as an example in which a secondary battery of one embodiment of the present invention is used for an moving vehicle, an example in which the secondary battery is used for an electric vehicle (EV) is illustrated in FIG. 48(C).

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed: the capacity of the second battery 1311 is lower than that of the first batteries 1301a and 1301b.

The internal structure of the first battery 1301a may be the wound structure illustrated in FIG. 41A or FIG. 42C or the stacked-layer structure illustrated in FIG. 43A or FIG. 43B. Alternatively, an all-solid-state battery in Embodiment 6 may be used as the first battery 1301a. The use of the all-solid-state battery in Embodiment 6 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 48A.

FIG. 48A illustrates an example in which nine rectangular secondary batteries 1300 form one battery pack 1415. The nine rectangular secondary batteries 1300 are connected in series: one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-Me-Zn oxide (an element Me is one or more kinds selected from aluminum, gallium, yttrium, tin, silicon, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-Me-Zn oxide that can be used as the oxide is preferably a CAAC-OS (C-Axis Aligned Crystalline Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material: as a whole, the CAC-OS has a function of a semiconductor. Separation of the conducting function and the insulating function can maximize each function. Accordingly, when the CAC-OS is used for a transistor, high on-state current (Ion), high field-effect mobility (u), and excellent switching operation can be achieved.

An oxide semiconductor has various structures with different properties. Two or more kinds among an amorphous oxide semiconductor, a polycrystalline oxide semiconductor, an a-like OS (amorphous-like Oxide Semiconductor), a CAC-OS, an nc-OS (nano crystalline Oxide Semiconductor), and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery including a positive electrode using the positive electrode active material 100 obtained in the above embodiment, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of a secondary battery include prevention of overcharging, prevention of overcurrent, control of overheating during charging, holding of cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit: the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect later estimation of charge and discharge state and the like of the secondary battery.

One of the causes of a micro-short circuit is as follows: charging and discharging performed a plurality of times cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

FIG. 48B illustrates an example of a block diagram of the battery pack 1415 illustrated in FIG. 48A.

The control circuit portion 1320 includes a switch portion 1324 including at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range: when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon: the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOr (gallium oxide, where x is a real number greater than 0), or the like. A memory element using an OS transistor can be freely placed by being stacked over a circuit using a Si transistor, for example: hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle devices for 42 V (for a high-voltage system), and the second battery 1311 supplies electric power to in-vehicle devices for 14 V (for a low-voltage system).

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b can desirably be charged rapidly.

The battery controller 1302 can set the charge voltage, charge current, and the like of the first batteries 1301a and 1301b. The battery controller 1302 can set charge conditions in accordance with charge characteristics of a secondary battery to be used, so that rapid charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used: to prevent overcharging, the first batteries 1301a and 1301b are preferably charged through the control circuit portion 1320. In addition, the plug of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 KW, for example. Furthermore, charging can be performed with electric power supplied from external charge equipment by a contactless power feeding method or the like.

For rapid charging, secondary batteries that can withstand high-voltage charging have been desired to perform charging in a short time.

The above-described secondary battery in this embodiment uses the positive electrode active material 100 obtained in the above embodiment. Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle: it is possible to provide a vehicle that has a long cruising range, specifically one charge mileage of 500 km or greater, without increasing the proportion of the weight of the secondary battery to the weight of the entire vehicle.

Specifically, in the above-described secondary battery in this embodiment, the use of the positive electrode active material 100 described in the above embodiment can increase the operating voltage of the secondary battery, and the increase in charge voltage can increase the available capacity. Moreover, using the positive electrode active material 100 described in the above embodiment in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 40D, FIG. 42C, and FIG. 48A on vehicles can achieve next-generation clean energy vehicles such as hybrid vehicles (HVs), electric vehicles (EVs), and plug-in hybrid vehicles (PHVs). The secondary battery can also be mounted on moving vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in moving vehicles.

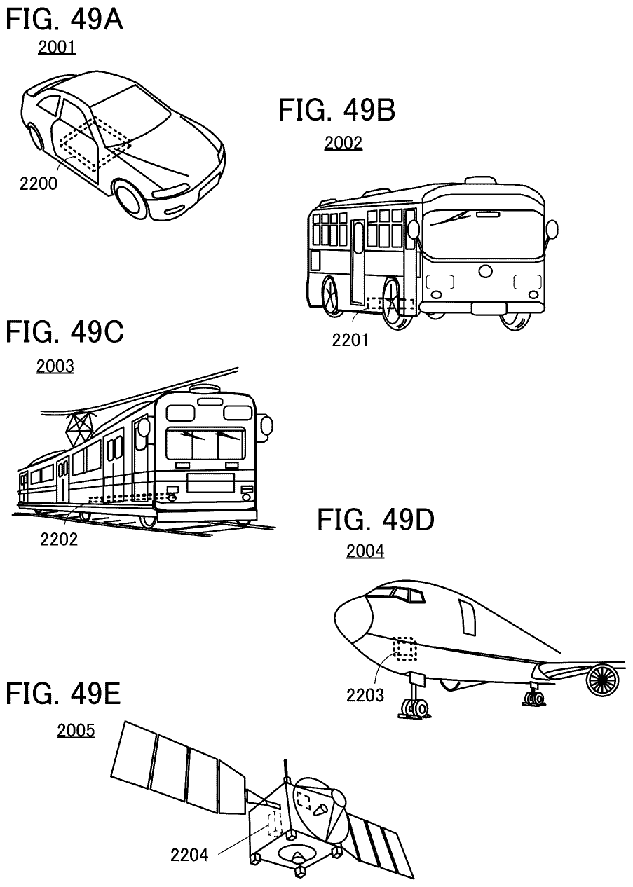

FIG. 49A to FIG. 49E illustrate examples of transport vehicles as examples of vehicles using one embodiment of the present invention. An automobile 2001 illustrated in FIG. 49A is an electric vehicle that runs using an electric motor as a driving power source. Alternatively, the automobile 2001 is a hybrid vehicle that can appropriately select an electric motor or an engine as a driving power source. In the case where the secondary battery is mounted on the vehicle, an example of the secondary battery described in Embodiment 5 is provided at one position or several positions. The automobile 2001 illustrated in FIG. 49A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. A charge apparatus may be a charge station provided in a commerce facility or a household power supply. For example, with the use of a plug-in technique, the power storage device mounted on the automobile 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 49B illustrates a large transporter 2002 having a motor controlled by electricity, as an example of a transport vehicle. A secondary battery module of the transporter 2002 has a cell unit of four secondary batteries with a nominal voltage higher than or equal to 3.0 V and lower than or equal to 5.0 V, and 48 cells are connected in series to have 170 V as the maximum voltage. A battery pack 2201 has the same function as that in FIG. 49A except, for example, the number of secondary batteries configuring the secondary battery module: thus, the description is omitted.

FIG. 49C illustrates a large transport vehicle 2003 having a motor controlled by electricity as an example. A secondary battery module of the transport vehicle 2003 has 100 or more secondary batteries with a nominal voltage higher than or equal to 3.0 V and lower than or equal to 5.0 V connected in series, and the maximum voltage is 600 V, for example. When a secondary battery including the positive electrode active material 100 described in the above embodiment for a positive electrode is used, a secondary battery having favorable rate performance and charge and discharge cycle performance can be manufactured, which can contribute to higher performance and a longer lifetime of the transport vehicle 2003. A battery pack 2202 has the same function as that in FIG. 49A except, for example, the number of secondary batteries configuring the secondary battery module: thus, the description is omitted.

FIG. 49D illustrates an aircraft 2004 having a combustion engine as an example. The aircraft 2004 illustrated in FIG. 49D can be regarded as part of transport vehicles since it is provided with wheels for takeoff and landing, and has a battery pack 2203 including a secondary battery module and a charge control device: the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 49A except, for example, the number of secondary batteries configuring the secondary battery module: thus, the description is omitted.

FIG. 49E illustrates an example of an artificial satellite using a storage battery management system of one embodiment of the present invention. An artificial satellite 2005 illustrated in FIG. 49E includes a secondary battery 2204. Because the artificial satellite 2005 is used in an ultra-low-temperature cosmic space, the secondary battery 2204 is desirably covered with a heat-retaining member to be mounted inside the artificial satellite 2005.

The contents in this embodiment can be combined with the contents in the other embodiments as appropriate.

### Embodiment 8

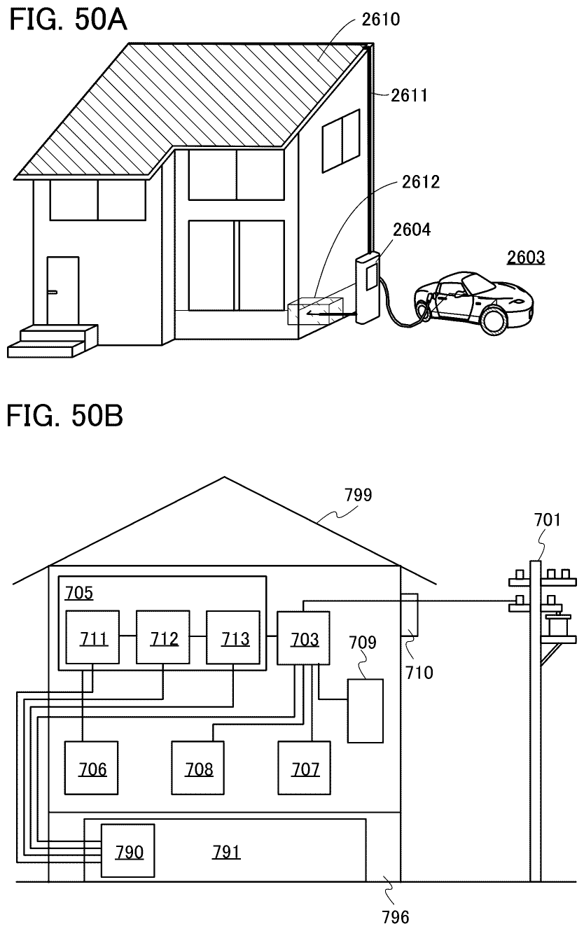

In this embodiment, examples in which the secondary battery of one embodiment of the present invention is mounted on a building will be described with reference to FIG. 50A and FIG. 50B.

A house illustrated in FIG. 50A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charge apparatus 2604. The power storage device 2612 can be charged with electric power generated by the solar panel 2610. A secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 50B illustrates an example of a power storage device of one embodiment of the present invention. As illustrated in FIG. 50B, a power storage device 791 of one embodiment of the present invention is provided in an underfloor space 796 of a building 799. The power storage device 791 may be provided with the control circuit described in Embodiment 7, and the use of a secondary battery including a positive electrode using the positive electrode active material 100 obtained in the above embodiment for the power storage device 791 enables the power storage device 791 to have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 9

In this embodiment, as examples where a battery of one embodiment of the present invention is used for a moving vehicle, examples where the battery is used for a motorcycle and a bicycle will be described.

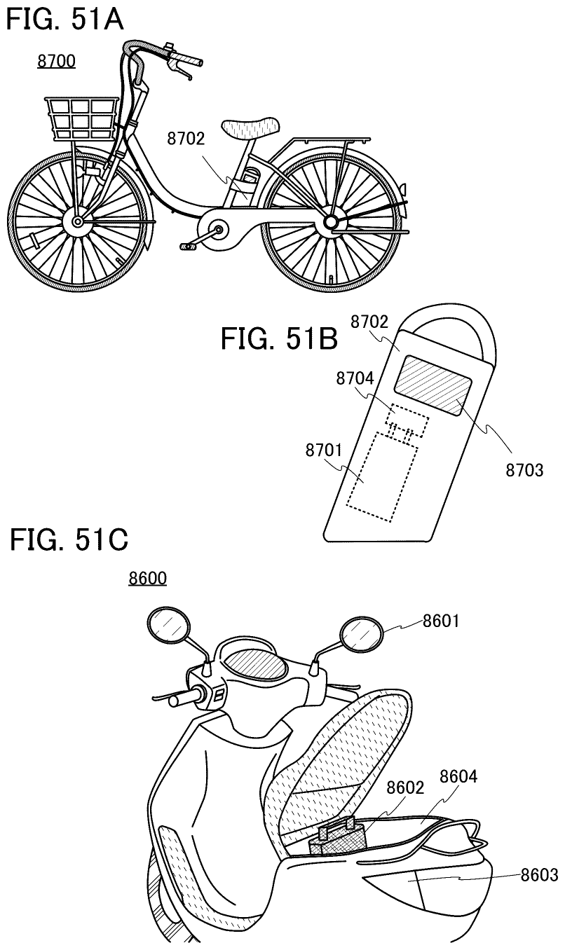

FIG. 51A illustrates an example of an electric bicycle using the power storage device of one embodiment of the present invention. The power storage device of one embodiment of the present invention can be used for an electric bicycle 8700 illustrated in FIG. 51A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 51B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 7. The control circuit 8704 is electrically connected to a positive electrode and a negative electrode of the storage battery 8701. The control circuit 8704 may be provided with the small solid-state secondary battery illustrated in FIG. 48A and FIG. 48B. When the small solid-state secondary battery illustrated in FIG. 48A and FIG. 48B is provided in the control circuit 8704, electric power can be supplied to store data in a memory circuit included in the control circuit 8704 for a long time. When the control circuit 8704 is used in combination with the secondary battery including the positive electrode active material 100 obtained in the above embodiment in the positive electrode, the synergy on safety can be obtained. The secondary battery including the positive electrode active material 100 obtained in the above embodiment in the positive electrode and the control circuit 8704 can greatly contribute to elimination of accidents due to secondary batteries, such as fires.

FIG. 51C illustrates an example of a motorcycle using the power storage device of one embodiment of the present invention. A motor scooter 8600 illustrated in FIG. 51C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in the above embodiment can have high capacity and contribute to a reduction in size.

In the motor scooter 8600 illustrated in FIG. 51C, the power storage device 8602 can be stored in an under-seat storage 8604. The power storage device 8602 can be stored in the under-seat storage 8604 even with a small size.

The contents in this embodiment can be combined with the contents in the other embodiments as appropriate.

### Embodiment 10

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

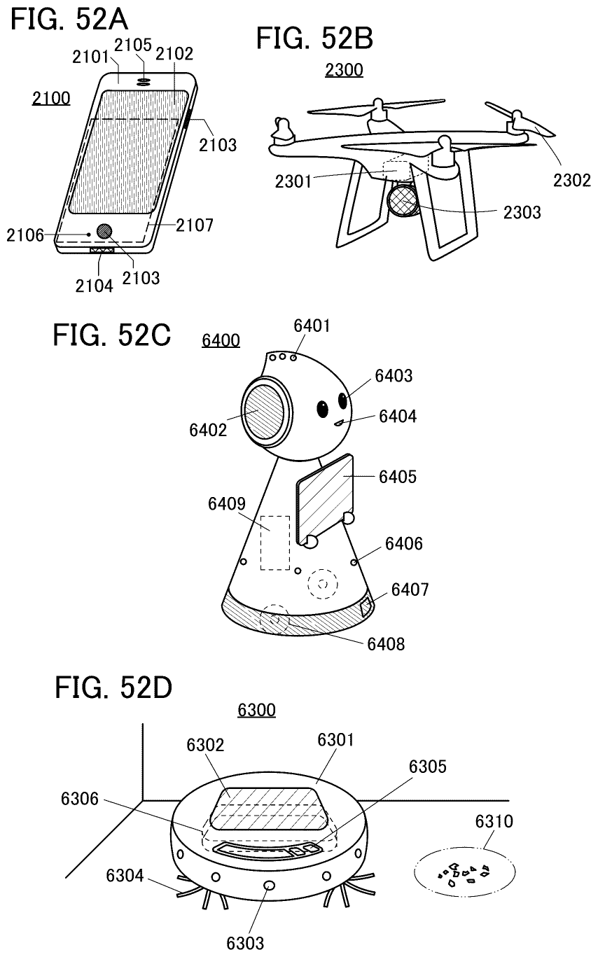

FIG. 52A illustrates an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in the above embodiment achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 52B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in the above embodiment has high energy density and a high level of safety, and thus can be used safely for a long time over a long period of time and is suitable as the secondary battery included in the unmanned aircraft 2300.

FIG. 52C illustrates an example of a robot. A robot 6400 illustrated in FIG. 52C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in the above embodiment has high energy density and a high level of safety, and thus can be used safely for a long time over a long period of time and is suitable as the secondary battery 6409 included in the robot 6400.

FIG. 52D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in the above embodiment has high energy density and a high level of safety, and thus can be used safely for a long time over a long period of time and is preferable as the secondary battery 6306 included in the cleaning robot 6300.

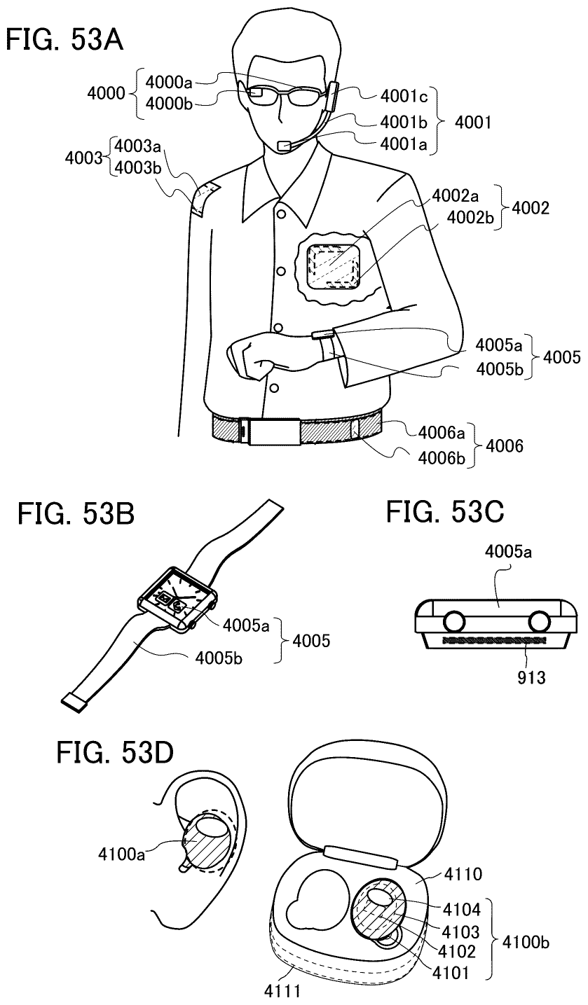

FIG. 53A illustrates examples of wearable devices. A secondary battery is used as a power source of a wearable device. To have improved splash resistance, water resistance, or dust resistance in daily use or outdoor use by a user, a wearable device is desirably capable of being charged wirelessly as well as being charged with a wire whose connector portion for connection is exposed.

For example, the secondary battery of one embodiment of the present invention can be provided in a glasses-type device 4000 illustrated in FIG. 53A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in the above embodiment has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 53B illustrates a perspective view of the watch-type device 4005 that is detached from an arm.

FIG. 53C illustrates a side view. FIG. 53C illustrates a state where the secondary battery 913 is incorporated in the inner region. The secondary battery 913 is the secondary battery described in Embodiment 5. The secondary battery 913 is provided to overlap with the display portion 4005a, can have high density and high capacity, and is small and lightweight. Since the secondary battery in the watch-type device 4005 is required to be small and lightweight, the use of the positive electrode active material 100 obtained in the above embodiment in the positive electrode of the secondary battery 913 enables the secondary battery 913 to have high energy density and a small size.

FIG. 53D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 100 obtained in the above embodiment has a high energy density: thus, with the use of the secondary battery as the secondary battery 4103 and the secondary battery 4111, a structure that accommodates space saving due to a reduction in size of the wireless earphones can be achieved.

This embodiment can be implemented in appropriate combination with the other embodiments.

### Example

In this example, positive electrodes each having a three-layer structure of one embodiment of the present invention were fabricated and cross-sectional observation was performed on the positive electrodes.

A positive electrode sample A and a positive electrode sample B were fabricated by the fabrication methods shown in FIG. 7 and FIG. 8.

### <Positive Electrode Sample A>

As the formation methods of the mixture 501, the mixture 502, and the mixture 503 in FIG. 7, the formation method in FIG. 8B was used.

The mixture 501 in FIG. 7 was formed by the formation method in FIG. 8B using lithium cobalt oxide (C-5H produced by NIPPON CHEMICAL INDUSTRIAL CO., LTD.) with a median diameter of 7.2 μm as the active material 10 in Step S123. The mixture 502 in FIG. 7 was formed by the formation method in FIG. 8B using lithium cobalt oxide (C-20F produced by NIPPON CHEMICAL INDUSTRIAL CO., LTD.) with a median diameter of 19.4 μm as the active material 10 in Step S123. The mixture 503 in FIG. 7 was formed by the formation method in FIG. 8B using lithium cobalt oxide (C-5H produced by NIPPON CHEMICAL INDUSTRIAL CO., LTD.) with a median diameter of 7.2 μm as the active material 10 in Step S123. Polyvinylidene fluoride (PVDF) was used as a binder, and acetylene black (AB) was used as a conductive material. The mixture ratio of lithium cobalt oxide, the conductive material, and the binder in the mixture 501, the mixture 502, and the mixture 503 was 95:3:2 in a weight ratio. For the mixing in Step S121, Step S131, and Step S141 in FIG. 8, a planetary centrifugal mixer (THINKY MIXER produced by THINKY CORPORATION) was used.

A current collector made of aluminum was prepared, and the mixture 501, the mixture 502, and the mixture 503 were sequentially applied onto the current collector according to the fabrication process in FIG. 7. As the drying in Step S14, Step S24, and Step S34, circulation drying was performed at 80° C. using a circulation drying apparatus. As the pressing in Step S15, Step S25, and Step S35, roll pressing was performed. The roll pressing was performed under conditions of a roll temperature of 120° C. and a press line pressure of 210 KN/m.

### <Positive Electrode Sample B>

In fabrication of the positive electrode sample B, classified active materials were used. For classification of the active materials, the picosplit of the Picoline produced by HOSOKAWA MICRON CORPORATION was used.

As a first layer of the positive electrode sample B, the mixture 501 in FIG. 7 was formed by the formation method in FIG. 8B using lithium cobalt oxide (fine powder obtained by classifying C-5H) with a median diameter of 3.5 μm as the active material 10 in Step S123.

Next, as a second layer of the positive electrode sample B, the mixture 502 in FIG. 7 was formed by the formation method in FIG. 9B using lithium cobalt oxide (rough powder obtained by classifying C-20F) with a particle diameter of 21.0 μm as the active material 10a in Step S123 and using lithium cobalt oxide (fine powder obtained by classifying C-5H) with a particle diameter of 3.5 μm as the active material 10b in Step S124. The mixture ratio of the active material 10a to the active material 10b was the mass of the active material 10a: the mass of the active material 10b=8:2.

Then, as a third layer of the positive electrode sample B, the mixture 503 in FIG. 7 was formed by the formation method in FIG. 8B using lithium cobalt oxide (fine power obtained by classifying C-5H) with a particle diameter of 3.5 μm as the active material 10 in Step S123.

The fabrication method of the positive electrode sample B was similar to the fabrication method of the positive electrode sample A except that the above-described active materials were used.

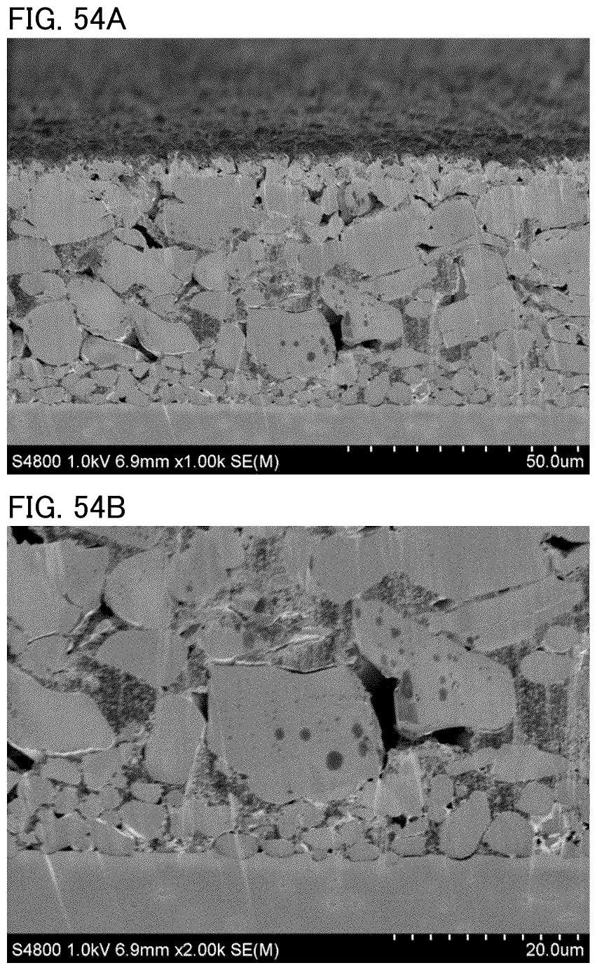

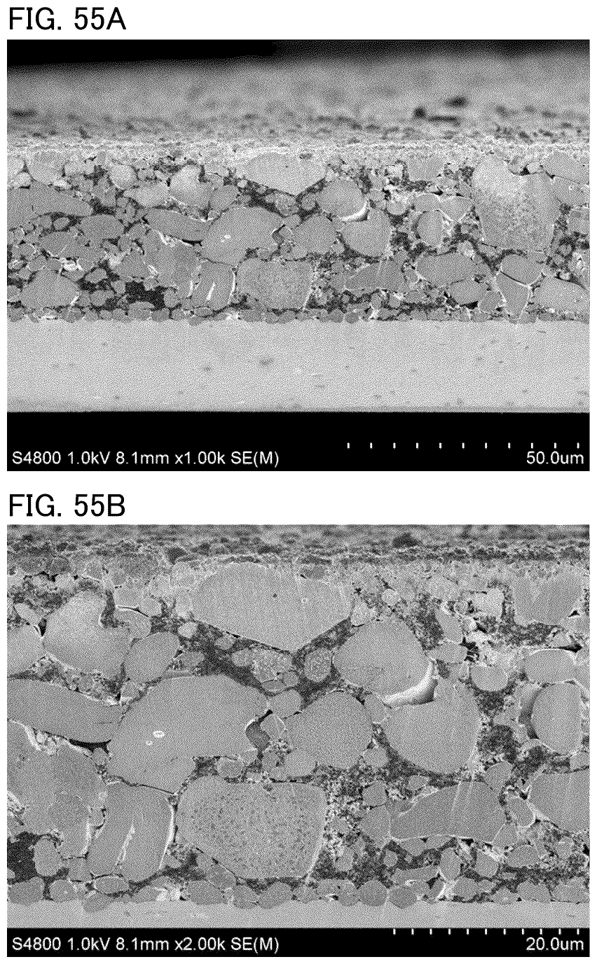

The cross sections of the positive electrode sample A and the positive electrode sample B fabricated through the above processes were exposed by ion milling processing, and cross-sectional SEM observation was performed on the positive electrode samples. A scanning electron microscope S-4800 produced by Hitachi High-Technologies Corporation was used for the SEM observation. FIG. 54A and FIG. 54B show the cross-sectional SEM images of the positive electrode sample A, and FIG. 55A and FIG. 55B show the cross-sectional SEM images of the positive electrode sample B.

According to the SEM observation results shown in FIG. 54A and FIG. 54B, in the positive electrode sample A, the thickness of the first layer 414a is approximately 10 μm, the thickness of the second layer 414b is approximately 40 μm, and the thickness of the third layer 414c is approximately 7 μm.

According to the SEM observation results shown in FIG. 55A and FIG. 55B, in the positive electrode sample B, the thickness of the first layer 414a is approximately 5 μm, the thickness of the second layer 414b is approximately 30 μm, and the thickness of the third layer 414c is approximately 3 μm.

When the second layers in FIG. 54B and FIG. 55B are compared, it is confirmed that the active material proportion in the active material layer in the positive electrode sample B, which uses the active material with a large particle diameter and the active material with a small particle diameter, is higher than that in the positive electrode sample A.

### REFERENCE NUMERALS

10: active material, 10a: active material, 10b: active material, 10c: active material, 51: positive electrode active material, 52: depression, 54: pit, 55: crystal plane, 57: crack, 58: pit, 100: positive electrode active material, 100a: surface portion, 100A: positive electrode active material, 100b: inner portion, 100B: positive electrode active material, 110: binder, 120: dispersion medium, 170: coprecipitation synthesis apparatus, 171: reaction container, 172: stirrer, 173: stirrer motor, 174: thermometer, 175: tank, 176: tube, 177: pump, 178: valve, 180; tank, 181: tube, 182: pump, 184: valve, 186: tank, 187: tube, 188: pump, 189: valve, 190: control device, 192: inner liquid, 300: secondary battery, 301: positive electrode can, 302: negative electrode can. 303: gasket, 304: positive electrode, 305: positive electrode current collector, 306: positive electrode active material layer, 307: negative electrode, 308: negative electrode current collector, 309: negative electrode active material layer, 310: separator, 312: washer, 313: ring-shaped insulator, 322: spacer, 400): electrode, 400A: electrode, 400B: electrode, 400C: electrode, 400D: electrode, 400E: electrode, 400F: electrode, 400G: electrode, 400H: electrode, 400I: electrode, 400J: electrode, 410: positive electrode, 411a: active material, 411b: active material, 411c: active material, 411d: active material, 411e: active material, 411Ta: positive electrode active material, 411Tb: positive electrode active material, 413: current collector, 414: active material layer, 414a: layer, 414b: layer, 414b-2: layer, 414c: layer, 415: conductive material, 420: solid electrolyte layer, 421: solid electrolyte, 430: negative electrode, 431: negative electrode active material, 433: negative electrode current collector, 434: negative electrode active material layer, 440: separator. 500: secondary battery, 501: mixture, 502: mixture, 503: mixture, 511: coated electrode, 512: coated electrode, 513: coated electrode, 514: terminal, 515: sealant, 517: antenna, 519: layer, 524: secondary battery, 525: exterior body, 529: label, 531: secondary battery pack, 540): circuit board, 561: positive electrode current collector, 562: positive electrode active material layer, 563: positive electrode, 564: negative electrode current collector, 565: negative electrode active material layer, 566: negative electrode, 567: separator, 568: positive electrode lead electrode, 569: negative electrode lead electrode, 576: electrolyte, 590): control circuit, 590a: circuit system, 590b: circuit system, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring. 622: wiring, 623: wiring, 624: conductor, 625: insulator, 626; wiring. 627: wiring, 628: conductive plate, 701: commercial power source, 703: distribution board, 705: power storage controller, 706: indicator, 707: general load. 708: power storage load. 709: router, 710: service wire mounting portion, 711: measuring portion. 712: predicting portion, 713: planning portion, 750a: positive electrode, 750b: solid electrolyte layer, 750c: negative electrode, 751: electrode plate, 752: insulating tube, 753: electrode plate, 761: lower component, 762: upper component. 764: butterfly nut, 765: O ring. 766: insulator, 770a: package component, 770b: package component. 770c: package component. 771: external electrode, 772: external electrode, 773a: electrode layer, 773b: electrode layer, 790: control device. 791: power storage device, 796: underfloor space, 799: building, 902: mixed solution, 903: mixture, 911a: terminal, 911b: terminal, 913: secondary battery, 930: housing, 930a: housing, 930b: housing, 931: negative electrode, 931a: negative electrode active material layer, 932: positive electrode, 932a: positive electrode active material layer, 933: separator, 950: wound body, 950a: wound body, 951: terminal, 952: terminal, 1001: binder mixture, 1002: conductive material, 1003: dispersion medium, 1010: mixture, 1020: mixture, 1030: mixture, 1031: mixture, 1032: mixture, 1300: rectangular secondary battery, 1301a: battery, 1301b: battery, 1302: battery controller, 1303: motor controller, 1304: motor, 1305: gear, 1306: DCDC circuit, 1308: heater, 1309: defogger, 1310: DCDC circuit, 1311: battery, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1325: external terminal, 1326: external terminal, 1413: fixing portion, 1414: fixing portion, 1415: battery pack, 1421: wiring, 1422: wiring, 2001: automobile, 2002: transporter, 2003: transport vehicle, 2004: airplane, 2005: artificial satellite, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2204: secondary battery, 2300: unmanned aircraft, 2301: secondary battery, 2302: rotor, 2303: camera, 2603: vehicle, 2604: charge apparatus, 2610: solar panel, 2611: wiring, 2612: power storage device, 4000: glasses-type device, 4000a: frame, 4000b: display portion, 4001: headset-type device, 4001a: microphone portion, 4001b: flexible pipe, 4001c: earphone portion, 4002: device, 4002a: housing, 4002b: secondary battery, 4003: device, 4003a: housing, 4003b: secondary battery, 4005: watch-type device, 4005a: display portion, 4005b: belt portion, 4006: belt-type device, 4006a: belt portion, 4006b: wireless power feeding and receiving portion, 4100a: main body, 4100b: main body, 4101: driver unit, 4102: antenna, 4103: secondary battery, 4104: display portion, 4110: case, 4111: secondary battery, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: direction indicator, 8604: under-seat storage, 8700: electric bicycle, 8701: storage battery, 8702: power storage device, 8703: display portion, 8704: control circuit

1. A battery comprising a positive electrode and a negative electrode,
wherein the positive electrode comprises a current collector, a first layer overlapping with the current collector, and a second layer overlapping with the first layer,
wherein the first layer comprises a first active material with a first particle diameter,
wherein the second layer comprises a second active material with a second particle diameter, and
wherein the first particle diameter is smaller than the second particle diameter.

2. The battery according to claim 1, wherein sphericity of the second active material is greater than or equal to 0.8 and less than or equal to 1.0.

3. The battery according to claim 1,
wherein the second active material comprises a surface portion and an inner portion,
wherein the surface portion is a region within a depth of 10 nm or less from a surface of the second active material to the inner portion, and
wherein the surface portion and the inner portion are topotaxy.

4. The battery according to claim 3,
wherein sphericity of the second active material is greater than or equal to 0.8 and less than or equal to 1.0.

5. The battery according to claim 1,
wherein the first layer is over the current collector, and
wherein the second layer is over the first layer.

6. The battery according to claim 1,
wherein the second layer is over the current collector, and
wherein the first layer is over the second layer.

7. The battery according to claim 5,
wherein the first layer and the second layer each comprise a conductive material, and
wherein mass of the conductive material contained in the second layer is larger than mass of the conductive material contained in the first layer.

8. The battery according to claim 6,
wherein the first layer and the second layer each comprise a conductive material, and
wherein mass of the conductive material contained in the first layer is larger than mass of the conductive material contained in the second layer.

9. The battery according to claim 5,
wherein the first layer and the second layer each comprise a solid electrolyte, and
wherein mass of the solid electrolyte contained in the first layer is larger than mass of the solid electrolyte contained in the second layer.

10. The battery according to claim 6,
wherein the first layer and the second layer each comprise a solid electrolyte, and
wherein mass of the solid electrolyte contained in the second layer is larger than mass of the solid electrolyte contained in the first layer.

11. A battery comprising a positive electrode and a negative electrode,
wherein the positive electrode comprises a current collector, a first layer over the current collector, a second layer over the first layer, and a third layer over the second layer,
wherein the first layer comprises a first active material with a first particle diameter,
wherein the second layer comprises a second active material with a second particle diameter,
wherein the third layer comprises a third active material with a third particle diameter,
wherein the first particle diameter is smaller than the second particle diameter, and
wherein the third particle diameter is smaller than the second particle diameter.

12. The battery according to claim 11,
wherein sphericity of the second active material is greater than or equal to 0.8 and less than or equal to 1.0.

13. The battery according to claim 11,
wherein the second layer comprises a fourth active material with a fourth particle diameter, and
wherein the fourth particle diameter is smaller than the second particle diameter.

14. The battery according to claim 13, wherein sphericity of the second active material is greater than or equal to 0.8 and less than or equal to 1.0.

15. The battery according to claim 11,
wherein the second active material comprises a surface portion and an inner portion,
wherein the surface portion is a region within a depth of 10 nm or less from a surface of the second active material to the inner portion, and
wherein the surface portion and the inner portion are topotaxy.

16. The battery according to claim 15, wherein
sphericity of the second active material is greater than or equal to 0.8 and less than or equal to 1.0.

17. The battery according to claim 13,
wherein the second active material comprises a surface portion and an inner portion,
wherein the surface portion is a region within a depth of 10 nm or less from a surface of the second active material to the inner portion, and
wherein the surface portion and the inner portion are topotaxy.

18. The battery according to claim 17, wherein sphericity of the second active material is greater than or equal to 0.8 and less than or equal to 1.0.

19. The battery according to claim 11,
wherein the first layer, the second layer, and the third layer each comprise a conductive material,
wherein mass of the conductive material contained in the third layer is larger than mass of the conductive material contained in the second layer, and
wherein the mass of the conductive material contained in the second layer is larger than mass of the conductive material contained in the first layer.

20. The battery according to claim 11,
wherein the first layer, the second layer, and the third layer each comprise a solid electrolyte,
wherein mass of the solid electrolyte contained in the first layer is larger than mass of the solid electrolyte contained in the second layer, and
wherein the mass of the solid electrolyte contained in the second layer is larger than mass of the solid electrolyte contained in the third layer.

21. The battery according to claim 15,
wherein the first layer, the second layer, and the third layer each comprise a solid electrolyte,
wherein mass of the solid electrolyte contained in the first layer is larger than mass of the solid electrolyte contained in the second layer,
wherein the mass of the solid electrolyte contained in the second layer is larger than mass of the solid electrolyte contained in the third layer, and
wherein an edge surface of the second active material comprises a region where the surface portion and the solid electrolyte are in contact with each other.

22. A moving vehicle comprising the battery according to claim 1.

23. A power storage system comprising the battery according to claim 1.

24. An electronic device comprising the battery according to claim 1.
